(19) United States
(12) Patent Application Publication
(10) Pub. No.: US 2026/0218052 A1
(43) Pub. Date: Jul. 30, 2026

(54) LIQUID CRYSTAL COMPOSITION, CURED PRODUCT, FILM, AND COMPOUND

(71) Applicant: FUJIFILM Corporation, Tokyo (JP)

(72) Inventors: Aiko YAMAMOTO, Minamiashigara-shi (JP); Megumi OKUBO, Minamiashigara-shi (JP); Takashi MACHIDA, Minamiashigara-shi (JP); Hiroshi INADA, Minamiashigara-shi (JP); Ryoji GOTO, Minamiashigara-shi (JP); Masamichi KISHINO, Minamiashigara-shi (JP)

(73) Assignee: FUJIFILM Corporation, Tokyo (JP)

(21) Appl. No.: 19/630,523

(22) Filed: Mar. 27, 2026

Related U.S. Application Data
(63) Continuation of application No. PCT/JP2024/024965, filed on Jul. 10, 2024.

(30) Foreign Application Priority Data
Sep. 29, 2023 (JP) 2023-169664

(51) Int. Cl. C09K 19/56; C07F 7/08; C08G 77/04; C08G 77/14; C08G 77/52; C09K 19/04; C09K 19/38

(52) U.S. Cl. CPC C09K 19/56; C07F 7/0838; C08G 77/045; C08G 77/14; C08G 77/52; C09K 19/3852; C09K 2019/0448

(57) ABSTRACT

A liquid crystal composition is provided that enables formation of films with improved alignment properties and reduced visible non-uniformity. The composition includes a liquid crystal compound and a compound represented by Formula (1), B—Z¹-A¹-Z²-A²-(Z³-A³)ₙ₁—W, in which A¹ to A³ each independently represent a divalent aromatic ring group or a divalent aliphatic ring group, Z¹ to Z³ each independently represent a single bond or a divalent linking group, n1 represents an integer of 0 or more, B represents a monovalent aromatic ring group substituted with one or more siloxane-containing substituents, and W represents hydrogen or a monovalent substituent not including silicon. Also provided are a cured product and a film formed from the composition.

### CROSS-REFERENCE TO RELATED APPLICATIONS

This application is a Continuation of PCT International Application No. PCT/JP2024/024965 filed on Jul. 10, 2024, which claims priority under 35 U.S.C. § 119 (a) to Japanese Patent Application No. 2023-169664 filed on Sep. 29, 2023. The above applications are hereby expressly incorporated by reference, in their entirety, into the present application.

### BACKGROUND OF THE INVENTION

### 1. Field of the Invention

The present invention relates to a liquid crystal composition, a cured product, a film, and a compound.

### 2. Description of the Related Art

An optically anisotropic film formed by aligning a liquid crystal compound in a predetermined alignment state, using a composition containing a liquid crystal compound (hereinafter, also referred to as “liquid crystal composition”), is used for various applications such as an optical compensation sheet. The liquid crystal composition may contain an aligning agent which can restrict aligning properties of the liquid crystal compound from the air interface side (hereinafter, also referred to as “air interface side aligning agent”), and as such an aligning agent, a fluorine-based aligning agent having a perfluoroalkyl chain, which has a low surface free energy and is likely to be surface-biased, has been widely used in the related art. However, in recent years, a PFAS-free alternative material has been required from the viewpoint of environmental pollution, and a silicon-based aligning agent has been expected as an alternative.

A silicon-containing compound has been used for various applications in the related art. For example, JP2016-534161A discloses a polyorganosiloxane which can be used in applications such as a surface treatment agent for various functional fillers, and specific examples thereof include the following compounds.

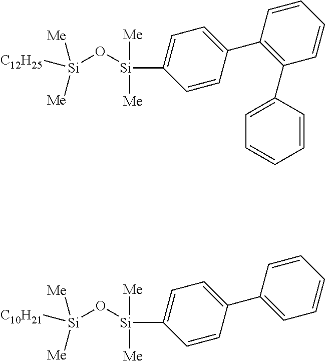

### SUMMARY OF THE INVENTION

In order to confirm alignment-controlling ability of the silicon-containing compound disclosed in JP2016-534161A, the present inventors have prepared a liquid crystal composition obtained by mixing the above-described silicon-containing compound with a liquid crystal compound, and studied a film formed of the liquid crystal composition; and as a result, it is clarified that aligning properties of the liquid crystal compound are insufficient and a large number of visible non-uniformities occur in the film. That is, it is clarified that further improvement is required to achieve both favorable aligning properties of the liquid crystal compound and suppression of the visible non-uniformity.

Therefore, an object of the present invention is to provide a liquid crystal composition capable of forming a film having excellent aligning properties of a liquid crystal compound with reduced visible non-uniformity.

Another object of the present invention is to provide a cured product formed of the above-described liquid crystal composition, and a film.

Still another object of the present invention is to provide a compound which can be used in the above-described liquid crystal composition.

The present inventors have found that the above-described objects can be achieved by the following configurations.

[1] A liquid crystal composition comprising:
a compound represented by Formula (1) described later; and
a liquid crystal compound.

[2] The liquid crystal composition according to [1], in which the substituent T is a monovalent group represented by Formula (TA) described later.

[3] The liquid crystal composition according to [2], in which B represents a monovalent group selected from the group consisting of groups represented by Formula (B-1) to Formula (B-5) described later.

[4] The liquid crystal composition according to [3], in which, in the monovalent group represented by Formula (TA), which is represented by R^{BT} and T^{X} in Formula (B-1) to Formula (B-5), m represents 1, and L represents a chain-like alkylene group having 1 to 4 carbon atoms, in which at least one —CH₂— may be replaced with —NH—, —O—, —S—, —CO—, —CS—, —SO—, or —SO₂—.

[5] The liquid crystal composition according to [3], in which B represents a monovalent group selected from the group consisting of groups represented by Formula (B-1-1) to Formula (B-1-5) described later.

[6] The liquid crystal composition according to any one of [2] to [5], in which X represents the monovalent group represented by Formula (C-1), where, in Formula (C-1), R^{C1} to R^{C3} each independently represent an alkyl group having 1 to 4 carbon atoms, and k represents an integer of 2 to 10.

[7] The liquid crystal composition according to any one of [2] to [5], in which X represents the monovalent group represented by Formula (C-2), where R^{C4} to R^{C6} in Formula (C-2) each independently represent an alkyl group having 1 to 4 carbon atoms.

[8] The liquid crystal composition according to any one of [2] to [5], in which X represents the monovalent group represented by Formula (C-2), where, in Formula (C-2), R^{C4} represents an alkyl group having 1 to 10 carbon atoms, and R^{C5} and R^{C6} each independently represent the monovalent group represented by Formula (C-1X).

[9] The liquid crystal composition according to any one of [2] to [5], in which X represents the monovalent group represented by Formula (C-3), where R^{C7} to R^{C9} in Formula (C-3) each independently represent an alkyl group having 1 to 4 carbon atoms.

[10] The liquid crystal composition according to any one of [2] to [5], in which X represents the monovalent group represented by Formula (C-3), where R^{C7} to R^{C9} in Formula (C-3) each independently represent the monovalent group represented by Formula (C-1X).

[11] The liquid crystal composition according to any one of [1] to [10], in which A¹ to A³ each independently represent a divalent group selected from the group consisting of groups represented by Formula (A-1) to Formula (A-14) described later.

[12] The liquid crystal composition according to [11], in which A¹ to A³ each independently represent a divalent group selected from the group consisting of the groups represented by Formula (A-1) to Formula (A-5) and Formula (A-14), where, in Formula (A-1), Formula (A-3) to Formula (A-5), and Formula (A-14), D's each independently represent CR^{A1}, and R^{A1}'s each independently represent a hydrogen atom or a substituent.

[13] The liquid crystal composition according to any one of [1] to [12], in which a content of a structural moiety represented by —Si—R^{AL} in the compound represented by Formula (1) is less than 1.79%, where R^{AL} represents an alkyl group.

[14] The liquid crystal composition according to any one of [1] to [13], in which a content of a structural moiety represented by —Si—R^{AL} in the compound represented by Formula (1) is more than 1.12%, where R^{AL} represents an alkyl group.

[15] The liquid crystal composition according to any one of [1] to [14], in which the liquid crystal compound is one or more selected from the group consisting of a polymerizable rod-like liquid crystal compound and a polymerizable disk-like liquid crystal compound.

[16] The liquid crystal composition according to any one of [1] to [15], further comprising:
a chiral agent.

[17] A cured product formed of the liquid crystal composition according to any one of [1] to [16].

[18] A film comprising:
the cured product according to [17].

[19] The film according to [18],
in which the film exhibits optical anisotropy.

[20] A film comprising:
a cured product formed of the liquid crystal composition according to [16], in which a cholesteric liquid crystalline phase is fixed.

[21] A compound represented by Formula (1) described later.

[22] The compound according to [21], in which the substituent T is a monovalent group represented by Formula (TA) described later.

[23] The compound according to [22],
in which B represents a monovalent group selected from the group consisting of groups represented by Formula (B-1) to Formula (B-5) described later.

[24] The compound according to [23],
in which, in the monovalent group represented by Formula (TA), which is represented by R^{BT} and T^{X} in Formula (B-1) to Formula (B-5), m represents 1, and L represents a chain-like alkylene group having 1 to 4 carbon atoms, in which at least one —CH₂— may be replaced with —NH—, —O—, —S—, —CO—, —CS—, —SO—, or —SO₂—.

[26] The compound according to [23],
in which B represents a monovalent group selected from the group consisting of groups represented by Formula (B-1-1) to Formula (B-1-5) described later.

[27] The compound according to any one of to [25],
in which X represents the monovalent group represented by Formula (C-1), where, in Formula (C-1), R^{C1} to R^{C3} each independently represent an alkyl group having 1 to 4 carbon atoms, and k represents an integer of 2 to 10.

[28] The compound according to any one of to [25],
in which X represents the monovalent group represented by Formula (C-2), where R^{C4} to R^{C6} in Formula (C-2) each independently represent an alkyl group having 1 to 4 carbon atoms.

[29] The compound according to any one of to [25],
in which X represents the monovalent group represented by Formula (C-2), where, in Formula (C-2), R^{C4} represents an alkyl group having 1 to 10 carbon atoms, and R^{C5} and R^{C6} each independently represent the monovalent group represented by Formula (C-1X).

[30] The compound according to any one of to [25],
in which X represents the monovalent group represented by Formula (C-3), where R^{C7} to R^{C9} in Formula (C-3) each independently represent an alkyl group having 1 to 4 carbon atoms.

[31] The compound according to any one of to [25],
in which X represents the monovalent group represented by Formula (C-3), where R^{C7} to R^{C9} in Formula (C-3) each independently represent the monovalent group represented by Formula (C-1X).

[31] The compound according to any one of to [30],
in which a content of a structural moiety represented by —Si—R^{AL} is less than 1.79%, where R^{AL} represents an alkyl group.

[32] The compound according to any one of to [31],
in which a content of a structural moiety represented by —Si—R^{AL} is more than 1.12%, where R^{AL} represents an alkyl group.

According to the present invention, it is possible to provide a liquid crystal composition capable of forming a film having excellent aligning properties of a liquid crystal compound with reduced visible non-uniformity.

In addition, according to the present invention, it is possible to provide a cured product formed of the above-described liquid crystal composition, and a film.

In addition, according to the present invention, it is possible to provide a compound which can be used in the above-described liquid crystal composition.

### DESCRIPTION OF THE PREFERRED EMBODIMENTS

Hereinafter, the present invention will be described in detail.

Although configuration requirements to be described below are described based on representative embodiments of the present invention, the present invention is not limited to the embodiments.

In the present specification, numerical ranges represented by “to” include numerical values before and after “to” as lower limit values and upper limit values.

In a notation for a group (atomic group) in the present specification, in a case where the group is denoted without specifying whether it is substituted or unsubstituted, the group includes both a group having no substituent and a group having a substituent. For example, an “alkyl group” includes not only an alkyl group having no substituent (unsubstituted alkyl group), but also an alkyl group having a substituent (substituted alkyl group).

In the present specification, for each component, one kind of substance corresponding to each component may be used alone, or two or more kinds thereof may be used in combination. Here, in a case where two or more kinds of substances are used in combination for each component, the content of the component indicates the total content of the substances used in combination, unless otherwise specified.

In the present specification, “(meth)acrylate” is used to mean “any one or both of acrylate and methacrylate”, and “(meth)acryloyl” is used to mean “any one or both of acryloyl and methacryloyl”.

In the present specification, a solid content of a composition means a component forming a composition layer, which does not include a solvent. The component forming the composition layer herein may be a component which reacts (is polymerized) to change a chemical structure in a case of forming the composition layer. In addition, even in a case where the component is liquid, the component is included in the solid content as long as the component forms the composition layer.

A bonding direction of divalent groups cited in the present specification is not limited unless otherwise specified. For example, in a case where Y in a compound represented by Formula “X—Y—Z” is —COO—, Y may be —CO—O— or —O—CO—. In addition, the above-described compound may be “X—CO—O—Z” or “X—O—CO—Z”.

In the present specification, unless otherwise specified, a molecular weight in a case of a molecular weight distribution is a weight-average molecular weight (Mw). In the present specification, a weight-average molecular weight (Mw) and a number-average molecular weight (Mn) are values in terms of polystyrene by gel permeation chromatography (GPC).

In the present specification, Re(λ) represents an in-plane retardation at a wavelength λ. Unless otherwise specified, the wavelength λ is 550 nm.

In addition, in the present specification, Re(λ) is a value measured at the wavelength λ using AxoScan (manufactured by Axometrics, Inc.). By inputting an average refractive index ((nx+ny+nz)/3) and a film thickness (d(μm)) in AxoScan,
a slow axis direction) (°),
Re(λ)═R0(λ), and
are calculated.

Although R0(λ) is displayed as a numerical value calculated by AxoScan, it means Re(λ).

### [Liquid Crystal Composition]

The liquid crystal composition contains a compound represented by Formula (1) described later (hereinafter, also referred to as “specific compound”), and a liquid crystal compound. A film formed of the liquid crystal composition having the above-described configuration has excellent aligning properties of the liquid crystal compound with reduced visible non-uniformity.

Although the mechanism of the action of the specific compound is not necessarily clear, it is presumed that the specific compound provides a high alignment restriction force on the liquid crystal compound mainly due to the following: the specific compound has favorable compatibility with the liquid crystal compound due to a predetermined mesogen structural moiety having 3 or more rings, represented by “B—Z¹-A¹-72-A²-(Z³-A³)ₙ₁-” (the mesogen structural moiety includes at least three rings of an aromatic ring included in B, and an aromatic ring or an aliphatic ring included in A¹ and A²); and the specific compound is likely to be surface-enriched at a surface of the film due to a monovalent substituent T having a siloxane structure including three or more silicon atoms. In addition, it is presumed that the specific compound has excellent surface maldistribution and excellent surface tension reducing ability due to the above-described substituent T, and as a result, thickness unevenness is suppressed, and thus visible non-uniformity of the film is suppressed.

In the following, in the film formed of the liquid crystal composition, the fact that the aligning properties of the liquid crystal compound are more excellent and/or the visible non-uniformity is reduced is also referred to as “the effect of the present invention is more excellent”.

Hereinafter, each component contained in the liquid crystal composition will be described in detail.

### [Specific Compound]

The liquid crystal composition contains a compound represented by Formula (1) (specific compound).

Hereinafter, the specific compound will be described in detail. In the following description, a wavy line shown in a structural formula represents a bonding position unless otherwise specified.

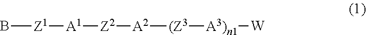

In Formula (1), A¹ to A³ each independently represent a divalent aromatic ring group or a divalent aliphatic ring group.

The divalent aromatic ring group represented by A¹ to A³ may be a divalent aromatic hydrocarbon ring group or a divalent aromatic heterocyclic group. In addition, the divalent aromatic ring group may be monocyclic or polycyclic.

The number of carbon atoms in the aromatic hydrocarbon ring constituting the divalent aromatic hydrocarbon ring group is preferably 6 to 30, more preferably 6 to 18, and still more preferably 6 to 10. Specific examples of the aromatic hydrocarbon ring include a benzene ring, a naphthalene ring, an anthracene ring, a phenanthrene ring, a fluorene ring, and a fluorenone ring; and a benzene ring is more preferable.

The number of ring members in an aromatic heterocyclic ring constituting the divalent aromatic heterocyclic group is not particularly limited, and is preferably 5 to 10 and more preferably 5 or 6. Examples of a heteroatom included in the aromatic heterocyclic ring include a nitrogen atom, an oxygen atom, and a sulfur atom. The number of heteroatoms included in the aromatic heterocyclic ring is not particularly limited, but for example, it is preferably 1 to 4 and more preferably 1 or 2. Specific examples of the aromatic heterocyclic ring include a pyridine ring, a pyrimidine ring, a quinoline ring, an isoquinoline ring, and a coumarin ring.

The divalent aliphatic ring group may be a divalent aliphatic hydrocarbon ring group or a divalent aliphatic heterocyclic group. In addition, the divalent aliphatic ring group may be monocyclic or polycyclic.

The number of carbon atoms in the aliphatic hydrocarbon ring constituting the divalent aliphatic hydrocarbon ring group is preferably 5 to 30, more preferably 5 to 18, still more preferably 5 to 10, and particularly preferably 5 or 6. Specific examples of the aliphatic hydrocarbon ring include a cyclopentane ring, a cyclohexane ring, a cycloheptane ring, a cyclooctane ring, a norbornene ring, and an adamantane ring. Among these, a cyclopentane ring or a cyclohexane ring is preferable.

The number of carbon atoms in an aliphatic heterocyclic ring constituting the divalent aliphatic heterocyclic group is preferably 3 to 30, more preferably 3 to 18, and still more preferably 3 to 10. Examples of a heteroatom included in an aliphatic heterocyclic ring constituting the divalent aliphatic heterocyclic group include a nitrogen atom, an oxygen atom, and a sulfur atom. The number of ring members in the aliphatic heterocyclic ring is not particularly limited, but is preferably 5 to 10. Specific examples of the aliphatic heterocyclic ring include an oxolane ring, an oxane ring, a piperidine ring, and a piperazine ring. In the aliphatic heterocyclic ring, —CH₂-constituting the ring may be replaced with —CO—, and examples thereof include a phthalimide ring.

In addition, a hydrogen atom in the above-described divalent aromatic ring group and divalent aliphatic ring group may be substituted with another substituent such as an alkyl group, an alkoxy group, a cyano group, a nitro group, and a halogen atom. The above-described substituent is preferably a substituent other than the above-described substituent T, and a substituent S1 is more preferable. The substituent S1 will be described in a later section.

In a case where the divalent aromatic ring group represented by A¹ to A³ is a phenylene group, from the viewpoint that the effect of the present invention is more excellent, a 1,4-phenylene group or a 1,3-phenylene group is preferable. It is preferable that a position of one bonding site of A¹ to A³ is a meta position or a para position with respect to the other bonding site.

A¹ to A³ preferably represent a divalent group selected from the group consisting of groups represented by Formula (A-1) to Formula (A-14).

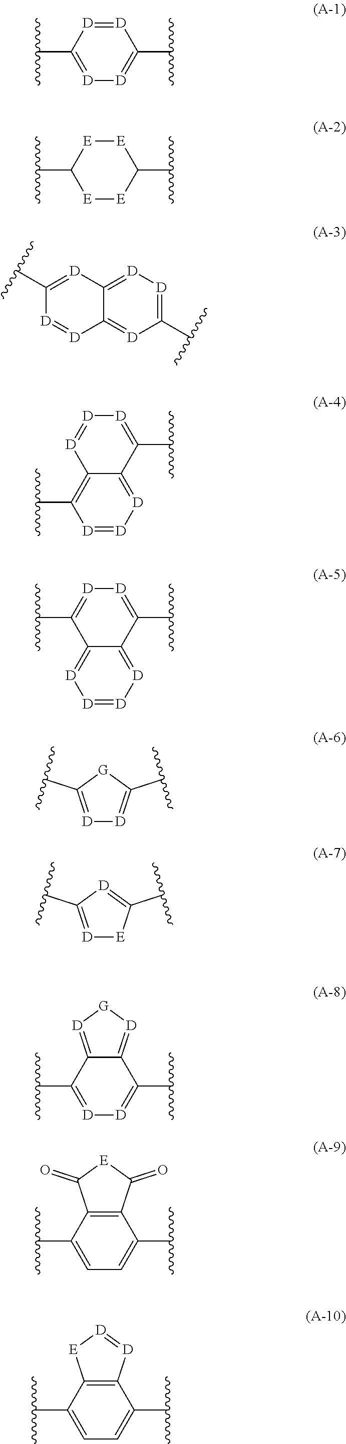

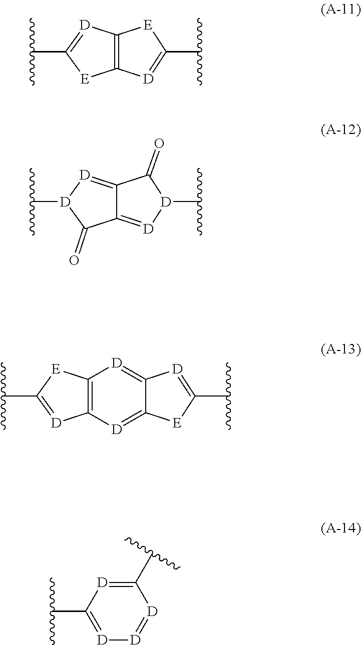

In Formula (A-1) to Formula (A-14), D's each independently represent CR^{A1} or a nitrogen atom.

Among these, as D, CR^{A1} is preferable.

R^{A1}'s each independently represent a hydrogen atom or a substituent. The substituent represented by R^{A1} is preferably a substituent other than the above-described substituent T, and a substituent S1 is more preferable. The substituent S1 will be described in a later section.

Among these, as R^{A1}, a hydrogen atom, an alkyl group, an alkoxy group, or an alkoxycarbonyl group is preferable.

E's each independently represent CR^{A2}R^{A3}, NR^{A4}, an oxygen atom, or a sulfur atom.

Among these, as E, CR^{A2}R^{A3}, NR^{A4}, or an oxygen atom is preferable.

G represents CR^{A5}R^{A6}, NR^{A7}, a sulfur atom, or an oxygen atom.

R^{A2} to R^{A7} each independently represent a hydrogen atom or a substituent. The substituent represented by R^{A2} to R^{A7} is preferably a substituent other than the above-described substituent T, and the substituent S1 is more preferable. The substituent S1 will be described in a later section.

Among these, as R^{A2} to R^{A7}, a hydrogen atom, an alkyl group, an alkoxy group, or an alkoxycarbonyl group is preferable.

As A¹ to A³, among these, from the viewpoint that the effect of the present invention is more excellent, a divalent group selected from the group consisting of the groups represented by Formula (A-1) to Formula (A-5) and Formula (A-14) is preferable; and a divalent group selected from the group consisting of the groups represented by Formula (A-1), Formula (A-3) to Formula (A-5), and Formula (A-14), in which D in each formula represents CR^{A1}, is more preferable.

In Formula (1), in a case where n1 represents an integer of 2 or more, a plurality of A³'s may be the same or different from each other.

In Formula (1), Z¹ to Z³ each independently represent a single bond or a divalent linking group.

The divalent linking group represented by Z¹ to Z³ is not particularly limited, and is preferably-CO—, —O—, —S—, —CS—, —CR^{A}R^{B}—, —CR^{C}—CR^{D}—, —NR^{E}—, —N═N—, —CH═N—, —C≡C—, or a divalent linking group consisting of a combination of two or more of these groups. RA to RE each independently represent a hydrogen atom, a fluorine atom, or an alkyl group having 1 to 12 carbon atoms.

Specific examples of the divalent linking group represented by Z¹ to Z³ include-O—, —S—, —OCH₂—, —CH₂CH₂—, —CO—, —CS—, —COO—, —CSO—, —CSS—, —CO—S—, —O—CO—O—, —CO—CO—, —CO—NH—, —SCH₂—, —CF₂O—, —CF₂S—, —CH═CH—COO—, —CH═CH—OCO—, —COO—CH₂CH₂—, —OCO—CH₂CH₂—, —COO—CH₂—, —OCO—CH₂—, —COO—NH—, —CH═CH—, —N═N—, —CH═N—N═CH—, —CH═N—, —CF═CF—, —C≡C—, —C≡C—C≡C—, —OCH₂CH₂O—, —SCH₂CH₂S—, —O—CO—CO—O—, and —O—CH₂—O—.

Among these, from the viewpoint that the effect of the present invention is more excellent, Z¹ to Z³ preferably represent a single bond, —O—, —CO—, —COO—, —CO—NH—, —CH═CH—COO—, —CH═CH—OCO—, —CH—CH—, or —C≡C—, and more preferably represent a single bond, —O—, —CO—, or —COO—.

In Formula (1), in a case where n1 represents an integer of 2 or more, a plurality of Z³'s may be the same or different from each other.

In Formula (1), n1 represents an integer of 0 or more.

The upper limit value of n1 is preferably 100 or less, more preferably 50 or less, still more preferably 30 or less, even more preferably 10 or less, particularly preferably 6 or less, and most preferably 3 or less.

In Formula (1), B represents a monovalent aromatic ring group in which one or more monovalent substituents T having a siloxane structure including three or more silicon atoms are substituted.

The siloxane structure including three or more silicon atoms corresponds to a structure including three or more silicon atoms and having a siloxane bond. Specific examples of the siloxane structure including three or more silicon atoms include a structure including a monovalent group represented by Formulae (C-1) to (C-3) described later.

As the monovalent substituent T having a siloxane structure including three or more silicon atoms (hereinafter, may also be abbreviated as “substituent T”), from the viewpoint that the effect of the present invention is more excellent, a monovalent group represented by Formula (TA) is preferable.

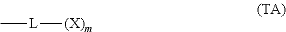

In Formula (TA), L represents a single bond or a chain-like (linear or branched) (m+1)-valent hydrocarbon group. Here, in the above-described hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one —CH< may be replaced with —N< or —SiH<, and at least one >C< may be replaced with >Si<.

The number of atoms in the chain-like (m+1)-valent hydrocarbon group represented by L, other than hydrogen atoms, is, for example, preferably 1 to 50, more preferably 1 to 40, still more preferably 1 to 30, even more preferably 1 to 20, particularly preferably 1 to 18, and most preferably 1 to 15.

Specific examples of the chain-like (m+1)-valent hydrocarbon group represented by L include a chain-like (m+1)-valent aliphatic hydrocarbon group.

From the viewpoint that the effect of the present invention is more excellent, L preferably represents a chain-like (preferably linear) alkylene group having 1 to 10 carbon atoms, in which at least one —CH₂— may be replaced with —NH—, —O—, —S—, —CO—, —CS—, —SO—, or —SO₂—; more preferably represents a chain-like (preferably linear) alkylene group having 1 to 6 carbon atoms, in which at least one —CH₂— may be replaced with —NH—, —O—, —S—, —CO—, —CS—, —SO—, or —SO₂—; and still more preferably represents a chain-like (preferably linear) alkylene group having 1 to 4 carbon atoms, in which at least one —CH₂— may be replaced with —NH—, —O—, —S—, —CO—, —CS—, —SO—, or —SO₂—.

In Formula (TA), m represents an integer of 1 or more.
m is preferably an integer of 1 to 4, more preferably 1 or 2, and still more preferably 1.

In Formula (TA), X represents a monovalent group selected from the group consisting of the groups represented by Formula (C-1) to Formula (C-3). In a case where m is an integer of 2 or more, a plurality of X's may be the same or different from each other.

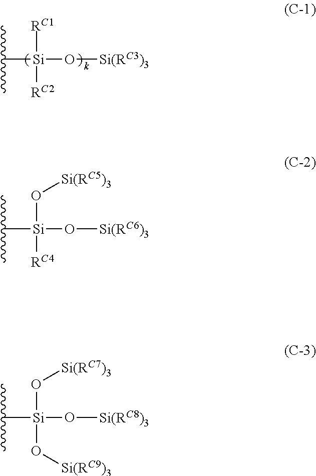

In Formula (C-1), R^{C1} to R^{C3} each independently represent an alkyl group having 1 to 10 carbon atoms, and k represents an integer of 2 to 20. In Formula (C-2), R^{C4} represents an alkyl group having 1 to 10 carbon atoms, and R^{C5} and R^{C6} each independently represent an alkyl group having 1 to 10 carbon atoms or a monovalent group represented by Formula (C-1X). In Formula (C-3), R^{C7} to R^{C9} each independently represent an alkyl group having 1 to 10 carbon atoms or a monovalent group represented by Formula (C-1X). In Formula (C-1), a plurality of R^{C1}'s, a plurality of R^{C2}'s, and a plurality of R^{C3}'s may be the same or different from each other. In Formula (C-2), a plurality of R^{C5}'s and a plurality of R^{C6}'s may be the same or different from each other. In Formula (C-3), a plurality of R^{C7}'s, a plurality of R^{C8}'s, and a plurality of R^{C9}'s may be the same or different from each other.

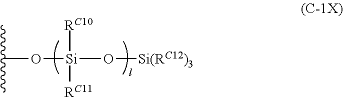

In Formula (C-1X), R^{C10} to R^{C12} each independently represent an alkyl group having 1 to 10 carbon atoms, and 1 represents an integer of 0 to 20. In Formula (C-1X), a plurality of R^{C10}'s, a plurality of R^{C11}'s, and a plurality of R^{C12}'s may be the same or different from each other.

In Formula (C-1) to Formula (C-3), and Formula (C-1X), the alkyl group having 1 to 10 carbon atoms represented by R^{C1} to R^{C12} is preferably a chain-like (linear or branched) alkyl group having 1 to 10 carbon atoms, and more preferably a linear alkyl group having 1 to 10 carbon atoms.

In particular, the number of carbon atoms in the alkyl group having 1 to 10 carbon atoms, represented by R^{C1} to R^{C12}, is preferably 1 to 6 and more preferably 1 to 4.

The alkyl group having 1 to 10 carbon atoms, represented by R^{C1} to R^{C12}, may have a substituent (preferably, the substituent S1 described later), but preferably does not have a substituent.

Among these, R^{C1} to R^{C4} and R^{C10} to R^{C12} are preferably an alkyl group having 1 to 4 carbon atoms, more preferably an alkyl group having 1 to 3 carbon atoms, and still more preferably a methyl group.

Among these, R^{C5} to R^{C9} are preferably an alkyl group having 1 to 4 carbon atoms (preferably an alkyl group having 1 to 3 carbon atoms and more preferably a methyl group) or a monovalent group represented by Formula (C-1X).

In Formula (C-1), k represents an integer of 2 to 20.

From the viewpoint that the effect of the present invention is more excellent, k preferably represents an integer of 2 to 10, and more preferably represents an integer of 2 to 6.

In Formula (C-1X), 1 represents an integer of 0 to 20.

From the viewpoint that the effect of the present invention is more excellent, 1 preferably represents an integer of 0 to 10, and more preferably represents an integer of 0 to 6.

From the viewpoint that the effect of the present invention is more excellent, X in Formula (TA) is also preferably any one aspect of the following (1) to (5).
(1) X represents the monovalent group represented by Formula (C-1), in which, in Formula (C-1), R^{C1} to R^{C3} each independently represent an alkyl group having 1 to 4 carbon atoms, and k represents an integer of 2 to 10.
(2) X represents the monovalent group represented by Formula (C-2), in which R^{C4} to R^{C6} in Formula (C-2) each independently represent an alkyl group having 1 to 4 carbon atoms.
(3) X represents the monovalent group represented by Formula (C-2), in which, in Formula (C-2), R^{C4} represents an alkyl group having 1 to 10 carbon atoms, and R^{C5} and R^{C6} each independently represent the monovalent group represented by Formula (C-1X).
(4) X represents the monovalent group represented by Formula (C-3), in which R^{C7} to R^{C9} in Formula (C-3) each independently represent an alkyl group having 1 to 4 carbon atoms.
(5) X represents the monovalent group represented by Formula (C-3), in which R^{C7} to R^{C9} in Formula (C-3) each independently represent the monovalent group represented by Formula (C-1X).

As the aspect of (3), an aspect of (3A) is also preferable.
(3A) X represents the monovalent group represented by Formula (C-2), in which, in Formula (C-2), R^{C4} represents an alkyl group having 1 to 10 carbon atoms, R^{C5} and R^{C6} each independently represent the monovalent group represented by Formula (C-1X), and R^{C10} to R^{C12} in Formula (C-1X) each independently represent an alkyl group having 1 to 4 carbon atoms.

As the aspect of (5), an aspect of (5A) is also preferable.
(5A) X represents the monovalent group represented by Formula (C-3), in which R^{C7} to R^{C9} in Formula (C-3) each independently represent the monovalent group represented by Formula (C-1X), and R^{C10} to R^{C12} in Formula (C-1X) each independently represent an alkyl group having 1 to 4 carbon atoms.

An aromatic ring constituting the monovalent aromatic ring group in which one or more substituents T are substituted, represented by B in Formula (1), may be an aromatic hydrocarbon ring or an aromatic heterocyclic ring. That is, the above-described monovalent aromatic ring group may be a monovalent aromatic hydrocarbon ring group or a monovalent aromatic heterocyclic group. In addition, the above-described aromatic ring may be monocyclic or polycyclic.

The number of carbon atoms in the aromatic hydrocarbon ring constituting the monovalent aromatic hydrocarbon ring group is preferably 6 to 30, more preferably 6 to 18, and still more preferably 6 to 10. Specific examples of the aromatic hydrocarbon ring include a benzene ring and a naphthalene ring; a benzene ring is more preferable.

The number of ring members in an aromatic heterocyclic ring constituting the monovalent aromatic heterocyclic group is not particularly limited, and is preferably 5 to 10 and more preferably 5 or 6. Examples of a heteroatom included in the aromatic heterocyclic ring include a nitrogen atom, an oxygen atom, and a sulfur atom. The number of heteroatoms included in the aromatic heterocyclic ring is not particularly limited, but for example, it is preferably 1 to 4 and more preferably 1 or 2. Specific examples of the aromatic heterocyclic ring include a pyridine ring, a pyrimidine ring, a quinoline ring, an isoquinoline ring, and a coumarin ring.

Among these, the above-described monovalent aromatic ring group is preferably a monovalent aromatic hydrocarbon ring group, and more preferably a phenyl group or a naphthyl group.

The number of substituents T included in the above-described monovalent aromatic ring group is not particularly limited, but is preferably 1 to 4, more preferably 1 to 3, and still more preferably 1 or 2.

In addition, the above-described monovalent aromatic ring group may have a substituent other than the substituent T. Examples of other substituents include the above-described substituent S1.

Among these, from the viewpoint that the effect of the present invention is more excellent, the monovalent aromatic ring group substituted with one or more substituents T, represented by B in Formula (1), is preferably a monovalent group selected from the group consisting of groups represented by Formula (B-1) to Formula (B-5).

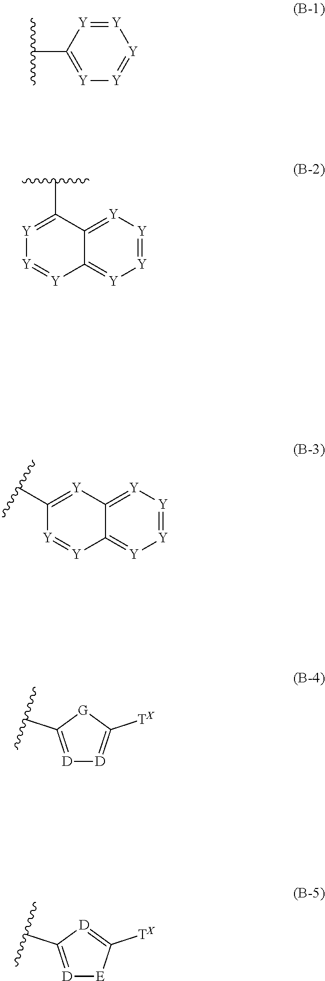

In Formula (B-1) to Formula (B-3), Y's each independently represent CR^{B1} or a nitrogen atom.

Among these, as Y, CR^{B1} is preferable.

R^{B1}'s each independently represent a hydrogen atom or a substituent. Here, in each of the monovalent groups represented by Formulae (B-1) to (B-3), at least one of Y's represents CR^{BT}. R^{BT} represents the above-described monovalent group represented by Formula (TA).

In each of the monovalent groups represented by Formula (B-1) to Formula (B-3), it is preferable that one to three of Y's represent CR^{BT}, and it is more preferable that one or two of Y's represent CR^{BT}.

In a case where RBI represents a substituent other than the above-described monovalent group represented by Formula (TA) (the above-described group represented by R^{BT}), the substituent is preferably a substituent other than the above-described substituent T, and more preferably a substituent S1. The substituent S1 will be described in a later section.

Among these, R^{B1} is preferably a hydrogen atom, an alkyl group, an alkoxy group, an alkoxycarbonyl group, or the above-described monovalent group represented by Formula (TA), and more preferably a hydrogen atom or the above-described monovalent group represented by Formula (TA).

In Formulae (B-4) and (B-5), D, E, and G have the same meaning as D, E, and G in Formulae (A-1) to (A-13), and suitable aspects thereof are also the same.

In Formula (B-4) and Formula (B-5), T^{X} represents the above-described monovalent group represented by Formula (TA).

In Formulae (B-1) to (B-5), the above-described monovalent group represented by R^{BT} and T^{X}, which is represented by Formula (TA), has the same meaning as the monovalent group represented by Formula (TA) described as a suitable aspect of the substituent T included in B in Formula (1), and suitable aspects thereof are also the same.

In Formula (1), as B, among these, from the viewpoint that the effect of the present invention is more excellent, a group selected from the group consisting of the groups represented by Formulae (B-1) to (B-3) is preferable, the group represented by Formula (B-1) is more preferable, and a group selected from groups consisting of Formulae (B-1-1) to (B-1-5) is particularly preferable.

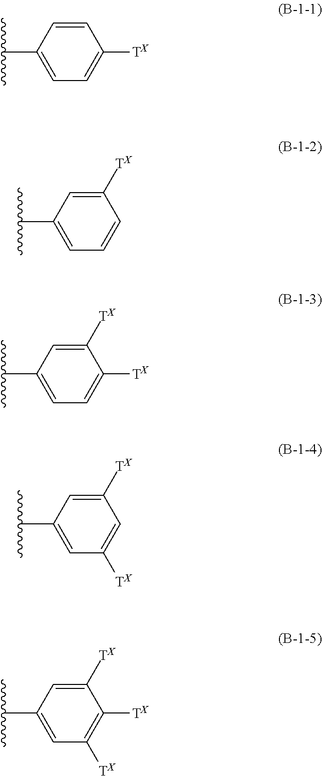

In Formula (B-1-1) to Formula (B-1-5), T^{X} represents the above-described monovalent group represented by Formula (TA).

From the viewpoint that the effect of the present invention is more excellent, m in the monovalent group represented by Formula (TA), represented by T^{X}, preferably represents 1. Hereinafter, the substituent S1 will be described.

### (Substituent S1)

The substituent S1 is a group selected from the group consisting of a halogen atom, an alkyl group, a cycloalkyl group, an alkenyl group, a cycloalkenyl group, an alkynyl group, an aryl group, a heterocyclic group, a cyano group, a hydroxy group, a nitro group, a carboxyl group, an alkoxy group, an alkoxycarbonyl group, an aryloxy group, a silyloxy group, a heterocyclic oxy group, an acyloxy group, a carbamoyloxy group, an amino group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, a carbamoyl group, an arylazo or heterocyclic azo group, an imide group, a phosphino group, a phosphinyl group, a phosphinyloxy group, a phosphinylamino group, and a silyl group.

In addition, each of the above-described groups may further have a substituent (for example, one or more groups of each of the above-described groups) as appropriate. For example, an alkyl group which may have a substituent is also included as the form of the substituent S1.

In addition, in a case where the substituent S1 has a carbon atom, the number of carbon atoms in the substituent S1 is, for example, 1 to 20.

In addition, the number of atoms in the substituent S1, other than hydrogen atoms, is, for example, 1 to 30.

In the substituent S1, examples of the halogen atom include a fluorine atom, a chlorine atom, a bromine atom, and an iodine atom.

In the substituent S1, the number of carbon atoms in the (linear or branched) alkyl group is preferably 1 to 20, more preferably 1 to 10, and still more preferably 1 to 6. Examples of the alkyl group include a methyl group, an ethyl group, a n-propyl group, an i-propyl group, a n-butyl group, a tert-butyl group, and a n-hexyl group.

In the substituent S1, the cycloalkyl group may be monocyclic or polycyclic. Examples of an aspect in which the cycloalkyl group is polycyclic include a bicycloalkyl group. The number of carbon atoms in the cycloalkyl group is preferably 3 to 20, more preferably 3 to 10, still more preferably 6 to 10, and particularly preferably 6.

In the substituent S1, the number of carbon atoms in the (linear or branched) alkenyl group is preferably 2 to 20, more preferably 2 to 10, and still more preferably 2 to 6.

In the substituent S1, the number of carbon atoms in the cycloalkenyl group is preferably 3 to 20, more preferably 3 to 10, still more preferably 6 to 10, and particularly preferably 6.

In the substituent S1, the number of carbon atoms in the alkynyl group is preferably 2 to 20, more preferably 2 to 10, and still more preferably 2 to 6.

In the substituent S1, an alkyl moiety in each of the alkoxy group, the alkoxycarbonyl group, the alkylthio group, the alkoxycarbonylamino group, the alkylsulfonylamino group, the alkylsulfinyl group, and the alkylsulfonyl group preferably has the same aspect as the above-described (linear or branched) alkyl group.

In the substituent S1, a hydrocarbon ring constituting the aryl group may be a monocyclic ring or a polycyclic ring (for example, a 2- to 6-membered ring or the like). The number of ring member atoms in the aryl group is preferably 5 to 15, more preferably 6 to 10, and still more preferably 6.

In the substituent S1, an aryl moiety in each of the aryloxy group, the aryloxycarbonylamino group, the arylsulfonylamino group, the arylthio group, the arylsulfinyl group, the arylsulfonyl group, the aryloxycarbonyl group, and the arylazo group preferably has the same aspect as the above-described aryl group.

In the substituent S1, a hydrocarbon ring constituting the heterocyclic group (heteroaryl group) may be a monocyclic ring or a polycyclic ring (for example, a 2- to 6-membered ring or the like). The number of ring member atoms in the heterocyclic group is preferably 5 to 15, and more preferably 5 or 6. In the heterocyclic group, the number of heteroatoms as the ring member atoms is, for example, 1 to 10, preferably 1 to 3, and more preferably 1 or 2. Examples of the above-described heteroatom include a nitrogen atom, a sulfur atom, and an oxygen atom.

In the substituent S1, a heterocyclic group moiety in each of the heterocyclic oxy group (heteroaryloxy group), the heterocyclic thio group (heteroarylthio group), and the heterocyclic azo group (heteroarylazo group) preferably has the same aspect as the above-described heterocyclic group (heteroaryl group).

In the substituent S1, the acyl group may be an alkylcarbonyl group or an arylcarbonyl group. An alkyl moiety in the alkylcarbonyl group preferably has the same aspect as the above-described (linear or branched) alkyl group. In addition, an aryl group moiety in the arylcarbonyl group preferably has the same aspect as the above-described aryl group.

In the substituent S1, an acyl group moiety in each of the acyloxy group and the acylamino group preferably has the same aspect as the above-described acyl group. Specifically, the acyloxy group may be an alkylcarbonyloxy group or an arylcarbonyloxy group, and the acylamino group may be an alkylcarbonylamino group or an arylcarbonylamino group.

In the substituent S1, the amino group may be an unsubstituted amino group (—NH₂) or a substituted amino group (—NHR or —N(R)₂).

The substituent (R) in the substituted amino group is preferably an alkyl group or the like.

The above-described alkyl group is preferably linear or branched. In addition, the number of carbon atoms is preferably 1 to 20, more preferably 1 to 10, and still more preferably 1 to 6. Examples of the alkyl group include a methyl group, an ethyl group, a n-propyl group, an i-propyl group, a n-butyl group, a tert-butyl group, and a n-hexyl group.

In the substituent S1, an amino group moiety in each of the acylamino group, the aminocarbonylamino group, the alkoxycarbonylamino group, the aryloxycarbonylamino group, the sulfamoylamino group, the alkylsulfonylamino or arylsulfonylamino group, and the phosphinylamino group may be an unsubstituted amino group (—NH—) or a substituted amino group (—NR—).

The substituent (R) in the substituted amino group is preferably an alkyl group or the like.

The above-described alkyl group is preferably linear or branched. In addition, the number of carbon atoms is preferably 1 to 20, more preferably 1 to 10, and still more preferably 1 to 6. Examples of the alkyl group include a methyl group, an ethyl group, a n-propyl group, an i-propyl group, a n-butyl group, a tert-butyl group, and a n-hexyl group.

In the substituent S1, the silyl group is preferably a group represented by —Si(R)₃.

R's in the silyl group each independently represent a substituent.

The substituent represented by R is preferably an alkyl group, an aryl group, or the like.

The above-described alkyl group is preferably linear or branched. In addition, the number of carbon atoms is preferably 1 to 20, more preferably 1 to 10, and still more preferably 1 to 6.

The above-described aryl group preferably has the same aspect as the above-described aryl group, and a phenyl group is more preferable.

In the substituent S1, a silyl group moiety in the silyloxy group preferably has the same aspect as the above-described silyl group.

In the substituent S1, the imide group is preferably a group represented by —CO—NR—CO—R or —N(—CO—R)₂.

R's in the imide group each independently represent a hydrogen atom or a substituent.

The substituent represented by R is preferably an alkyl group or an aryl group.

The above-described alkyl group is preferably linear or branched. In addition, the number of carbon atoms is preferably 1 to 20, more preferably 1 to 10, and still more preferably 1 to 6.

The above-described aryl group preferably has the same aspect as the above-described aryl group, and a phenyl group is more preferable.

In Formula (1), W represents a hydrogen atom or a monovalent substituent which does not include a silicon atom.

The monovalent substituent which does not include a silicon atom, represented by W, is not particularly limited, and examples thereof include a halogen atom, an alkyl group, a cycloalkyl group, an alkenyl group, a cycloalkenyl group, an alkynyl group, an aryl group, a heterocyclic group, a cyano group, a hydroxy group, a nitro group, a carboxyl group, an alkoxy group, an alkoxycarbonyl group, an aryloxy group, a heterocyclic oxy group, an acyloxy group, a carbamoyloxy group, an amino group, an acylamino group, an aminocarbonylamino group, an alkoxycarbonylamino group, an aryloxycarbonylamino group, a sulfamoylamino group, an alkylsulfonylamino group, an arylsulfonylamino group, a mercapto group, an alkylthio group, an arylthio group, a heterocyclic thio group, a sulfamoyl group, a sulfo group, an alkylsulfinyl group, an arylsulfinyl group, an alkylsulfonyl group, an arylsulfonyl group, an acyl group, an aryloxycarbonyl group, a carbamoyl group, an arylazo or heterocyclic azo group, an imide group, a phosphino group, a phosphinyl group, a phosphinyloxy group, and a phosphinylamino group. Specific examples of these groups include the same groups as those described in the substituent S1.

Among these, W is preferably a hydrogen atom.

The specific compound preferably includes a structural moiety represented by —Si-R^{AL} (R^{AL} represents an alkyl group).

From the viewpoint that aggregation among the specific compounds is suppressed and thus the aligning properties of the liquid crystal compound are more excellent in the film formed of the liquid crystal composition, an upper limit value of a content of the structural moiety represented by —Si—R^{AL} in the specific compound (hereinafter, also referred to as “Si—R^{AL} content”) is preferably 3.00% or less, more preferably less than 1.79%, and still more preferably 1.70% or less. From the viewpoint that the visible non-uniformity of the film formed of the liquid crystal composition is further suppressed, a lower limit value of the Si—R^{AL} content is preferably 1.05% or more, more preferably more than 1.12%, and still more preferably 1.30% or more.

In addition, the Si—R^{AL} content is obtained by the following expression (S1).

Si—R^{AL} content (%)=(number of structural moieties represented by —Si—R^{AL}/molecular weight of specific compound)×100 Expression (S1)

As an example of the specific compound, a compound having the following structure has nine portions represented by —Si—CH₃, and thus the number of structural moieties represented by —Si—R^{AL} in the compound is 9.

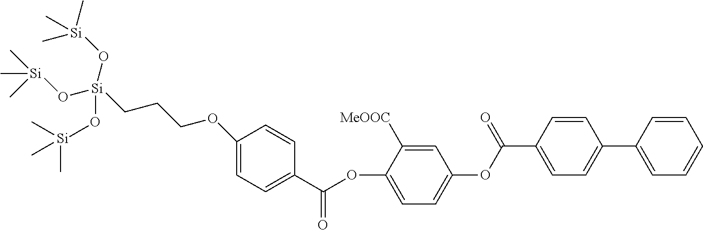 [SMILES: COC(=O)c1cc(OC(=O)c2ccc(-c3ccccc3)cc2)ccc1OC(=O)c1ccc(OCCC[Si](O[Si](C)(C)C)(O[Si](C)(C)C)O[Si](C)(C)C)cc1]

The lower limit value of the molecular weight of the specific compound is preferably 500 or more, more preferably 700 or more, and still more preferably 1,000 or more. In addition, the upper limit value thereof is preferably 5,000 or less, more preferably 4,000 or less, still more preferably 3,000 or less, and particularly preferably 2,000 or less.

Specific examples of the specific compound will be shown below, but the specific compound is not limited thereto.

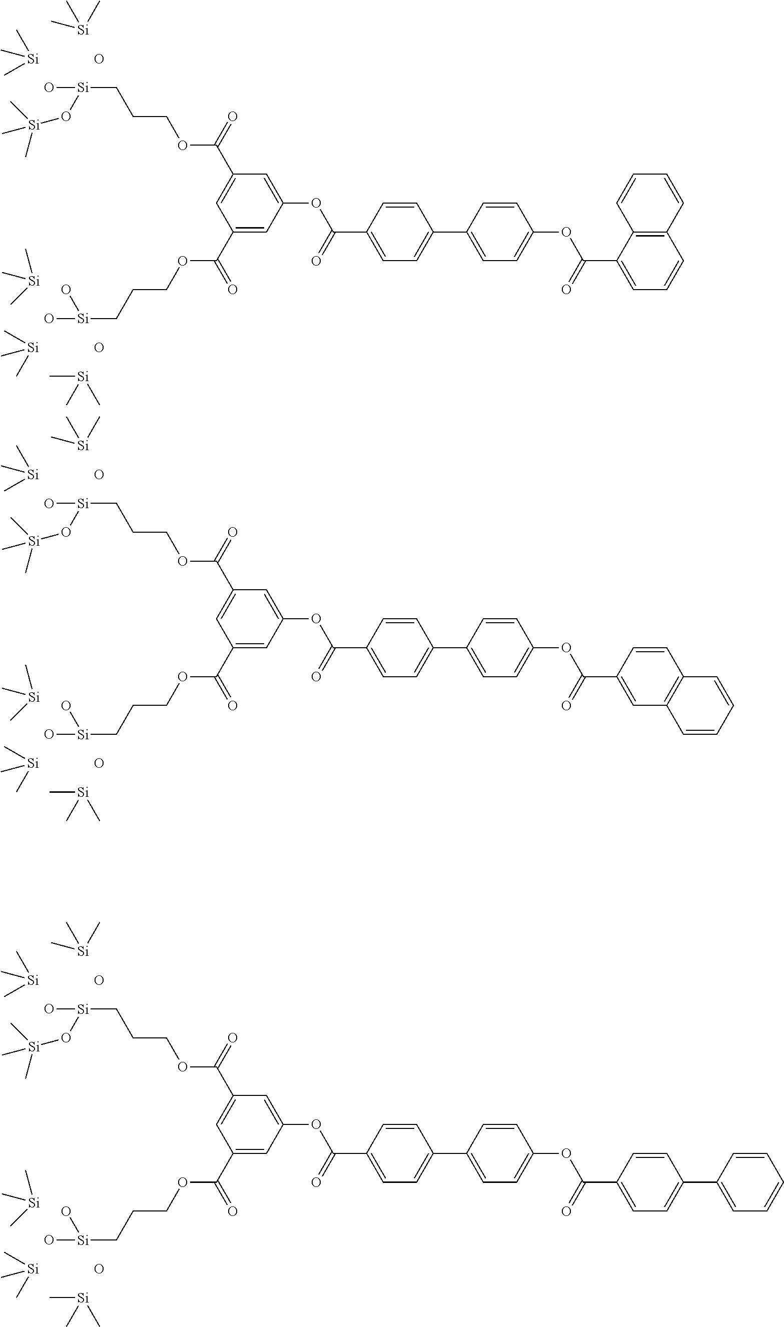

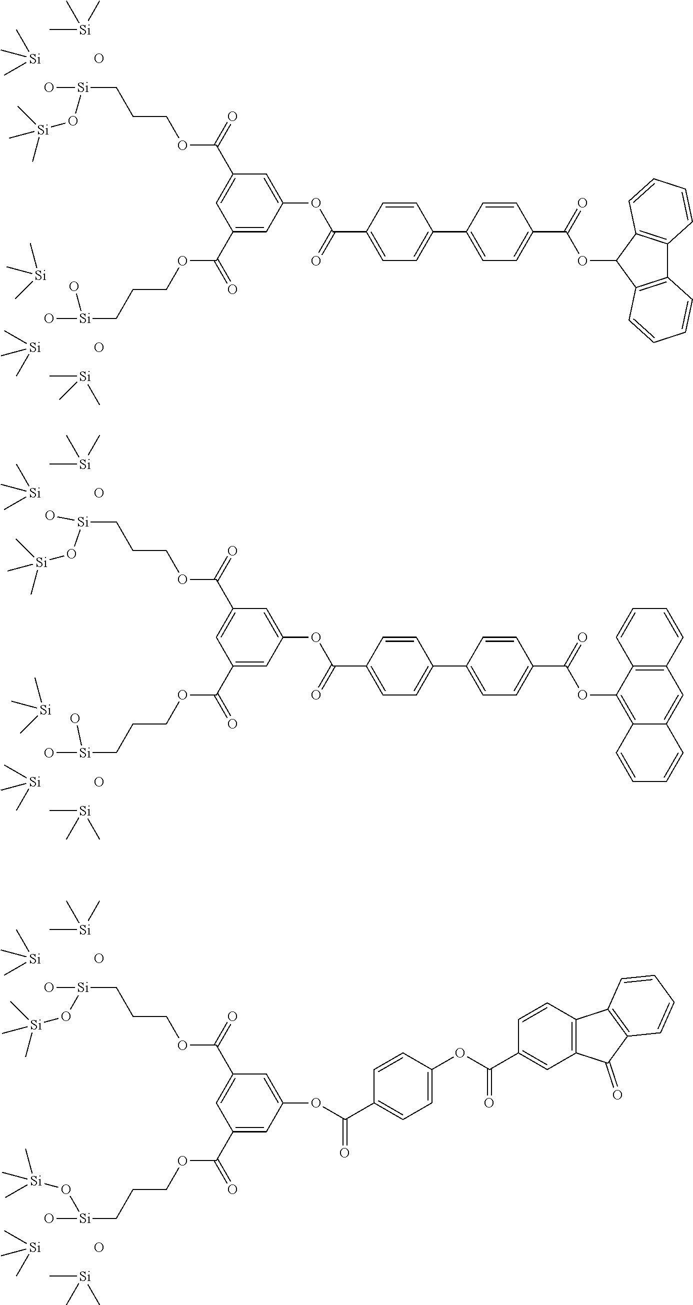

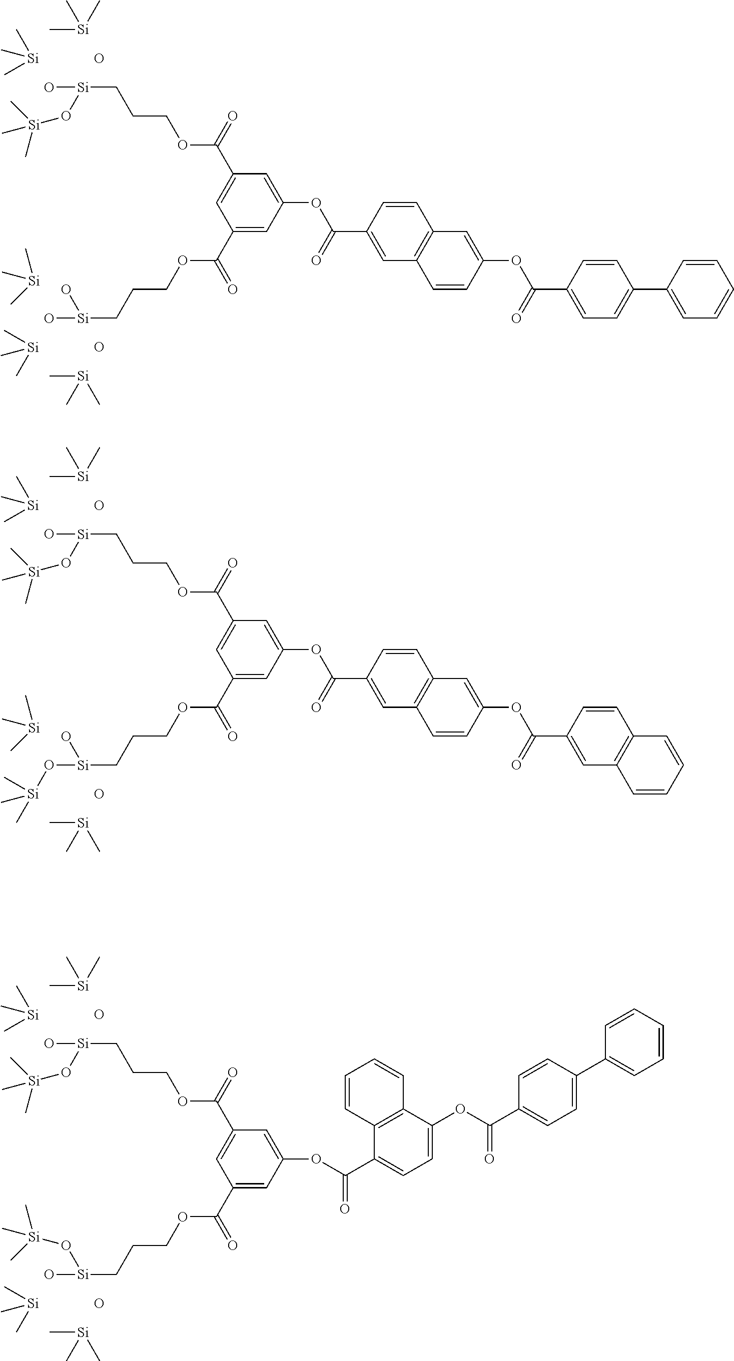

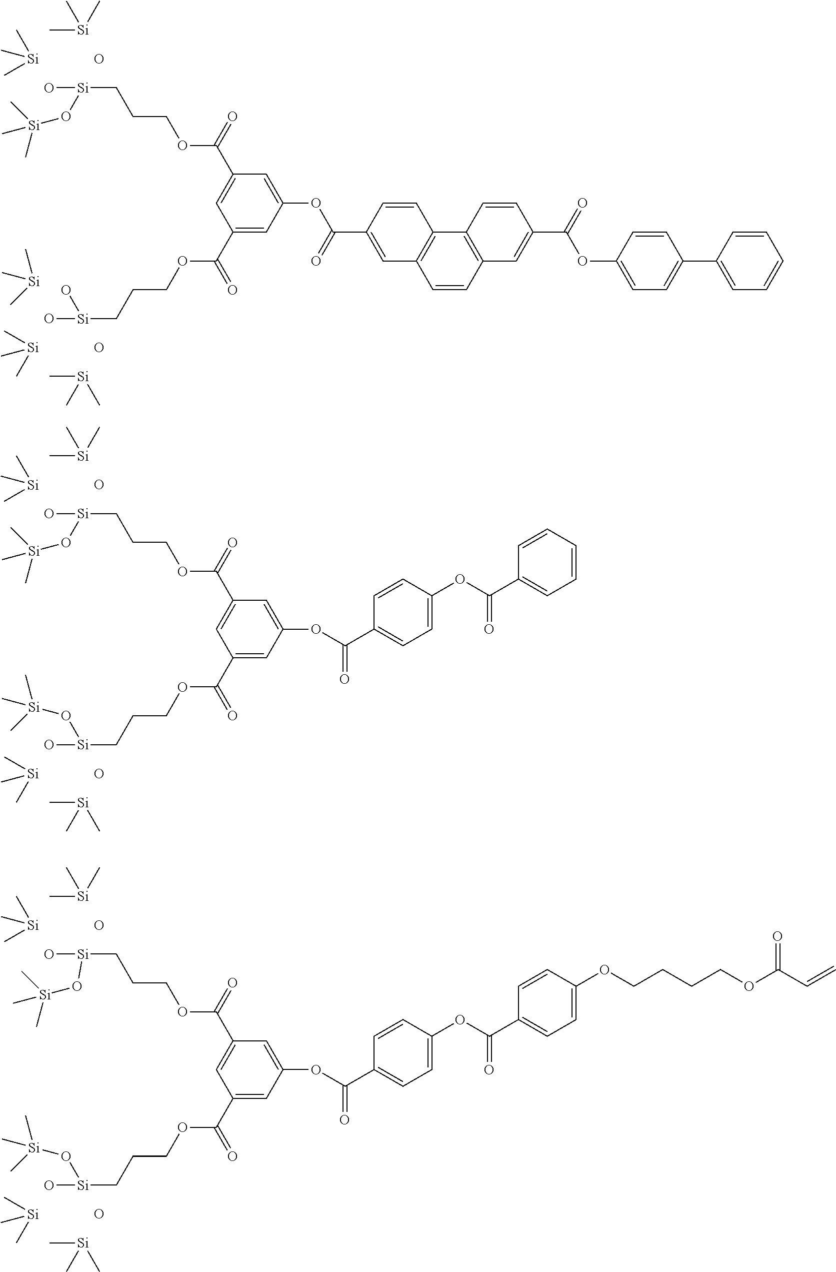

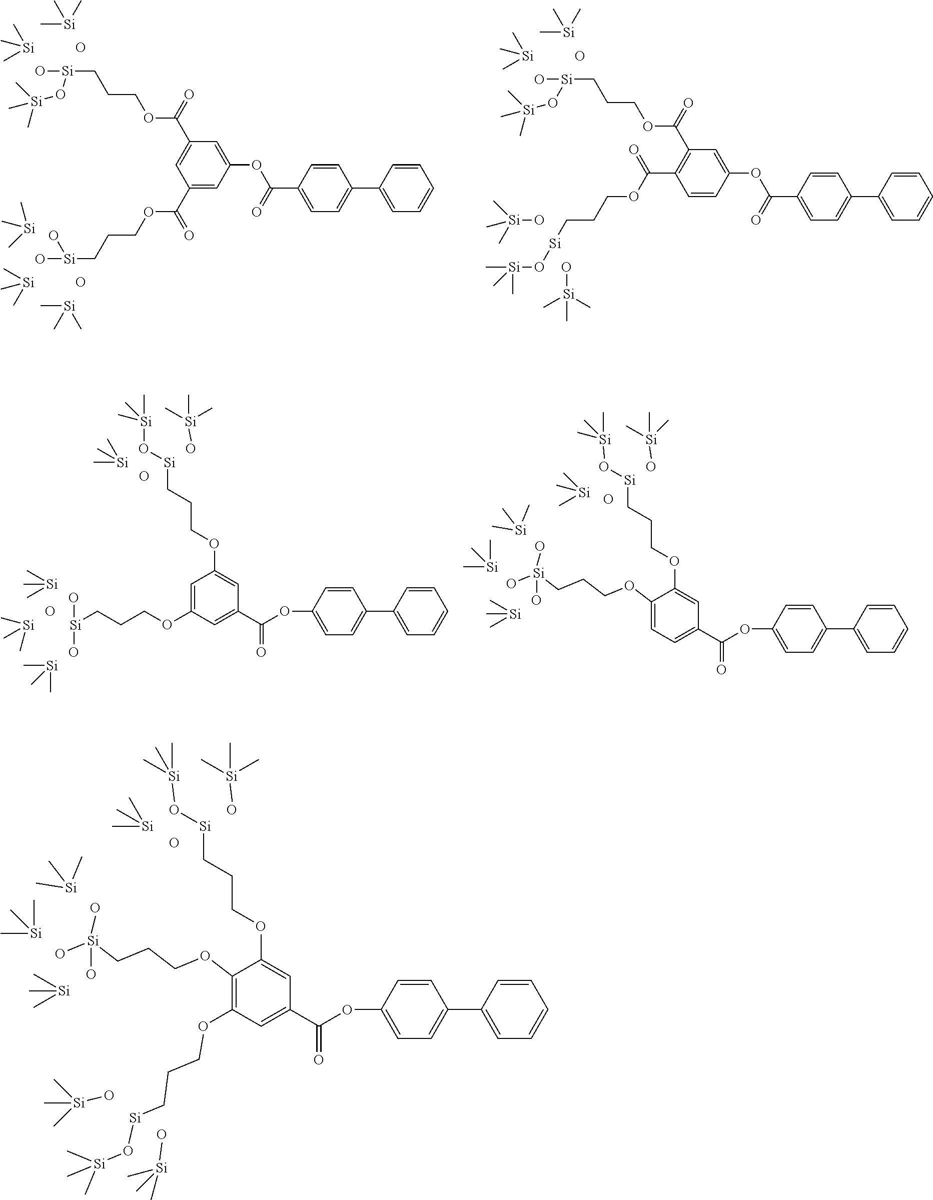

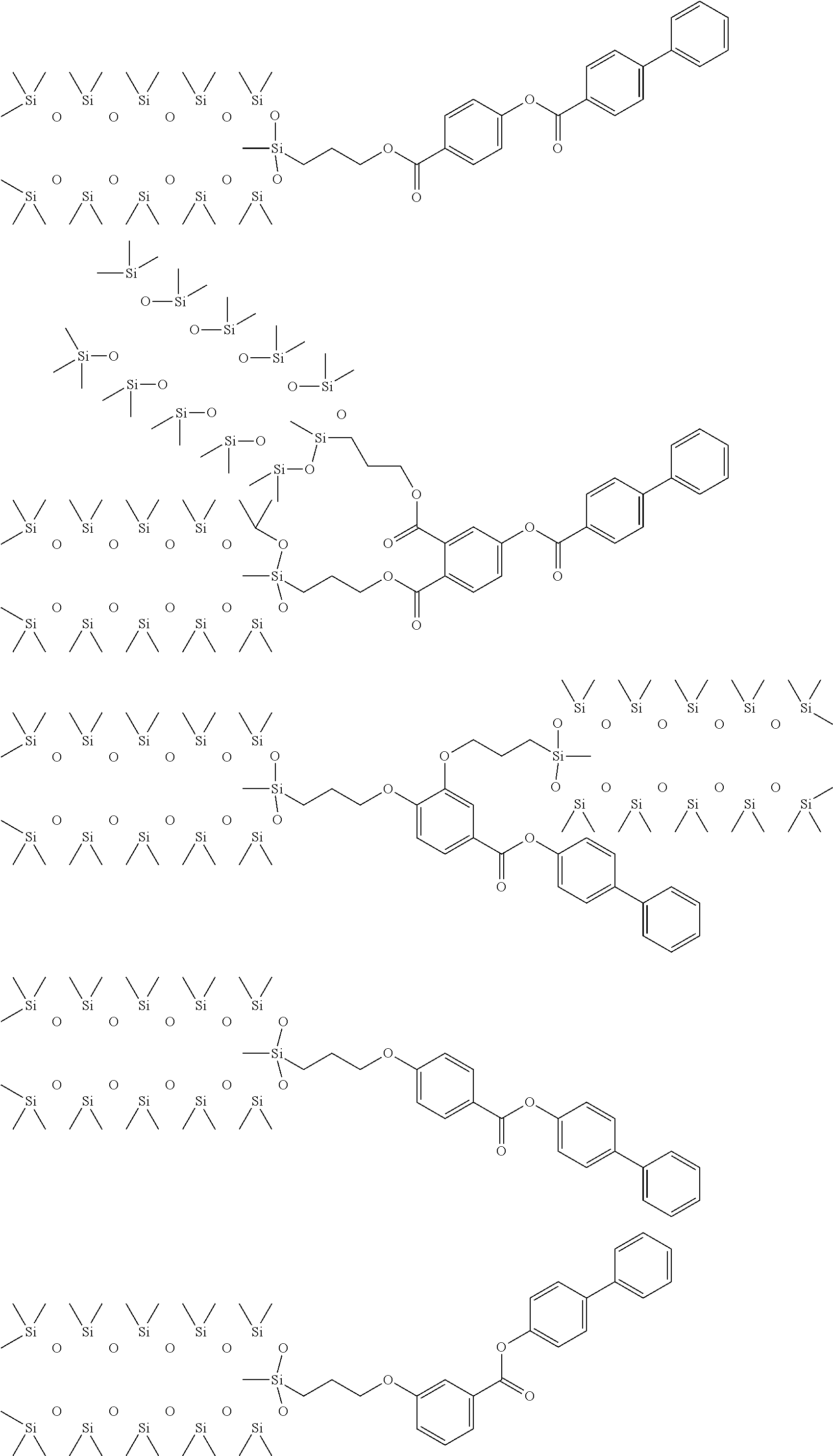

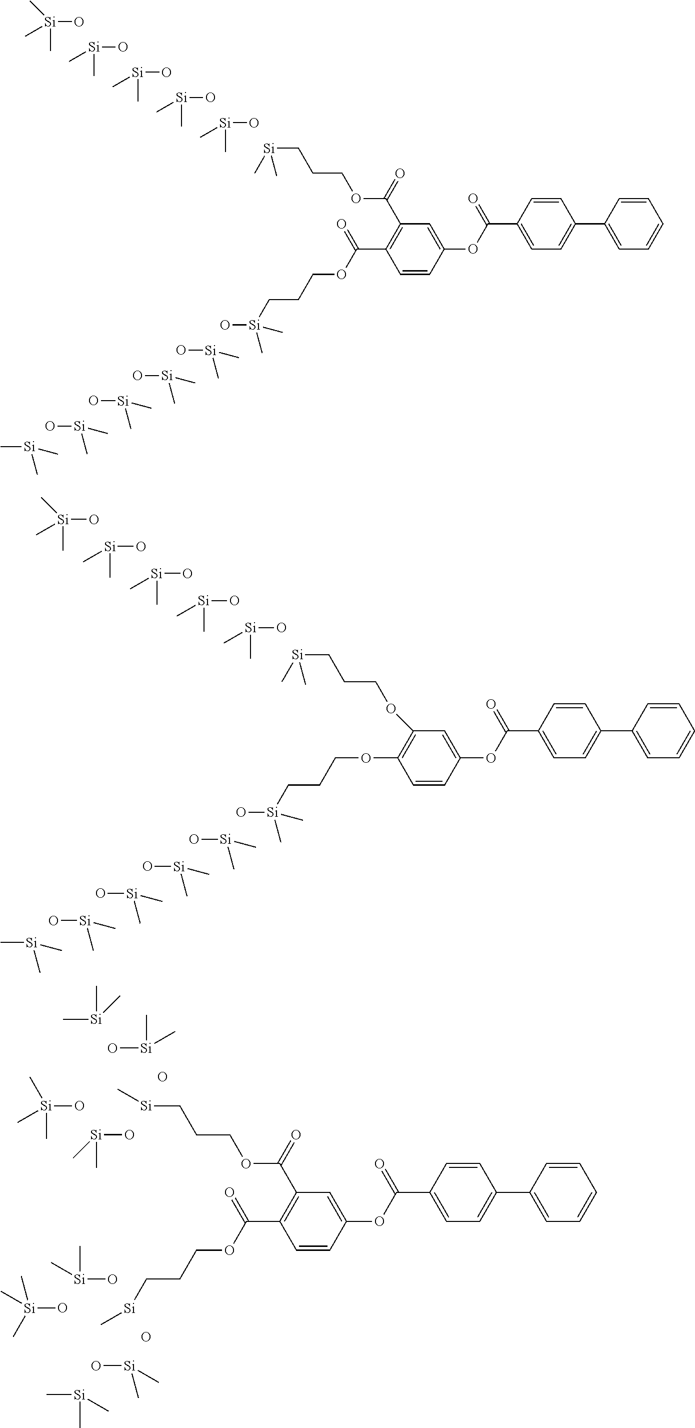

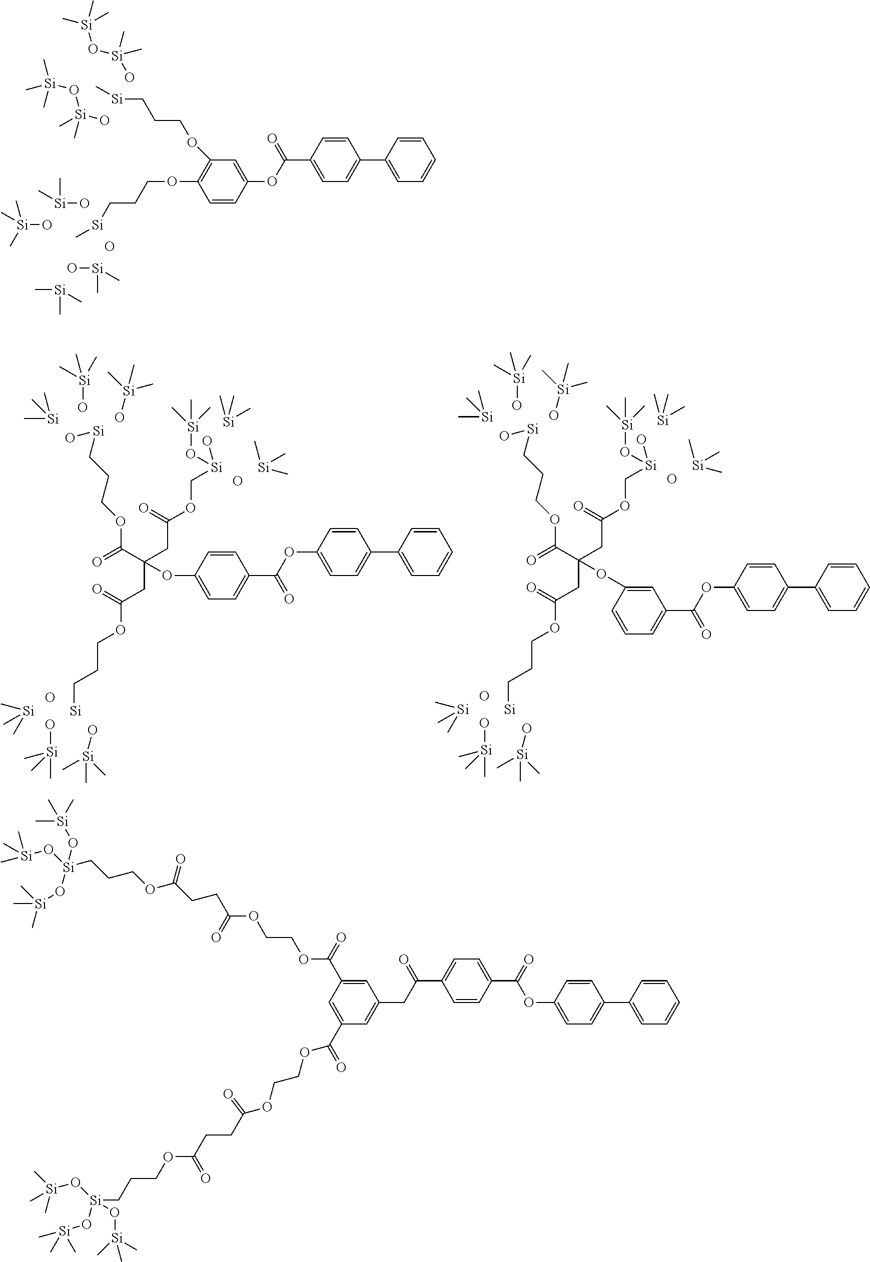

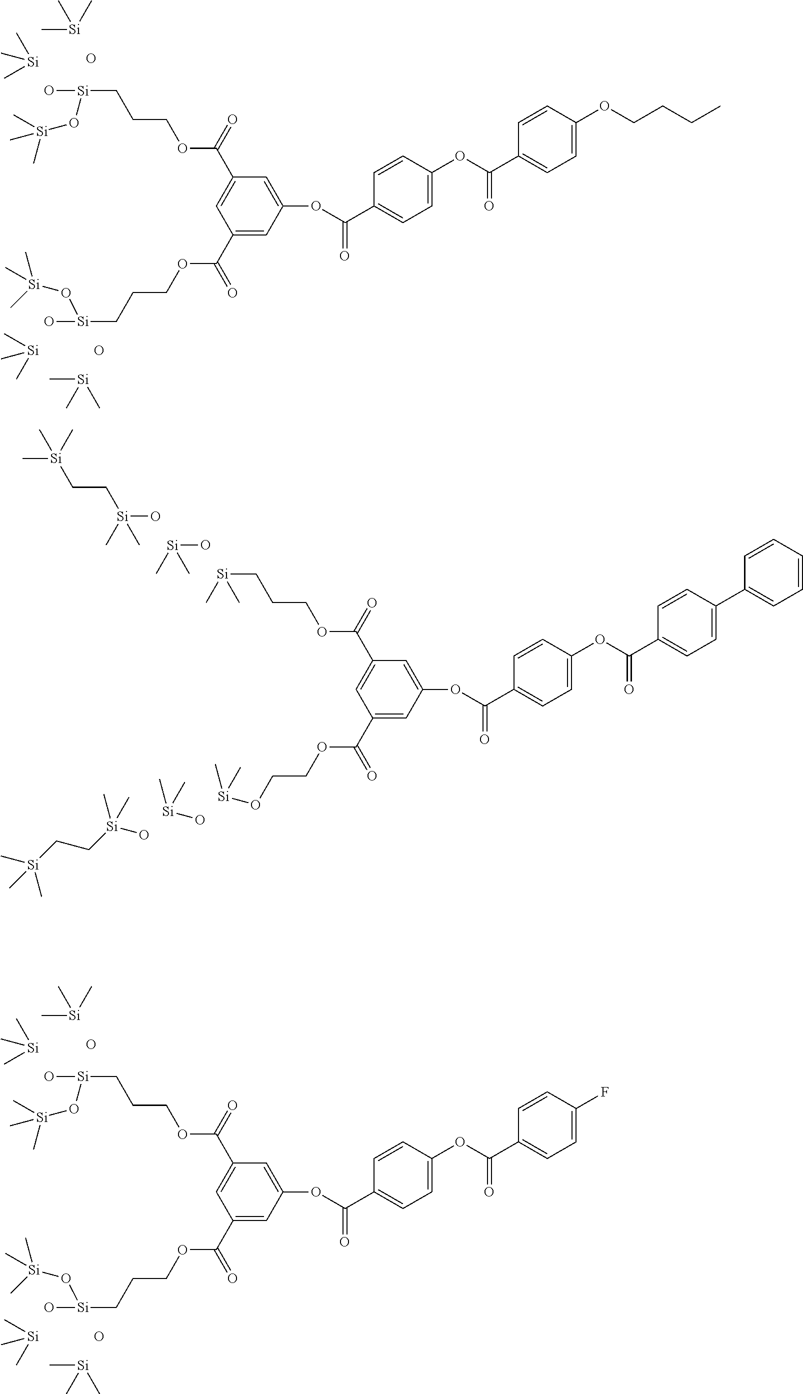

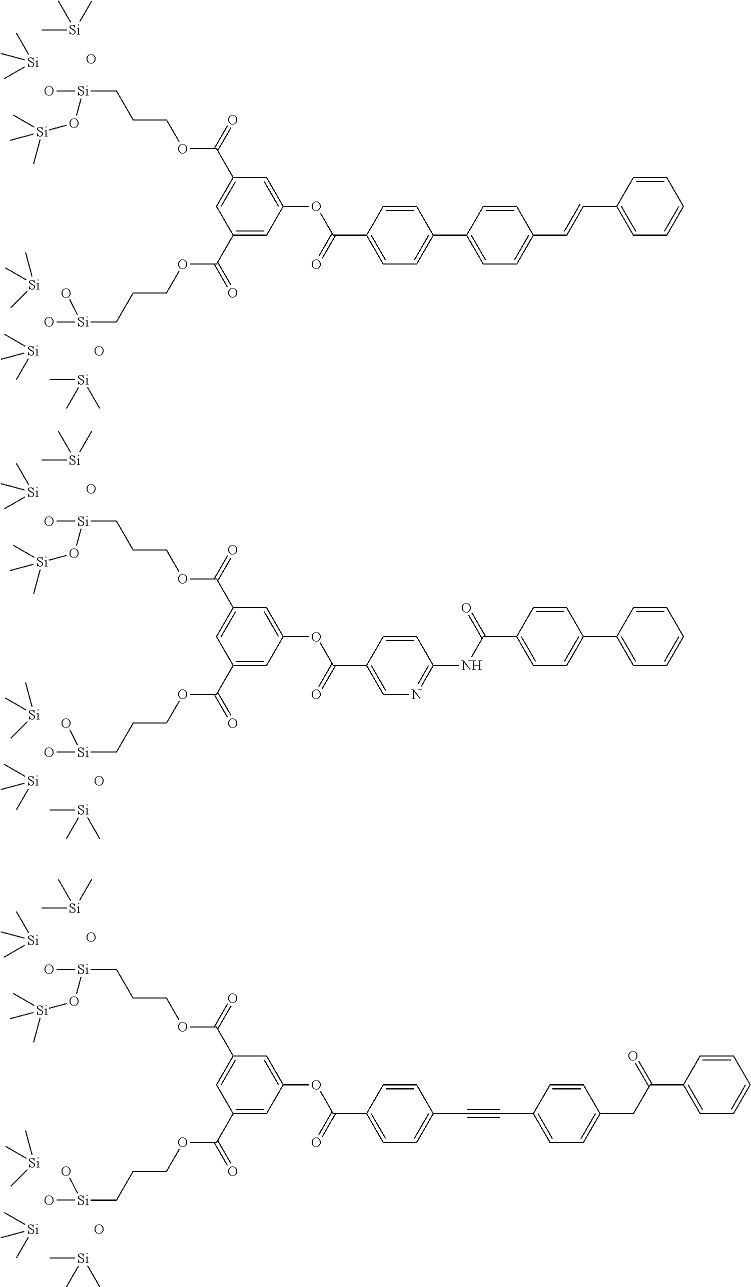

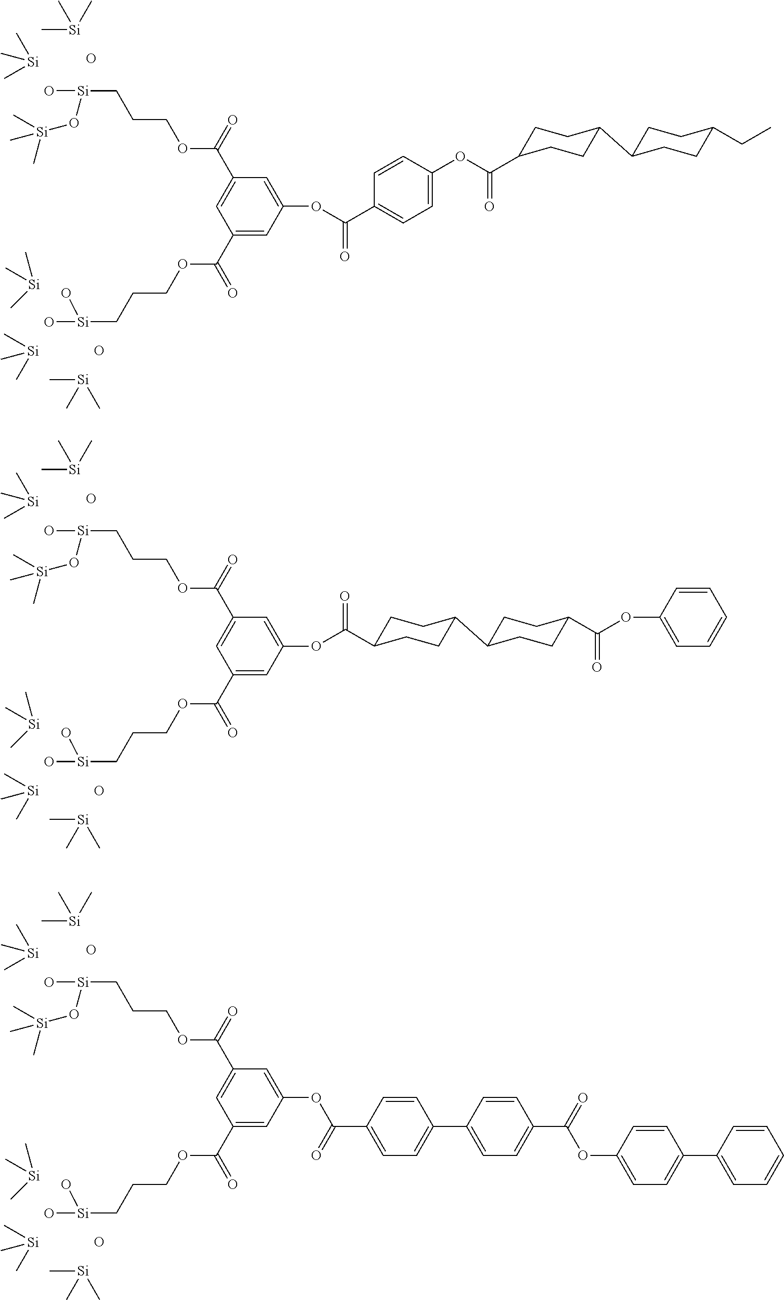

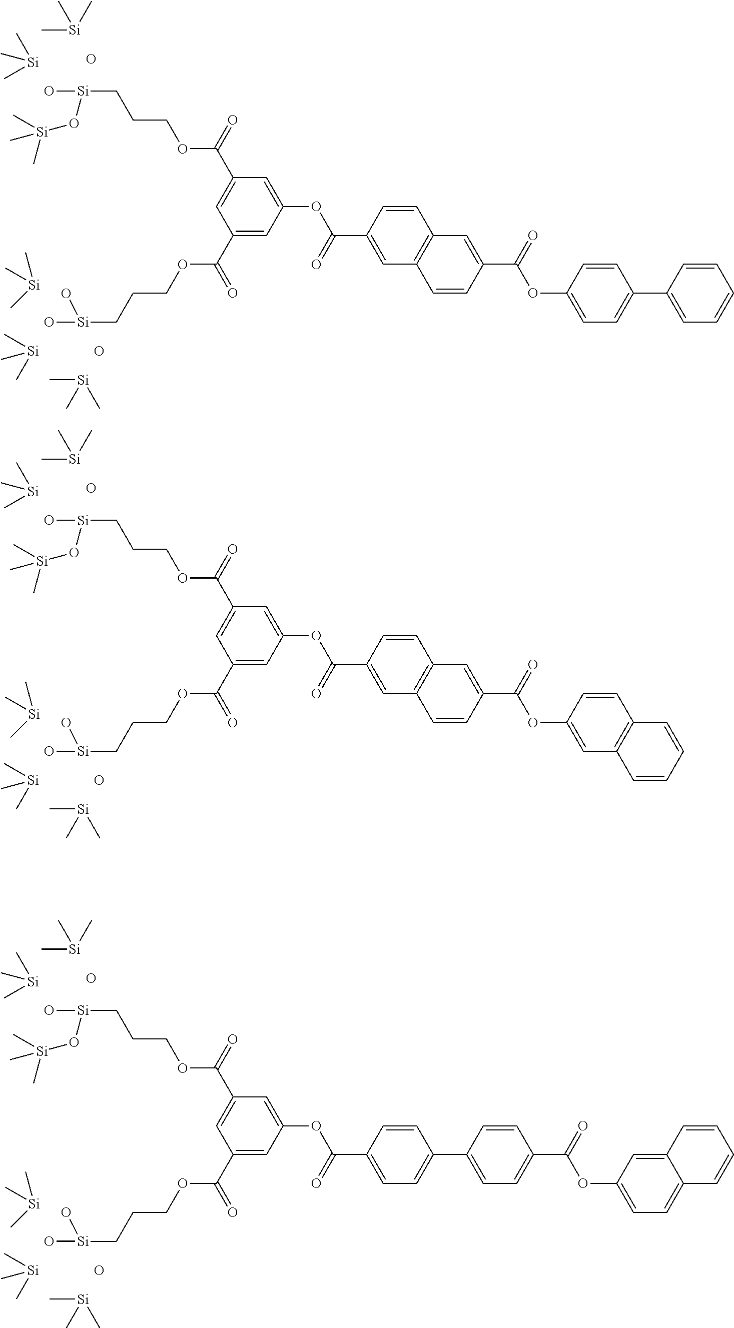

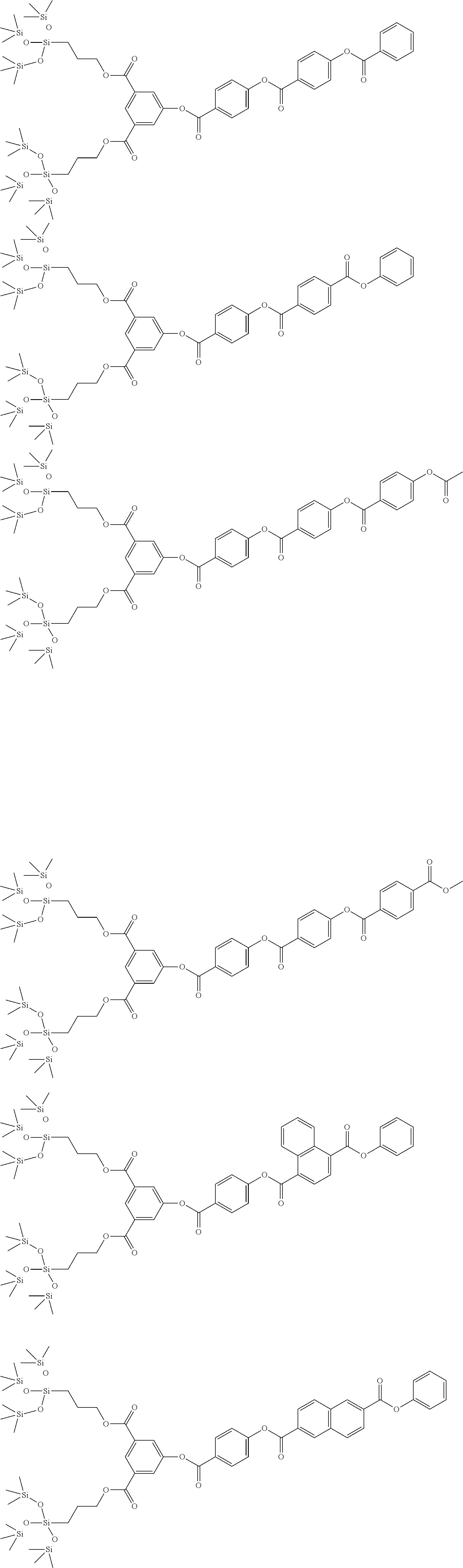

A content of the specific compound in the liquid crystal composition is preferably 0.01% to 5.00% by mass, more preferably 0.03% to 3.00% by mass, still more preferably 0.03% to 1.00% by mass, and particularly preferably 0.05% to 1.00% by mass with respect to the mass of total solid content in the liquid crystal composition.

The specific compound may be used alone, or in combination of two or more kinds thereof.

In a case where two or more kinds of the specific compounds are used in combination, the total content thereof is preferably within the above-described numerical range.

Regarding the specific compound, at an air interface of layers, a tilt angle of the molecules of the liquid crystal compound can be increased, or the liquid crystal compound can be substantially vertically aligned.

In the present specification, the term “vertically aligned” means that, in a case where the liquid crystal compound is a rod-like liquid crystal compound, a major axis of the liquid crystal compound is perpendicular to the film surface; and in a case where the liquid crystal compound is a disk-like liquid crystal compound, a disc plane of the liquid crystal compound is perpendicular to the film surface. However, it is not required to be strictly perpendicular, and in the present specification, the vertical alignment means that a tilt angle with respect to a vertical direction of the film is less than 50 degrees.

The specific compound can be synthesized by a known method.

### [Liquid Crystal Compound]

The liquid crystal composition according to the embodiment of the present invention contains a liquid crystal compound.

The liquid crystal compound is not particularly limited, and a known liquid crystal compound can be used. In general, the types of the liquid crystal compound are classified into a rod-shaped type (rod-like liquid crystal compound) and a disk-shaped type (discotic liquid crystal compound) from the shapes thereof. Furthermore, the liquid crystal compound can be classified into a low-molecular-weight type and a high-molecular-weight type. The “high-molecular-weight” generally refers to a compound having a degree of polymerization of 100 or more (Polymer Physics-Phase Transition Dynamics, written by Masao Doi, p. 2, published by Iwanami Shoten, 1992).

The liquid crystal compound may be a rod-like liquid crystal compound or a disk-like liquid crystal compound.

In the liquid crystal composition according to the embodiment of the present invention, a mixture of two or more kinds of the rod-like liquid crystal compounds, two or more kinds of the disk-like liquid crystal compounds, or the rod-like liquid crystal compound and the disk-like liquid crystal compound may be used.

From the viewpoint that the effect of the present invention is more excellent, the liquid crystal compound preferably includes a disk-like liquid crystal compound.

As the disk-like liquid crystal compound, for example, disk-like liquid crystal compounds described in paragraphs 0161 to 0171 of JP2002-129162A, paragraphs 0020 to 0067 of JP2007-108732A, paragraphs 0013 to 0108 of JP2010-244038A, and the like can be preferably used.

As the rod-like liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, or alkenylcyclohexylbenzonitriles are preferably used. In addition, a liquid crystal compound exhibiting reverse wavelength dispersibility may be used. Here, the “liquid crystal compound exhibiting reverse wavelength dispersibility” refers to a liquid crystal compound in which, in a case where an in-plane retardation (Re) value or a thickness direction retardation (Rth) value of a retardation film produced using the liquid crystal compound is measured at a specific wavelength (visible light range), the Re value or the Rth value increases as a measurement wavelength increases. The liquid crystal compound exhibiting reverse wavelength dispersibility is not particularly limited, and a known liquid crystal compound exhibiting reverse wavelength dispersibility in the related art can be used.

Specific examples of the rod-like liquid crystal compound include compounds described in Makromol. Chem., Vol. 190, p. 2255 (1989), Advanced Materials, Vol. 5, p. 107 (1993), U.S. Pat. Nos. 4,683,327A, 5,622,648A, 5,770,107A, WO95/22586A, WO95/024455A, WO97/000600A, WO98/023580A, WO98/052905A, JP1989A-272551 (JP-H1-272551A), JP1994-016616A (JP-H6-016616A), JP1995-110469A (JP-H7-110469A), JP1999-080081A (JP-H11-080081A), JP1999-513019A (JP-H11-513019A), JP2001-328973A, JP2005-289980A, JP2014-198815A, and JP2014-198814A. Two or more kinds of liquid crystal compounds may be used in combination. In a case where two or more kinds of liquid crystal compounds are used in combination, an alignment temperature can be decreased.

In addition, the liquid crystal compound may be polymerizable or non-polymerizable, but is preferably polymerizable from the viewpoint that a liquid crystal phase can be fixed.

Examples of a polymerizable group include an unsaturated bond polymerizable group, an epoxy group, and an aziridinyl group; and among these, an ethylenically unsaturated bond group ((meth)acryloyl group or the like) is preferable. The number of polymerizable groups in the liquid crystal compound is, for example, preferably 1 to 6, more preferably 1 to 3, and still more preferably 2.

From the viewpoint that the liquid crystal phase can be fixed, as the liquid crystal compound, a liquid crystal compound having one or more polymerizable groups is preferable, a liquid crystal compound having two or more polymerizable groups is more preferable, and a liquid crystal compound having two polymerizable groups is still more preferable.

A content of the liquid crystal compound in the liquid crystal composition according to the embodiment of the present invention is not particularly limited, but is preferably 50% by mass or more and more preferably 70% by mass or more with respect to the mass of the total solid content in the liquid crystal composition. The upper limit thereof is not particularly limited, but is usually 99% by mass or less and preferably 98% by mass or less.

### [Chiral Agent]

The liquid crystal composition according to the embodiment of the present invention may further contain a chiral agent.

In a case where the liquid crystal composition according to the embodiment of the present invention contains a chiral agent, the liquid crystal compound can be twisted and aligned along a helical axis. Such an alignment state is also referred to as a cholesteric alignment.

The type of the chiral agent is not particularly limited. Any known chiral agent (for example, described in “Liquid Crystal Device Handbook” edited by the 142nd Committee of the Japan Society for the Promotion of Science, Chapter 3, 4-3, Chiral agents for TN and STN, p. 199, 1989) can be used.

The chiral agent may be a photosensitive chiral agent in which a helical twisting power changes depending on irradiation with light (hereinafter, also simply referred to as “chiral agent A”). The chiral agent A may be liquid crystalline or non-liquid crystalline. The chiral agent A generally has an asymmetric carbon atom in many cases. The chiral agent A may be an axially chiral compound or a planar chiral compound, which does not have an asymmetric carbon atom.

The chiral agent A may have a polymerizable group.

The chiral agent A may be a chiral agent in which the helical twisting power increases by irradiation with light or a chiral agent in which the helical twisting power decreases by irradiation with light. Among these, a chiral agent in which the helical twisting power decreases by irradiation with light is preferable.

The “increase and decrease in helical twisting power” in the present specification represents an increase or a decrease in helical twisting power in a case where an initial helical direction (helical direction before irradiation with light) of the chiral agent A is defined as “positive”. Therefore, even in a case where the helical twisting power of the chiral agent continues to decrease to be below zero by irradiation with light and the helical direction is “negative” (that is, even in a case where the chiral agent induces a helix in a helical direction opposite to the initial helical direction (helical direction before irradiation with light)), such a chiral agent also corresponds to the “chiral agent in which the helical twisting power decreases”.

Examples of the chiral agent A include a so-called photoreactive chiral agent. The photoreactive chiral agent is a compound which has a chiral site and has a photoreactive site in which structure changes by irradiation with light, and for example, which greatly changes the twisting power of the liquid crystal compound according to the amount of light irradiated.

Among these, it is preferable that the chiral agent A is a compound having at least a photoisomerization site, and it is more preferable that the photoisomerization site has a photoisomerizable double bond.

In a case where the chiral agent has a photoisomerization group, a pattern having a desired reflection wavelength corresponding to a luminescence wavelength can be formed by irradiation with actinic ray or the like through a photo mask after coating and alignment, which is preferable. The photoisomerizable group is preferably an isomerization moiety of a compound exhibiting photochromic properties, an azobenzene moiety, a cinnamoyl moiety, an α-cyanocinnamyl moiety, a stilbene moiety, or a chalcone moiety. As specific examples of the compound, compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, and JP2003-313292A can be used.

The liquid crystal composition according to the embodiment of the present invention may contain two or more kinds of the chiral agents A, or may contain at least one kind of the chiral agent A and at least one kind of chiral agent in which the helical twisting power does not change by irradiation with light.

A content of the above-described chiral agent A in the liquid crystal composition is not particularly limited, but from the viewpoint that the liquid crystal compound is easily uniformly aligned, the content is preferably 5.0% by mass or less, more preferably 3.0% by mass or less, and still more preferably 2.0% by mass or less with respect to the total mass of the liquid crystal compound. The lower limit of the content of the chiral agent A is not particularly limited, but is preferably 0.01% by mass or more, more preferably 0.02% by mass or more, and still more preferably 0.05% by mass or more with respect to the total mass of the liquid crystal compound.

The liquid crystal composition according to the embodiment of the present invention may contain other polymerizable compounds having one or more polymerizable groups.

The type of the polymerizable group included in the other polymerizable compounds is not particularly limited; and examples thereof include an acryloyl group, a methacryloyl group, a vinyl group, a styryl group, and an allyl group, and an acryloyl group or a methacryloyl group is preferable.

Examples of the other polymerizable compounds include a non-liquid crystal polymerizable compound. Specific examples thereof include an ester of a polyhydric alcohol and (meth)acrylic acid (for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,2,3-cyclohexanetetramethacrylate, polyurethane polyacrylate, polyester polyacrylate, and the like); vinylbenzene and a derivative thereof, vinyl sulfone, acrylamide, and methacrylamide.

In a case where such other polymerizable compounds are contained, a content thereof is preferably less than 50% by mass, more preferably 40% by mass or less, and still more preferably 2% to 30% by mass with respect to the mass of the above-described liquid crystal compound (in a case where there are a plurality of liquid crystal compounds, the total mass of the liquid crystal compounds).

### [Polymerization Initiator]

The liquid crystal composition according to the embodiment of the present invention may contain a polymerization initiator.

A polymerization reaction suitable for the present invention is a thermal polymerization reaction using a thermal polymerization initiator or a photopolymerization reaction using a photopolymerization initiator, and a photopolymerization reaction is more preferable.

Examples of the photopolymerization initiator include α-carbonyl compounds (described in the specifications of U.S. Pat. Nos. 2,367,661A and 2,367,670A), acyloin ethers (described in U.S. Pat. No. 2,448,828A), aromatic acyloin compounds substituted with α-hydrocarbon (described in U.S. Pat. No. 2,722,512A), polynuclear quinone compounds (described in the specifications of U.S. Pat. Nos. 3,046,127A and 2,951,758A), a combination of a triaryl imidazole dimer and a p-aminophenyl ketone (described in U.S. Pat. No. 3,549,367A), acridine compounds and phenazine compounds (described in the specifications of JP1985-105667A (JP-S60-105667A) and U.S. Pat. No. 4,239,850A), oxadiazole compounds (described in U.S. Pat. No. 4,212,970A), acylphosphine oxide compounds (described in JP1988-040799B (JP-S63-040799B), JP1993-029234B (JP-H5-029234B), JP1998-095788A (JP-H10-095788A), JP1998-029997A (JP-H10-029997A), and the like), and oxime ester compounds (for example, OXE-01 and OXE-02 manufactured by Omni Inc. and NCI-1919 manufactured by ADEKA CORPORATION).

In a case where the liquid crystal composition according to the embodiment of the present invention contains a polymerization initiator, a content of the polymerization initiator is preferably 0.01% to 20% by mass and more preferably 0.4% to 8% by mass with respect to the mass of total solid content in the liquid crystal composition.

### [Solvent]

The liquid crystal composition according to the embodiment of the present invention may contain a solvent.

As the solvent, an organic solvent is preferable.

Examples of the organic solvent include an amide (for example, N,N-dimethylformamide or the like), a sulfoxide (for example, dimethyl sulfoxide or the like), a hydrocarbon (for example, toluene, hexane, or the like), an alkyl halide (for example, chloroform, dichloromethane, or the like), an ester (for example, methyl acetate, butyl acetate, ethyl propionate, or the like), a ketone (for example, acetone, methyl ethyl ketone, cyclohexanone, methyl isobutyl ketone, cyclopentanone, or the like), and an ether (for example, tetrahydrofuran, 1,2-dimethoxyethane, or the like).

Among these organic solvents, an ester or a ketone is preferable.

In a case where the liquid crystal composition contains a solvent, a content of the solvent in the liquid crystal composition is preferably an amount at which the concentration of solid contents in the liquid crystal composition is 0.5% to 30% by mass, and more preferably an amount at which the concentration of solid contents in the liquid crystal composition is 1% to 20% by mass.

In the liquid crystal composition, the solvent may be used alone or in combination of two or more kinds thereof. In a case where two or more kinds thereof are used in combination, the total content thereof is preferably within the above-described range.

### [Other Components]

The liquid crystal composition according to the embodiment of the present invention may contain a component other than the above-described components, and examples thereof include an acid generator, a surfactant, a tilt angle control agent, an aligning agent for an alignment film interface, a plasticizer, an adhesion improver (for example, a boronic acid monomer or the like), and a crosslinking agent.

### [Cured Product]

The cured product according to the embodiment of the present invention is obtained by polymerizing the liquid crystal composition according to the embodiment of the present invention.

The cured product according to the embodiment of the present invention is preferably a cured product in which an alignment state of the liquid crystal compound contained in the liquid crystal composition is fixed. In the cured product in which an alignment direction of the liquid crystal compound is fixed, optical characteristics derived from the liquid crystal compound are exhibited, and the optical characteristics change depending on the liquid crystal compound and an alignment direction and alignment state of the liquid crystal compound. In the cured product in which the alignment direction of the liquid crystal compound is fixed, it is sufficient that the alignment direction of the liquid crystal compound is fixed, and the liquid crystal compound may no longer have liquid crystallinity.

Examples of the cured product according to the embodiment of the present invention include a cured product in which the alignment direction of the liquid crystal compound is in a fixed direction, and a cured product in which the alignment direction of the liquid crystal compound is twisted and aligned along a helical axis. A form of the cured product according to the embodiment of the present invention is not particularly limited, but is preferably a film shape.

A method of polymerizing the liquid crystal composition according to the embodiment of the present invention may be selected according to the components contained in the liquid crystal composition, and the method is not particularly limited, but is preferably a method of irradiating with actinic rays, and more preferably a method of irradiating with ultraviolet rays. A method of obtaining the cured product according to the embodiment of the present invention, and a preferred aspect of the cured product according to the embodiment of the present invention will be described in a portion of a film including the cured product according to the embodiment of the present invention.

### [Film]

The film according to the embodiment of the present invention includes the cured product according to the embodiment of the present invention. The film according to the embodiment of the present invention preferably contains a film-shaped cured product according to the embodiment of the present invention (hereinafter, also referred to as “cured film”). It is sufficient that the film according to the embodiment of the present invention includes the cured product according to the embodiment of the present invention, and it may consist of only the cured product according to the embodiment of the present invention or may include other configurations. In addition, the film according to the embodiment of the present invention may include two or more cured films.

Examples of other configurations which may be included in the film according to the embodiment of the present invention include an alignment film and a support. The alignment film and the support are appropriately selected such that the film exhibits desired characteristics.

### [Cured Film]

In the film according to the embodiment of the present invention, the cured film contains a component derived from the liquid crystal compound, and as described above, optical characteristics derived from the liquid crystal compound are exhibited.

In a case where the alignment direction of the liquid crystal compound is in a fixed direction, the film according to the embodiment of the present invention often exhibits optical anisotropy. The alignment direction of the liquid crystal compound is typically perpendicular to an in-plane direction of the cured film.

The film according to the embodiment of the present invention may be, for example, a negative A-plate or a positive C-plate.

Here, the negative A-plate and the positive C-plate are defined as follows.

The negative A-plate satisfies a relationship of Expression (A) and the positive C-plate satisfies a relationship of Expression (C), assuming that a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz.

Both the negative A-plate and the positive C-plate have negative Rth values.

$$n y < nx \approx nz \qquad Expression ( A )$$

$$nz > nx \approx ny \qquad Expression ( C )$$

The symbol “≈” encompasses not only a case where both sides are completely the same as each other but also a case where the both sides are substantially the same as each other. As the expression “substantially the same”, in a case of the negative A-plate, for example, a case where (nx−nz)×d (here, d is a thickness of a film) is −10 to 10 nm, and preferably-5 to 5 nm is also included in “nx≈nz”. In addition, in a case of the positive C-plate, for example, a case where (nx−ny)×d (here, d is a thickness of a film) is 0 to 10 nm, and preferably 0 to 5 nm is also included in “nx≈ny”.

In addition, Rth refers to a value represented by Rth=((nx+ny)/2−nz)×d, and is also called out-of-plane retardation. In addition, hereinafter, Re may refer to a value represented by Re=(nx−ny)×d. Re is also called an in-plane retardation.

The Re and the Rth may be appropriately adjusted depending on an application of the film according to the embodiment of the present invention. The Re and the Rth can be adjusted depending on a thickness of the cured film and the type of the liquid crystal compound contained in the cured film.

In the cured film of the film according to the embodiment of the present invention, in a case where the alignment direction of the liquid crystal compound is twisted and aligned along a helical axis (particularly, in a case where a cholesteric liquid crystalline phase is fixed), the film according to the embodiment of the present invention may exhibit optical anisotropy derived from the liquid crystal compound, and may reflect electromagnetic waves in a specific wavelength range.

In a case where the film according to the embodiment of the present invention exhibits optical anisotropy derived from the liquid crystal compound, a twisted angle of the liquid crystal compound (change in angle from one surface of the cured film to the other surface) can be adjusted depending on the purpose.

In a case where the film according to the embodiment of the present invention reflects electromagnetic waves in a specific wavelength range, a wavelength range of the reflected electromagnetic waves can be adjusted by adjusting a pitch of a twisted alignment (cholesteric alignment) helical structure. The wavelength range of the reflected electromagnetic waves may be, for example, an infrared light region (wavelength of 750 nm to 1000 μm, preferably 750 nm to 10 μm) or a visible light region (wavelength of 400 to 750 nm).

A central wavelength of the reflected light can be obtained as follows. In a case where a transmittance spectrum of the film according to the embodiment of the present invention is measured from a normal direction of the film according to the embodiment of the present invention using a spectrophotometer UV3150 (manufactured by Shimadzu Corporation), a spectrum having a peak at which a transmittance is decreased in a region near a central wavelength λ is obtained. Among two wavelengths having a transmittance of ½ of the maximum peak value, in a case where a value of a wavelength on a shorter wavelength side is denoted by λₗ (nm) and a value of a wavelength on a longer wavelength side is denoted by λₕ (nm), the central wavelength λ of the reflected light is determined by the following expression.

$$λ = ( {λ}_{l} + {λ}_{h} ) / 2$$

A reflectance of the film according to the embodiment of the present invention at the central wavelength λ is preferably 40% or more, more preferably 45% or more, still more preferably 47% or more, and particularly preferably 49% or more. The upper limit of the reflectance is, for example, 50% or less.

The pitch of the helical structure changes depending on the type of the chiral agent added to the liquid crystal composition and a concentration of the added chiral agent, and a desired pitch alignment state can be obtained by adjusting any one or more of these. Regarding a helical turning direction and measuring method of the pitch, it is possible to use the method described on page 46 of “Liquid Crystal Chemical Experiment Introduction” edited by Japan Liquid Crystal Society, published by Sigma Corporation in 2007, or the method described on page 196 of “Liquid Crystal Handbook” Liquid Crystal Handbook Editing Committee, Maruzen Publishing Co., Ltd.

The thickness of the cured film can be appropriately adjusted, but is preferably 0.1 to 50 μm, more preferably 0.3 to 20 μm, and still more preferably 1 to 10 μm.

### [Support]

The support is preferably a transparent support.

Examples of the transparent support include a glass plate and a polymer film, and a polymer film is preferable. The support being transparent means that the support has a light transmittance of 80% or more.

As the transparent support, an optically isotropic polymer film is generally used. Specifically, with regard to the optical isotropy, an in-plane retardation (Re) at a wavelength of 550 nm is preferably less than 10 nm, and more preferably less than 5 nm. In addition, in the optically isotropic transparent support, a thickness direction retardation (Rth) at a wavelength of 550 nm is also preferably less than 10 nm, and more preferably less than 5 nm. Regarding the transparent support, the in-plane retardation (Re) and the thickness direction retardation (Rth) are respectively defined by the following expressions.

$$Re = ( n x - ny ) \cdot d$$

$$Rth = [ \{ ( n x + ny ) / 2 \} - nz ] \cdot d$$

In the expressions, nx and ny are in-plane refractive indices of the transparent support, nz is a refractive index of the transparent support in a thickness direction, and d is a thickness of the transparent support.

An optically anisotropic polymer film may be used as the transparent support.

In such a case, the transparent support preferably has optical uniaxiality or optical biaxiality. In a case of the optically uniaxial support, it may be optically positive (the refractive index in the optical axis direction is larger than the refractive index in the direction perpendicular to the optical axis) or may be optically negative (the refractive index in the optical axis direction is smaller than the refractive index in the direction perpendicular to the optical axis). In a case of the optically biaxial support, all the refractive indices nx, ny, and nz in the above expression are values different from each other (nx+ny/nz).

An in-plane retardation (Re) of the optically anisotropic transparent support at a wavelength of 550 nm is preferably 10 to 1,000 nm, more preferably 15 to 300 nm, and still more preferably 20 to 200 nm. A thickness direction retardation (Rth) of the optically anisotropic transparent support at a wavelength of 550 nm is preferably 10 to 1,000 nm, more preferably 15 to 300 nm, and still more preferably 20 to 200 nm.

A material forming the transparent support is determined depending on an aspect of an optically isotropic support or an optically anisotropic support. In a case of the optically isotropic support, glass or a cellulose ester is generally used. In a case of the optically anisotropic support, a synthetic polymer (for example, polycarbonate, polysulfone, polyethersulfone, polyacrylate, polymethacrylate, and norbornene resin) is generally used.

A thickness of the transparent support is preferably 10 to 500 μm and more preferably 50 to 200 μm. In order to improve adhesion between the transparent support and a layer (for example, an adhesion layer, an alignment film, and a cured film) provided thereon, the transparent support may be subjected to a surface treatment (for example, a glow discharge treatment, a corona discharge treatment, an ultraviolet (UV) treatment, and a flame treatment).

In addition, an ultraviolet absorber may be added to the transparent support.

In addition, an adhesion layer (undercoat layer) may be provided on the transparent support. The adhesion layer is described in JP1995-333433A (JP-H7-333433A). A thickness of the adhesion layer is preferably 0.1 to 2 μm and more preferably 0.2 to 1 μm.

The transparent support may be peeled off after forming the film.

### [Manufacturing Method of Film]

Examples of a method of obtaining the film according to the embodiment of the present invention include a method of applying the liquid crystal composition according to the embodiment of the present invention onto a support to form a coating film, removing a solvent contained in the coating film as necessary, performing an alignment treatment of aligning the liquid crystal compound contained in the coating film as necessary, and performing a polymerization treatment to fix an alignment direction of the liquid crystal compound contained in the coating film to form a cured film.

A method of applying the liquid crystal composition is not particularly limited, and can be performed by a known method (for example, an extrusion coating method, a direct gravure coating method, a reverse gravure coating method, a die-coating method, a bar coating method, and the like).

The alignment treatment is not particularly limited, and examples thereof include a method of applying an electric field to the coating film and a method of heating the coating film, in which a method of heating the coating film is preferable. A heating temperature in the heating may be selected depending on the type of the liquid crystal compound contained. The alignment treatment may be performed at the same time as removal of the solvent. In a case where the heating is performed as the alignment treatment, it is also preferable to maintain the alignment direction of the liquid crystal compound at a temperature lower than the alignment treatment in order to stabilize the alignment direction of the liquid crystal compound.

The polymerization treatment is not particularly limited, and a method of irradiating with ultraviolet rays is preferable. It is preferable that the ultraviolet irradiation is performed in an environment having a low oxygen concentration. In the present specification, the term “ultraviolet rays” means electromagnetic waves mainly including electromagnetic waves having a wavelength of 200 to 400 nm, and preferably means electromagnetic waves mainly including electromagnetic waves having a wavelength of 300 to 400 nm. A light source of the ultraviolet rays is not particularly limited and a known light source can be used, and ultraviolet rays including any wavelength range may be radiated using a filter or the like. Examples of the light source of the ultraviolet rays include a high-pressure mercury lamp, a metal halide lamp, and a light emitting diode (LED).

An irradiation energy is preferably 5 mJ/cm² to 100 J/cm², more preferably 30 to 600 mJ/cm², and still more preferably 100 to 400 mJ/cm². In order to promote the photopolymerization reaction, the light irradiation may be performed under heating conditions.

In a case where the film according to the embodiment of the present invention has two or more cured films, the film according to the embodiment of the present invention may be obtained by bonding separately produced cured films or a laminate including the cured film, or the film according to the embodiment of the present invention may be obtained by further producing a cured film on the produced cured film.

Examples of a method of further producing a cured film on the produced cured film include a method of applying the liquid crystal composition according to the embodiment of the present invention onto a support to form a first cured film, applying the liquid crystal composition according to the embodiment of the present invention onto the first cured film to form a coating film, and obtaining a second cured film by the above-described procedure. In addition, a third cured film or the like may be further produced on the produced second cured film by the same method.

The cured film according to the embodiment of the present invention may be formed on an alignment film.

The alignment film can be provided by means such as rubbing treatment of an organic compound (preferably a polymer), oblique vapor deposition of an inorganic compound, formation of a layer having microgrooves, or accumulation of an organic compound (for example, @-tricosanoic acid, dioctadecylmethylammonium chloride, methyl stearate, or the like) by the Langmuir-Blodgett method (LB film).

Furthermore, an alignment film in which an alignment function is generated by application of an electric field, application of a magnetic field, or irradiation with light is also known. Among these, a photo-alignment film in which an alignment function is generated by irradiation with light is preferable.

The rubbing treatment is performed by rubbing the surface of the polymer layer with paper or cloth several times in one direction.

The type of the polymer used for the alignment film is determined depending on the desired alignment (particularly, the average tilt angle) of the liquid crystal compound. From the viewpoint of easily vertically aligning (average tilt angle: 50° to) 90° the liquid crystal compound, it is preferable to use a polymer which reduces a surface energy of the alignment film. In order to reduce the surface energy of the alignment film, it is preferable to introduce a hydrocarbon group having 10 to 100 carbon atoms into a side chain of the polymer.

The specific type of the polymer is described in the literature on an optical compensation sheet using a liquid crystalline molecule for various display modes.

A thickness of the alignment film is preferably 0.01 to 5 μm and more preferably 0.05 to 1 μm. The liquid crystal compound of the coating film may be aligned using the alignment film, and then the coating film may be transferred onto the transparent support. The liquid crystal compound immobilized in the alignment state can maintain the alignment state even without the alignment film.

### [Application of Film]

The film according to the embodiment of the present invention can be used for various applications depending on the optical characteristics thereof.

For example, the film according to the embodiment of the present invention can be used as a retardation plate. It is also preferable that the retardation plate has Re at a specific wavelength of approximately λ/4, and such a retardation plate is also called a λ/4 plate. The λ/4 plate exhibits a function of a circular polarization plate which converts unpolarized light into circularly polarized light, by being used together with a linear polarizer.

In addition, the film according to the embodiment of the present invention can be used as a retardation adjustment film. The retardation adjustment film is preferably used in a laminate in which other optical layers are laminated, and it is more preferable to adjust Rth of the entire laminate. By adjusting Rth of the entire laminate, a phase difference of rays in a direction inclined from a normal direction of the laminate can be adjusted, and for example, display performance of an image display device can be improved.

In addition, the film according to the embodiment of the present invention can be used as a reflective layer. The reflective layer preferably functions as a circularly polarized light selective reflection layer which selectively reflects any one of dextrorotatory circularly polarized light or levorotatory circularly polarized light and transmits circularly polarized light of the other sense.

In the present specification, the “sense” is used regarding circular polarization means either dextrorotatory circularly polarized light or levorotatory circularly polarized light. The sense of circularly polarized light is defined such that, in a case where light is viewed as it proceeds toward a viewer, the sense is dextrorotatory circularly polarized light in a case where the distal end of the electric field vector rotates clockwise as time increases, and the sense is levorotatory circularly polarized light in a case where it rotates counterclockwise. In the present specification, the term “sense” may be used for a twisted direction of the helix of the cholesteric alignment. In the selective reflection by the cholesterically aligned liquid crystal compound, in a case where a twisted direction (sense) of the helix of the cholesteric alignment is right, dextrorotatory circularly polarized light is reflected and levorotatory circularly polarized light is transmitted; and in a case where the sense is left, levorotatory circularly polarized light is reflected and dextrorotatory circularly polarized light is transmitted.

The reflective layer is preferably used as a reflective layer in an image display device having a reciprocating optical system which reflects light between the reflective layer and a half mirror so as to reciprocate the light. The image display device may be a head-mounted display, and the head-mounted display may be a virtual reality display device. In addition, the reflective layer can also be used as a screen and a half mirror for image projection display.

In a case where the film according to the embodiment of the present invention is used as the reflective layer, it is also preferable that the film according to the embodiment of the present invention includes two or more cured films. It is also preferable that central wavelengths of light to be reflected are different from each other in the two or more cured films. In the two or more cured films, the central wavelengths of light to be reflected are different from each other, so that, for example, the reflective layer can function as a reflective layer over the entire visible light region.

For example, a member for image projection display, which can display full-color projected images, can be produced by separately producing cured films each having an apparent selective reflection central wavelength in a red light wavelength range, a green light wavelength range, and a blue light wavelength range, and laminating these films.

In addition, for example, in a case where the above-described member for image projection display is configured to be transmissive to light in the visible light region, a half mirror for image projection display in a head-up display can be obtained. The half mirror for image projection display can display the image projected from a projector so as to be visible, and in a case where the half mirror for image projection display is observed from the same surface side where the image is displayed, the information or scenery on the opposite surface side can be observed at the same time.

In addition, the film according to the embodiment of the present invention can be used as a heat shielding film or as an infrared cut filter for a sensor by controlling the film so as to exhibit selective reflection characteristics in an infrared wavelength region.

In addition, the reflective layer can be used for various purposes as constituent elements of optical elements, such as polarizers, reflective films, anti-reflection films, viewing angle compensation films, holographic elements, and alignment films.

### [Compound]

The compound according to the embodiment of the present invention is the same as the above-described specific compound contained in the liquid crystal composition according to the embodiment of the present invention, and suitable aspects thereof are also the same.

### EXAMPLES

Hereinafter, the present invention will be described in more detail with reference to Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed to be limited by Examples described below.

### [Evaluation Compound]

Specific compounds (compounds A-1 to A-10) and comparative compounds (compounds C-1 and C-2) used in Examples of the present invention are shown below.

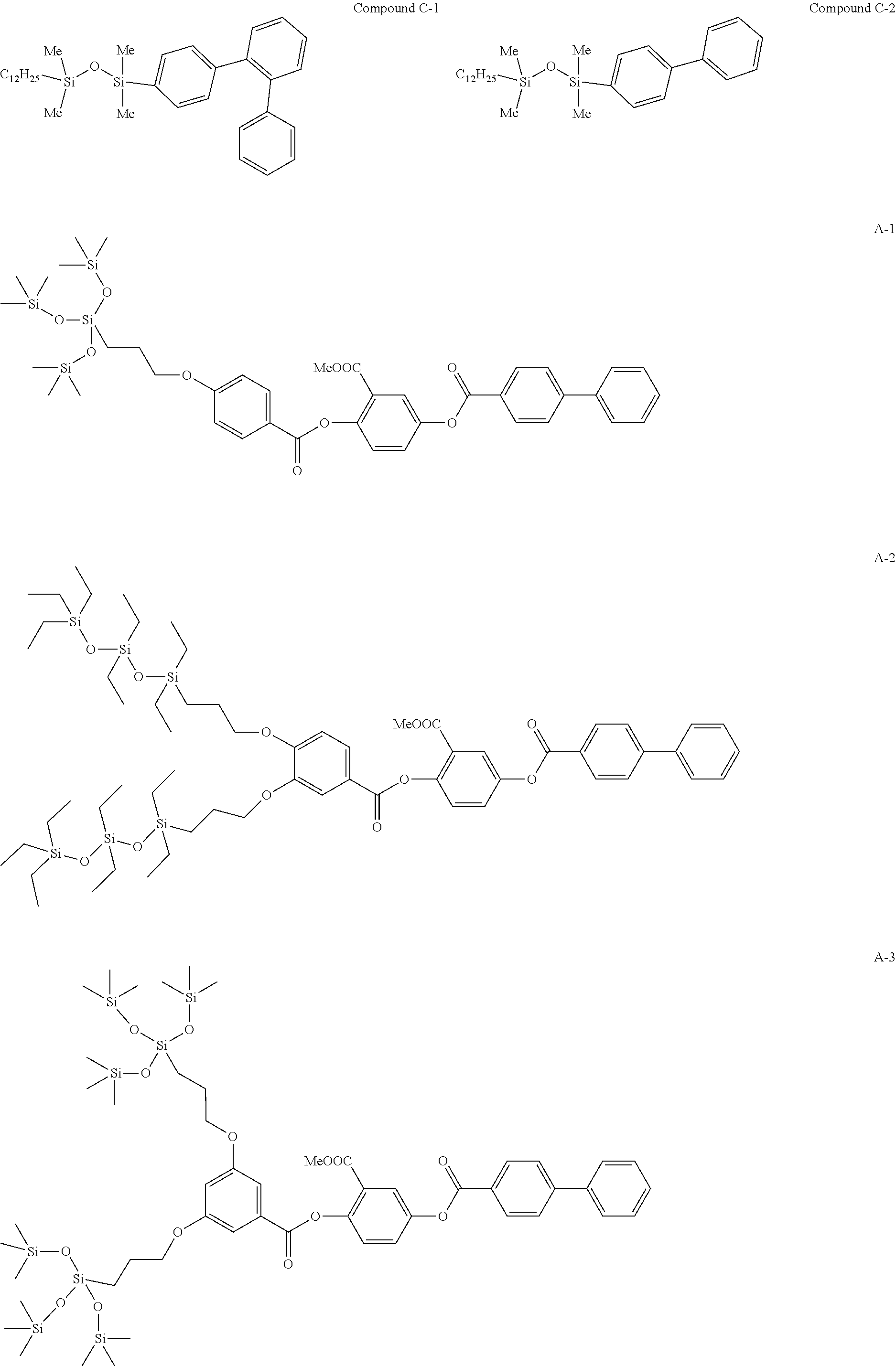

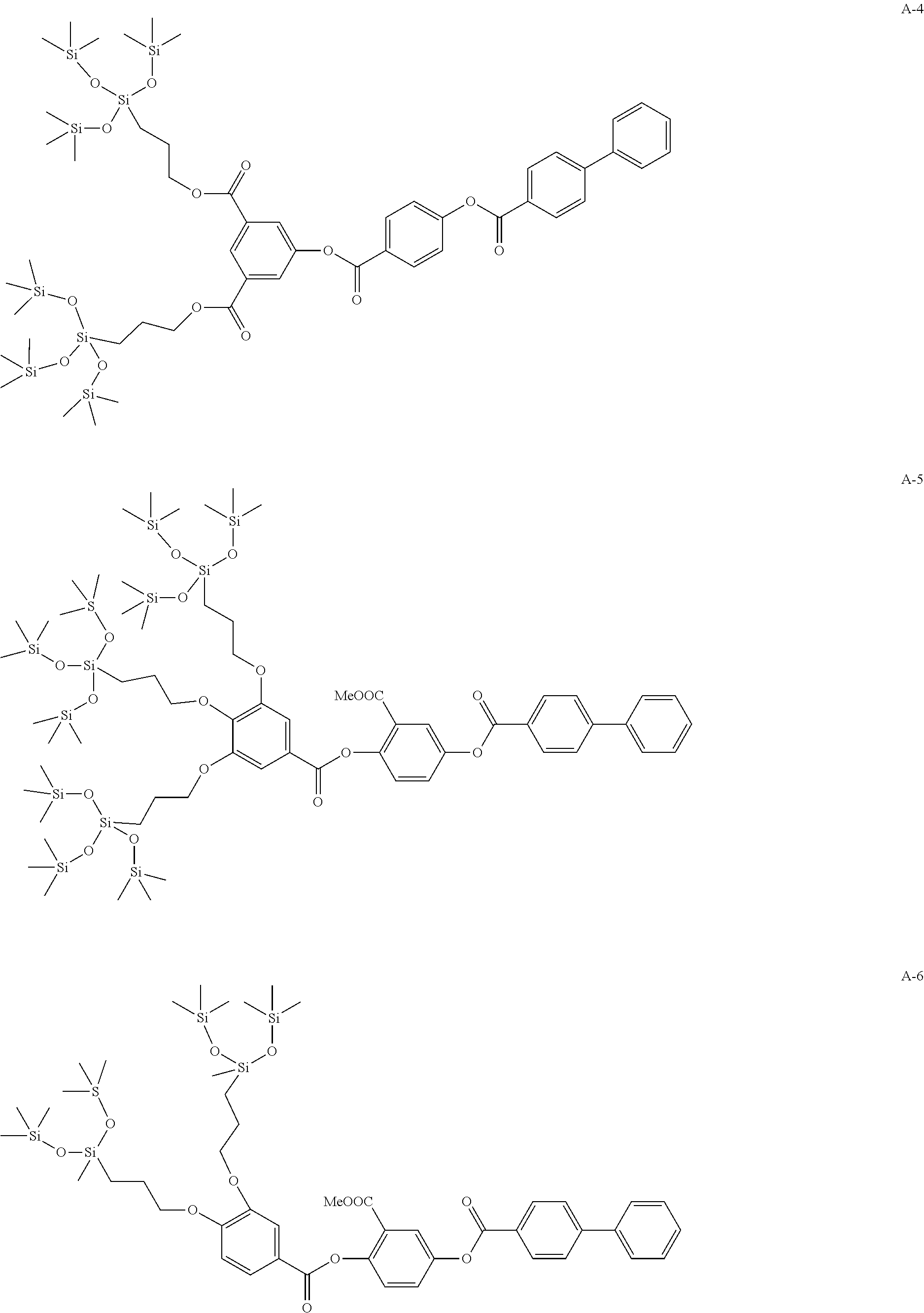 [SMILES: C[Si](C)(C)O[Si](CCCOC(=O)c1cc(OC(=O)c2ccc(OC(=O)c3ccc(-c4ccccc4)cc3)cc2)cc(C(=O)OCCC[Si](O[Si](C)(C)C)(O[Si](C)(C)C)O[Si](C)(C)C)c1)(O[Si](C)(C)C)O[Si](C)(C)C ; COC(=O)c1cc(OC(=O)c2ccc(-c3ccccc3)cc2)ccc1OC(=O)c1cc(OCCC[Si](O[Si](C)(C)C)(O[Si](C)(C)C)O[Si](C)(C)C)c(OCCC[Si](O[Si](C)(C)C)(O[Si](C)(C)C)OS(C)(C)C)c(OCCC[Si](O[Si](C)(C)C)(O[Si](C)(C)C)O[Si](C)(C)C)c1 ; COC(=O)c1cc(OC(=O)c2ccc(-c3ccccc3)cc2)ccc1OC(=O)c1ccc(OCCC[Si](C)(O[Si](C)(C)C)OS(C)(C)C)c(OCCC[Si](C)(O[Si](C)(C)C)O[Si](C)(C)C)c1]

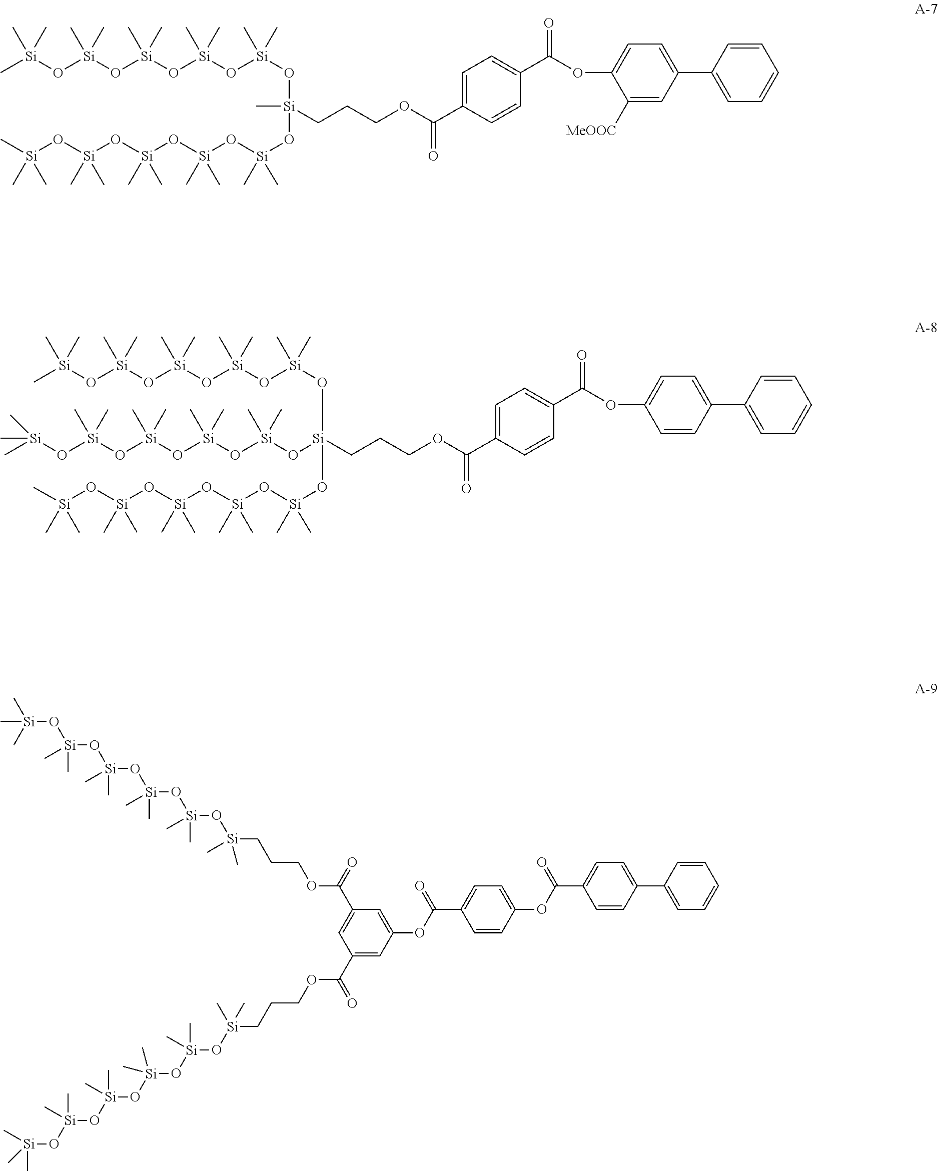

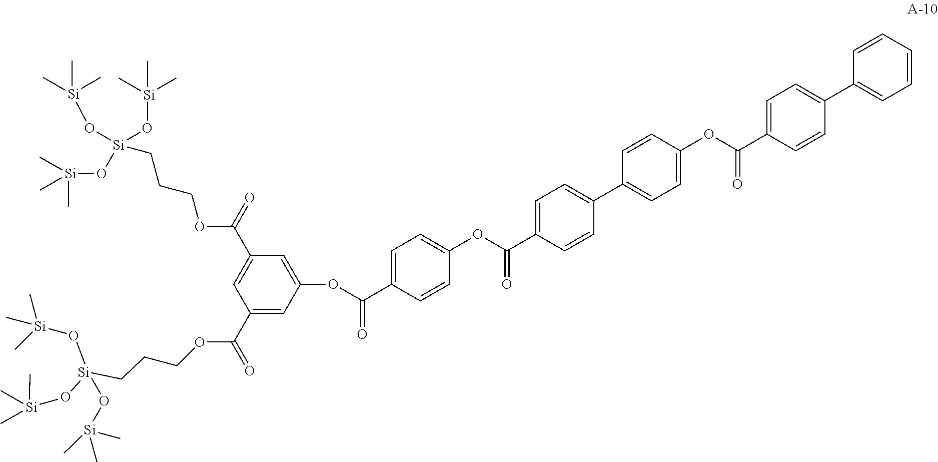 [SMILES: C[Si](C)(C)O[Si](CCCOC(=O)c1cc(OC(=O)c2ccc(OC(=O)c3ccc(-c4ccc(OC(=O)c5ccc(-c6ccccc6)cc5)cc4)cc3)cc2)cc(C(=O)OCCC[Si](O[Si](C)(C)C)(O[Si](C)(C)C)O[Si](C)(C)C)c1)(O[Si](C)(C)C)O[Si](C)(C)C]

### Synthesis Example

### Synthesis of Compound (A-3)

A compound (A-3) was synthesized according to the following procedure.

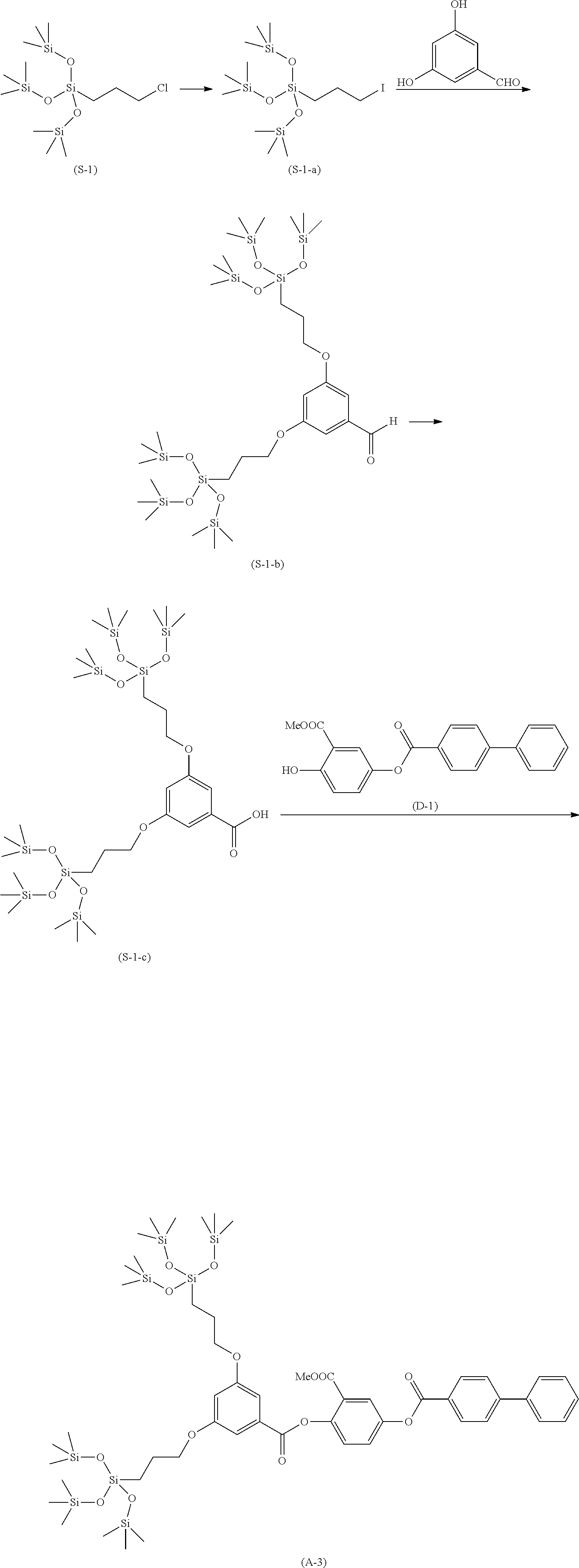

### Synthesis of Compound (S-1-a)

50.0 g of a compound (S-1) and 201.0 g of sodium iodide were added to 600 mL of acetone, and the mixture was heated and stirred at 60° C. for 12 hours. After the stirring, 1000 mL of hexane and 600 mL of water were added to the obtained reaction solution, and the mixture was subjected to a liquid-liquid separation treatment to remove the water layer. Next, the organic layer was dried with anhydrous magnesium sulfate. After the drying, the anhydrous magnesium sulfate was filtered off, and the filtrate was concentrated to obtain 54.8 g of a colorless oily compound (S-1-a).

### Synthesis of Compound (S-1-b)

4.2 g of 3,5-dihydroxybenzaldehyde, 29.6 g of the compound (S-1-a), and 29.7 g of cesium carbonate were added to 270 mL of N,N-dimethylformamide, and the mixture was stirred at room temperature for 3 hours. After stirring, 500 mL of ethyl acetate was added to the obtained reaction solution, and insoluble matter was filtered off. Next, the filtrate was washed with 1 N hydrochloric acid solution and 10% saline, and then dried with anhydrous magnesium sulfate. After the drying, the anhydrous magnesium sulfate was filtered off, and the filtrate was concentrated to obtain a light brown oily crude product. The crude product was purified by silica gel column chromatography (hexane alone to hexane/ethyl acetate=93/7 gradient) to obtain 8.6 g of a colorless oily compound (S-1-b).

### Synthesis of Compound (S-1-c)

8.6 g of the compound (S-1-b), 0.5 g of sodium dihydrogen phosphate, and 36 mg of tetrabutylammonium hydrogen sulfate were added to 50 mL of ethyl acetate. 1.4 mL of hydrogen peroxide and a sodium chlorite aqueous solution (solution obtained by dissolving 1.4 g of sodium chlorite in 3.5 mL of water) were sequentially added dropwise thereto, and the mixture was stirred at 40° C. for 1 hour. After the stirring, the water layer was removed from the reaction solution, and the organic layer was washed with a 5% sodium sulfite aqueous solution and 10% saline, and then dried with anhydrous sodium sulfate. After the drying, the anhydrous sodium sulfate was filtered off, and the filtrate was concentrated to obtain 8.0 g of a white solid compound (S-1-c).

### Synthesis of Compound (D-1)

6.0 g of 4-phenylbenzoyl chloride, 30.5 g of methyl gentisate, and 68 mL of butyl acetate were charged into a 200 mL three-neck flask under a nitrogen stream, and the mixture was heated to 110° C. to be completely dissolved. 108 μL of methanesulfonic acid was added to the contents of the three-neck flask, and the mixture was reacted at 110° C. for 2 hours. After the reaction, the liquid temperature was cooled to 50° C. or lower, and after cooling, 120 mL of methanol was added thereto, and the liquid temperature was cooled to 20° C. to precipitate a solid. The precipitated solid was collected by filtration, washed with 100 mL of methanol, and dried in the air overnight to obtain 5.7 g of a white solid compound (D-1) (yield: 62%).

### Synthesis of Compound (A-3)

0.26 g of the compound (D-1), 0.65 g of the compound (S-1-c), and 9 mg of 4-dimethylaminopyridine were dissolved in 4 mL of dichloromethane, 0.43 g of 1-(3-dimethylaminopropyl)-3-ethylcarbodiimide hydrochloride and 60 μL of 1-methylimidazole were added thereto, and the mixture was stirred at room temperature for 1 hour. After the stirring, the reaction solution was purified by silica gel column chromatography (hexane alone to hexane/ethyl acetate=95/5 gradient) to obtain 0.81 g of a white solid compound (A-3).

MALDI-MS measurement results of the obtained compound (A-3) are shown below.

m/z: 1156.40 (100.0%), 1157.40 (96.9%), 1158.40 (56.8%), 1159.40 (29.8%), 1158.41 (19.8%), 1159.41 (12.6%), 1160.40 (11.5%), 1160.41 (8.3%), 1161.40 (4.6%), 1161.41 (2.2%), 1157.41 (1.5%), 1162.40 (1.5%), 1161.39 (1.0%)

### Synthesis of Compound (A-1)

A compound (A-1) was synthesized according to the following procedure.

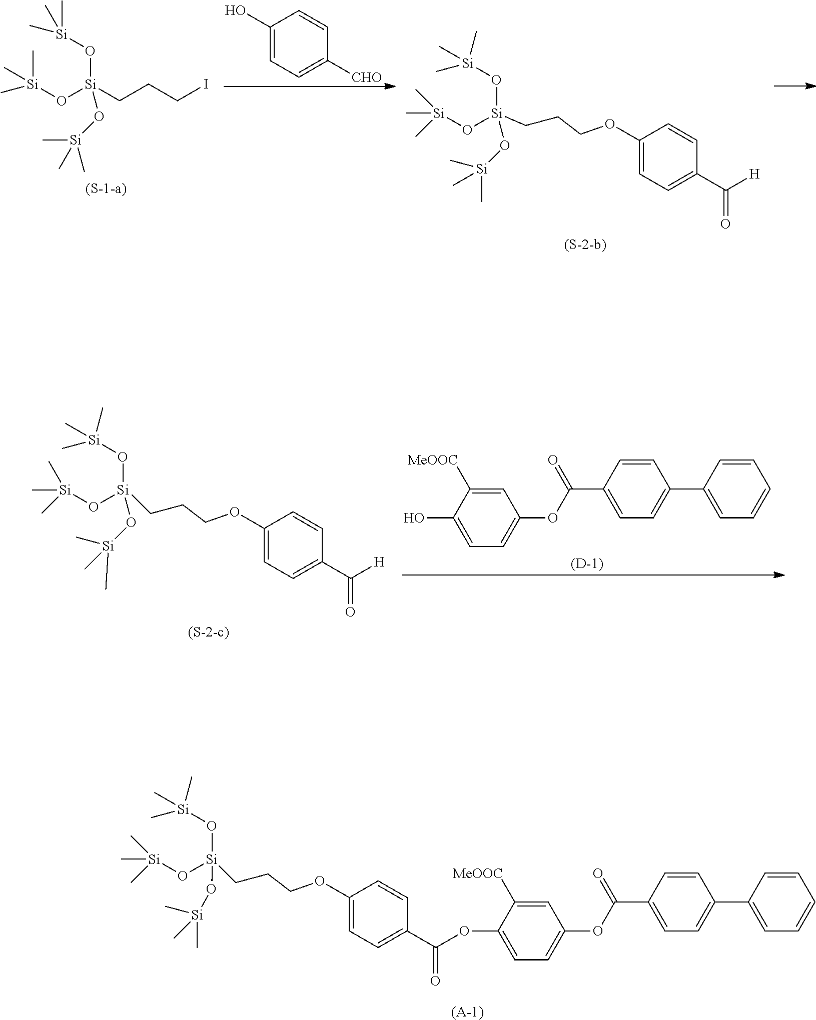

### Synthesis of Compound (S-2-b)

In accordance with “Synthesis of compound (S-1-b)” described above, a compound (S-2-b) was synthesized in yield of 71%.

### Synthesis of Compound (S-2-c)

In accordance with “Synthesis of compound (S-1-c)” described above, a compound (S-2-c) was synthesized in yield of 97%.

### Synthesis of Compound (A-1)

In accordance with “Synthesis of compound (A-3)” described above, a compound (A-1) was synthesized in yield of 76%.

MALDI-MS measurement results of the obtained compound (A-1) are shown below.

m/z: 804.26 (100.0%), 805.27 (44.2%), 806.27 (20.6%), 805.26 (20.3%), 806.26 (14.9%), 807.26 (7.9%), 807.27 (5.3%), 808.27 (2.1%), 808.26 (1.9%)

### Synthesis of Compound (A-2)

A compound (A-2) was synthesized according to the following procedure.

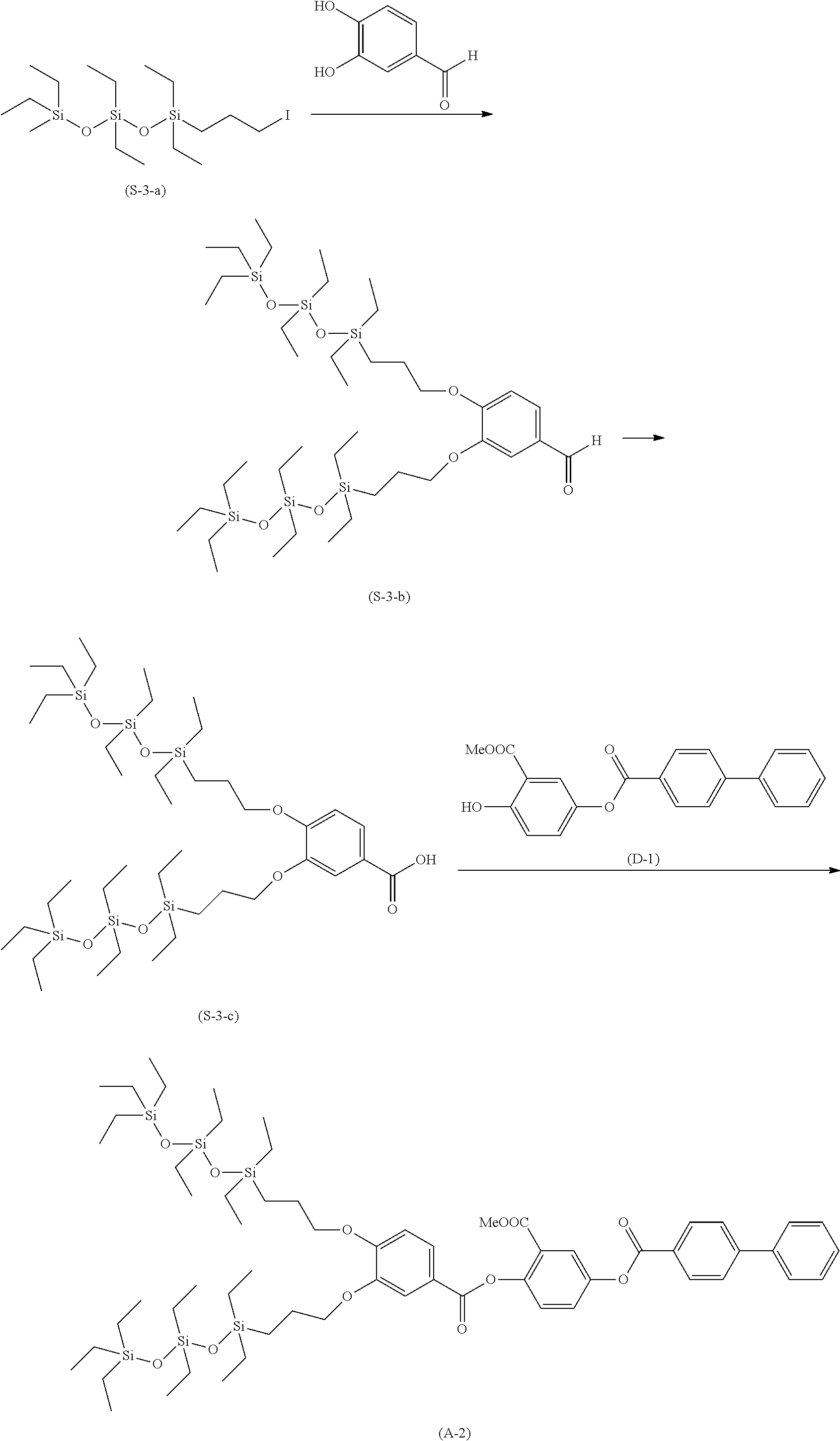

### Synthesis of Compound (S-3-b)

In accordance with “Synthesis of compound (S-1-b)” described above, a compound (S-3-b) was synthesized in yield of 67%.

### Synthesis of Compound (S-3-c)

In accordance with “Synthesis of compound (S-1-c)” described above, a compound (S-3-c) was synthesized in yield of 94%.

### Synthesis of Compound (A-2)

In accordance with “Synthesis of compound (A-3)” described above, a compound (A-2) was synthesized in yield of 70%.

MALDI-MS measurement results of the obtained compound (A-2) are shown below.

m/z: 1204.58 (100.0%), 1205.59 (68.7%), 1206.59 (46.6%), 1205.58 (30.5%), 1206.58 (24.0%), 1207.58 (18.9%), 1207.59 (17.3%), 1208.59 (8.5%), 1208.58 (6.1%), 1209.59 (3.1%), 1209.58 (2.0%)

### Synthesis of Compound (A-4)

A compound (A-4) was synthesized according to the following procedure.

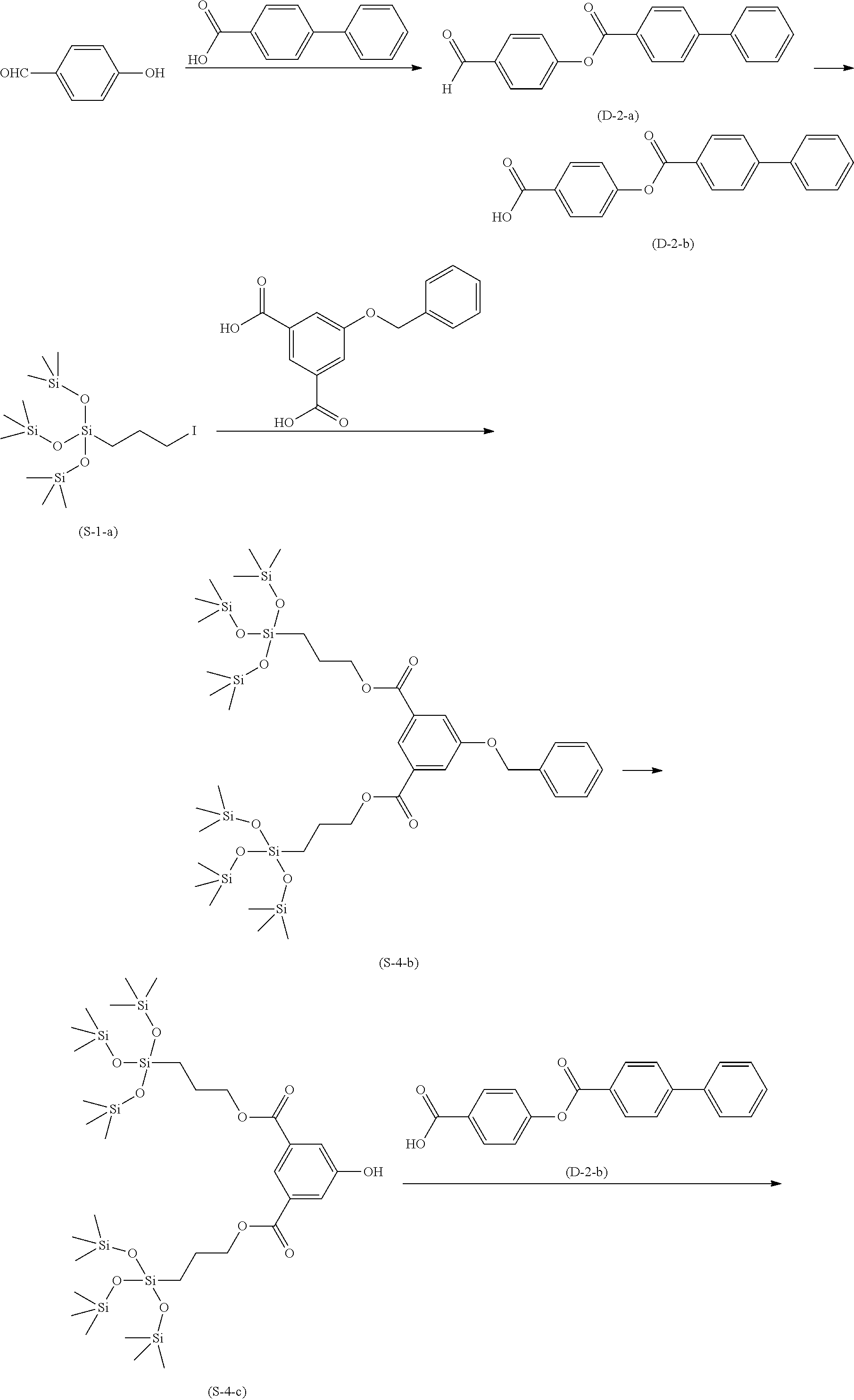

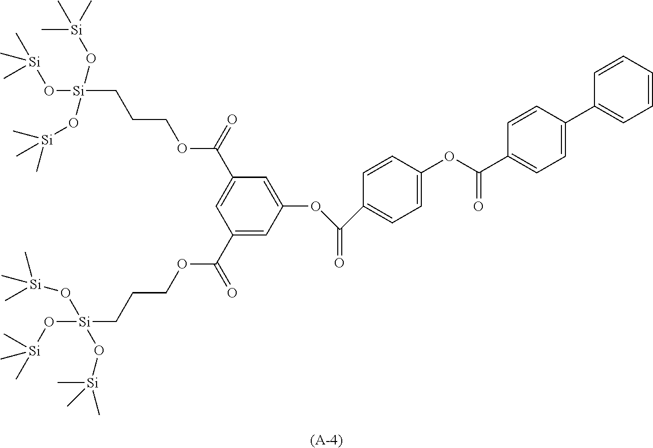 [SMILES: C[Si](C)(C)O[Si](CCCOC(=O)c1cc(OC(=O)c2ccc(OC(=O)c3ccc(-c4ccccc4)cc3)cc2)cc(C(=O)OCCC[Si](O[Si](C)(C)C)(O[Si](C)(C)C)O[Si](C)(C)C)c1)(O[Si](C)(C)C)O[Si](C)(C)C ; "(A-4)"]

### Synthesis of Compound (D-2-a)

2.96 g of 4-hydroxybenzaldehyde and 5.00 g of 4-phenylbenzoyl chloride were dissolved in 50 mL of tetrahydrofuran, and the mixture was cooled to 5° C. 0.18 mL of 1-methylimidazole and 4.32 mL of N,N-diisopropylamine were added dropwise thereto, and the mixture was stirred at 5° C. or lower for 2 hours. 100 mL of methanol was added to the reaction solution, the mixture was stirred for 5 minutes, and the precipitated solid was collected by filtration and washed with methanol. The obtained solid was dried under reduced pressure to obtain 3.28 g of a white solid compound (D-2-a).

### Synthesis of Compound (D-2-b)

In accordance with “Synthesis of compound (S-1-c)” described above, a compound (D-2-b) was synthesized in yield of 91%.

### Synthesis of Compound (S-4-b)

2.90 g of 5-(benzyloxy) isophthalic acid, 4.42 g of potassium carbonate, and 10.89 g of the compound (S-1-a) were added to 250 mL of 1-methyl-2-pyrrolidone, and the mixture was stirred at 55° C. for 2 hours. The reaction solution was cooled to room temperature, 300 mL of ethyl acetate and 150 mL of 1 N hydrochloric acid solution were added thereto, the mixture was stirred, and the organic layer was separated by liquid-liquid separation. The organic layer was washed twice with 100 mL of 10% saline and dried with anhydrous sodium sulfate. The desiccant was filtered off, and the organic layer was concentrated to obtain a brown oily crude product. The obtained crude product was purified by silica gel chromatography (hexane/ethyl acetate=95/5) to obtain 6.7 g of a colorless oily compound (S-4-b).

### Synthesis of Compound (S-4-c)

6.00 g of the compound (S-4-b) was dissolved in 30 mL of tetrahydrofuran, and the mixture was nitrogen-replaced. 1.35 g of 10% palladium carbon was added thereto, and the mixture was hydrogen-replaced and stirred at room temperature for 1 hour. The reaction solution was filtered through Celite, and the filtrate was concentrated under reduced pressure to obtain 5.2 g of a colorless oily compound (S-4-c).

### Synthesis of Compound (A-4)

In accordance with “Synthesis of compound (A-3)” described above, a compound (A-4) was synthesized in yield of 76%.

MALDI-MS measurement results of the obtained compound (A-4) are shown below.

m/z: 1154.39 (100.0%), 1155.39 (98.3%), 1156.39 (49.4%), 1157.39 (28.8%), 1156.38 (26.8%), 1158.39 (13.2%), 1157.38 (10.3%), 1158.38 (4.6%), 1159.39 (4.2%), 1157.40 (3.3%), 1159.38 (2.9%), 1158.40 (2.1%), 1160.39 (1.4%), 1160.38 (1.0%)

### Synthesis of Compound (A-5)

A compound (A-5) was synthesized according to the following procedure.

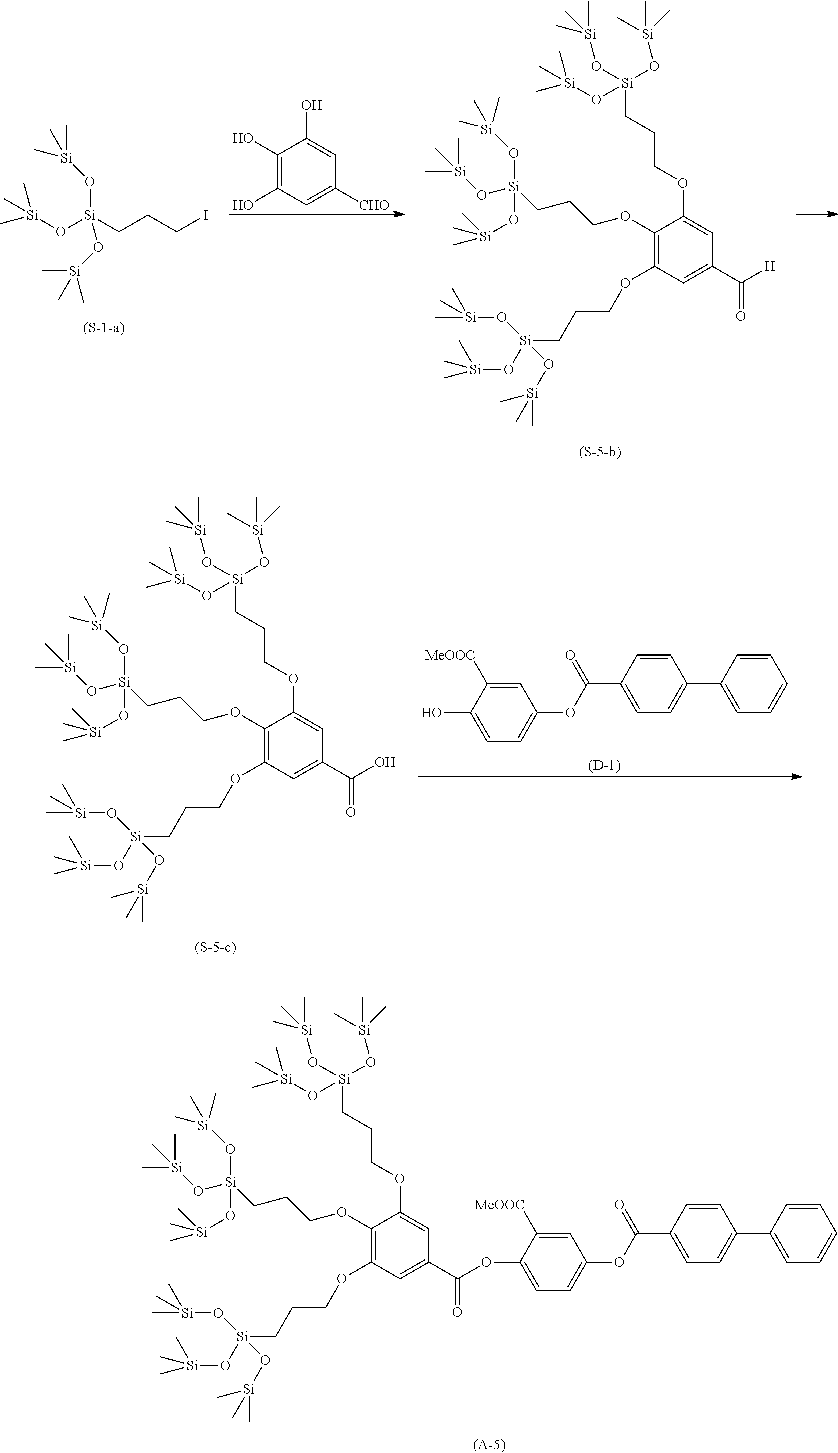

### Synthesis of Compound (S-5-b)

In accordance with “Synthesis of compound (S-1-b)” described above, a compound (S-5-b) was synthesized in yield of 52%.

### Synthesis of Compound (S-5-c)

In accordance with “Synthesis of compound (S-1-c)” described above, a compound (S-5-c) was synthesized in yield of 94%.

### Synthesis of Compound (A-5)

In accordance with “Synthesis of compound (A-3)” described above, a compound (A-5) was synthesized in yield of 72%.

MALDI-MS measurement results of the obtained compound (A-5) are shown below.

m/z: 1509.54 (100.0%), 1510.54 (79.1%), 1508.54 (76.4%), 1511.54 (52.2%), 1512.54 (27.4%), 1510.55 (19.7%), 1511.55 (18.0%), 1513.54 (13.5%), 1512.55 (8.9%), 1514.54 (5.9%), 1512.53 (5.7%), 1513.55 (4.1%), 1513.53 (3.5%), 1514.55 (2.1%), 1515.54 (2.1%), 1514.53 (1.4%), 1509.55 (1.0%)

### Synthesis of Compound (A-6)

A compound (A-6) was synthesized according to the following procedure.

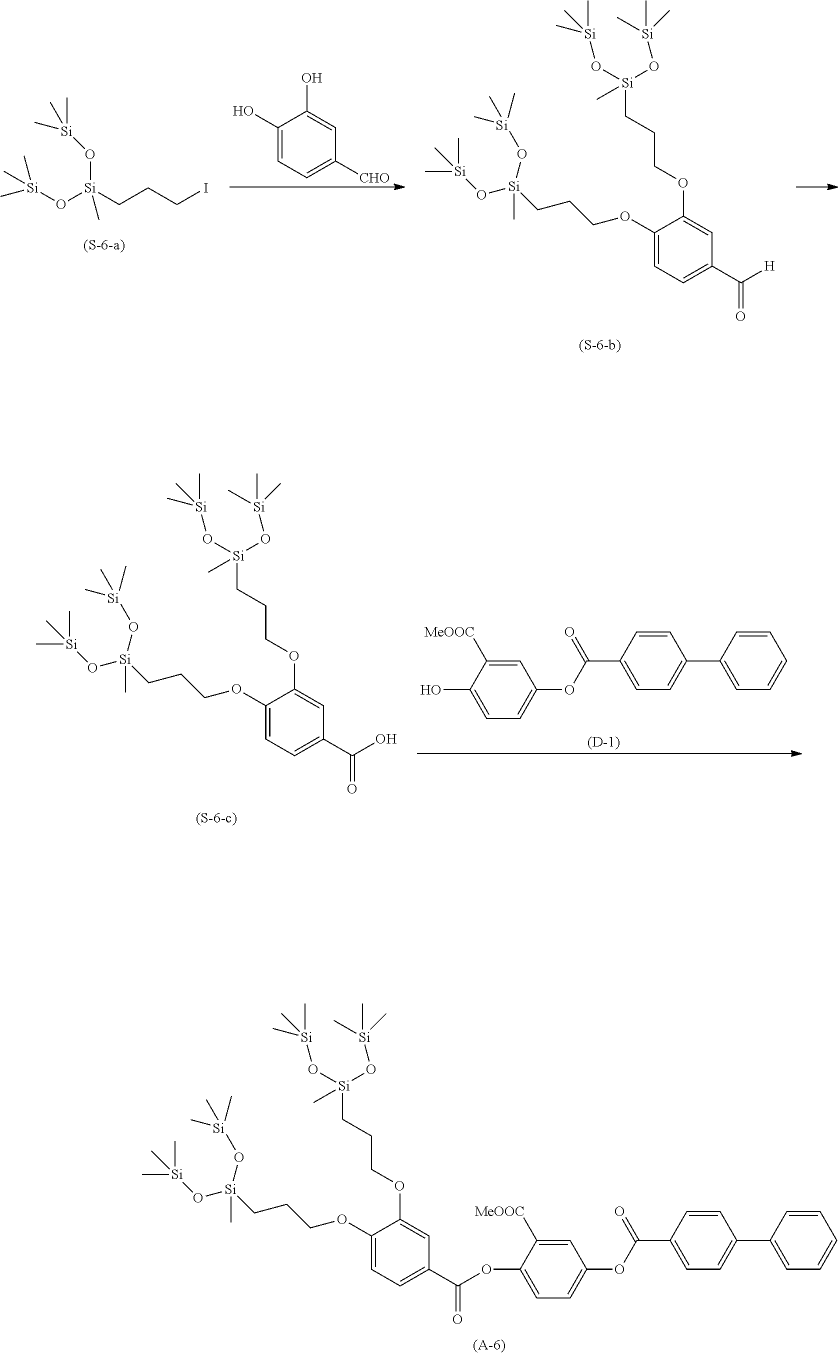

### Synthesis of Compound (S-6-b)

In accordance with “Synthesis of compound (S-1-b)” described above, a compound (S-6-b) was synthesized in yield of 73%.

### Synthesis of Compound (S-6-c)

In accordance with “Synthesis of compound (S-1-c)” described above, a compound (S-6-c) was synthesized in yield of 96%.

### Synthesis of Compound (A-6)

In accordance with “Synthesis of compound (A-3)” described above, a compound (A-6) was synthesized in yield of 78%.

MALDI-MS measurement results of the obtained compound (A-6) are shown below.

m/z: 1008.36 (100.0%), 1009.37 (53.2%), 1010.37 (32.5%), 1009.36 (30.5%), 1010.36 (24.0%), 1011.36 (15.9%), 1011.37 (10.8%), 1012.37 (5.5%), 1012.36 (4.9%), 1013.37 (1.7%), 1013.36 (1.7%)

### Synthesis of Compound (A-7)

A compound (A-7) was synthesized according to the following procedure.

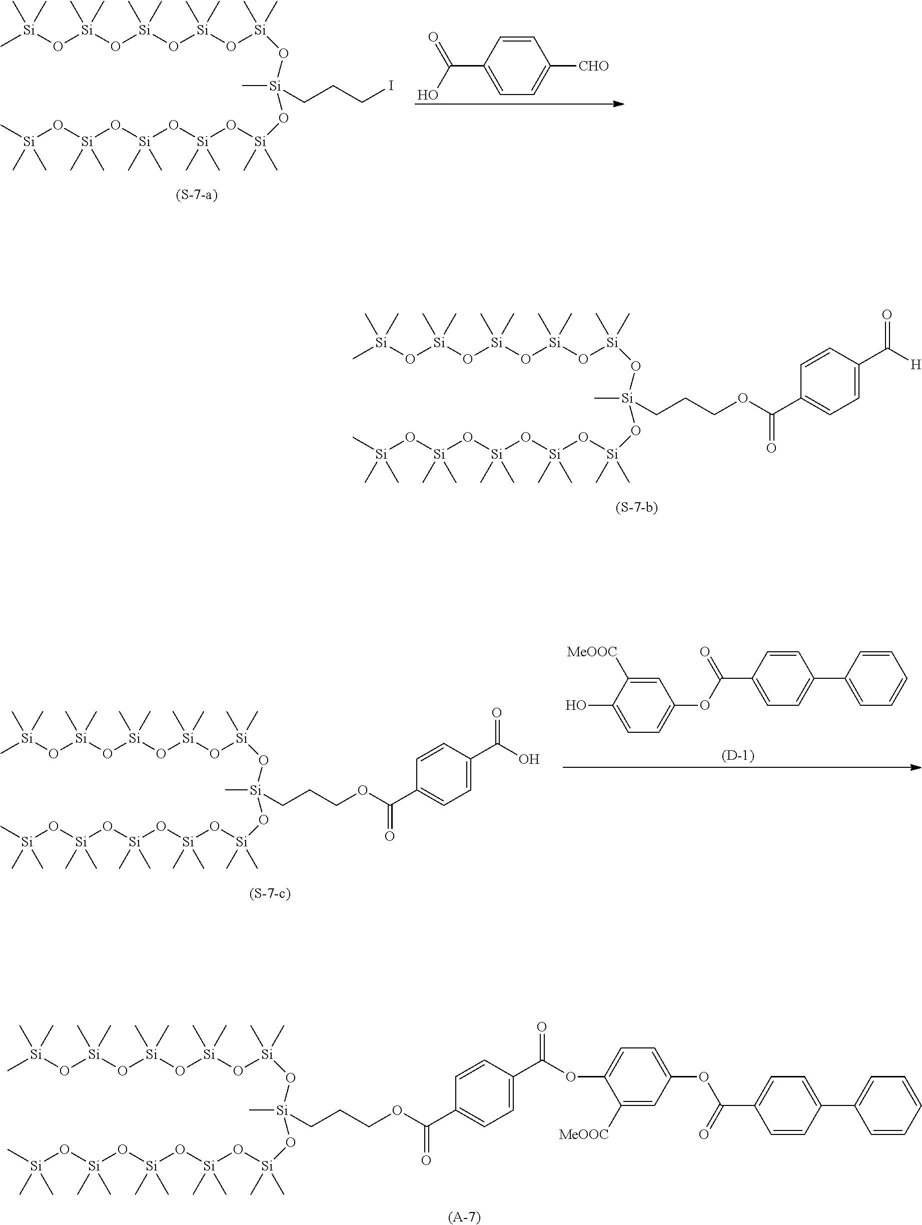

### Synthesis of Compound (S-7-b)

In accordance with “Synthesis of compound (S-4-b)” described above, a compound (S-7-b) was synthesized in yield of 89%.

### Synthesis of Compound (S-7-c)

In accordance with “Synthesis of compound (S-1-c)” described above, a compound (S-7-c) was synthesized in yield of 92%.

### Synthesis of Compound (A-7)

In accordance with “Synthesis of compound (A-3)” described above, a compound (A-7) was synthesized in yield of 71%.

MALDI-MS measurement results of the obtained compound (A-7) are shown below.

m/z: 1351.39 (100.0%), 1350.39 (86.2%), 1352.39 (76.1%), 1353.39 (46.5%), 1354.39 (22.1%), 1352.40 (16.4%), 1353.40 (14.1%), 1355.39 (10.4%), 1354.40 (6.4%), 1354.38 (5.3%), 1356.39 (4.2%), 1355.40 (3.1%), 1355.38 (2.4%), 1356.40 (1.4%), 1357.39 (1.4%), 1356.38 (1.0%)

### Synthesis of Compound (A-8)

A compound (A-8) was synthesized according to the following procedure.

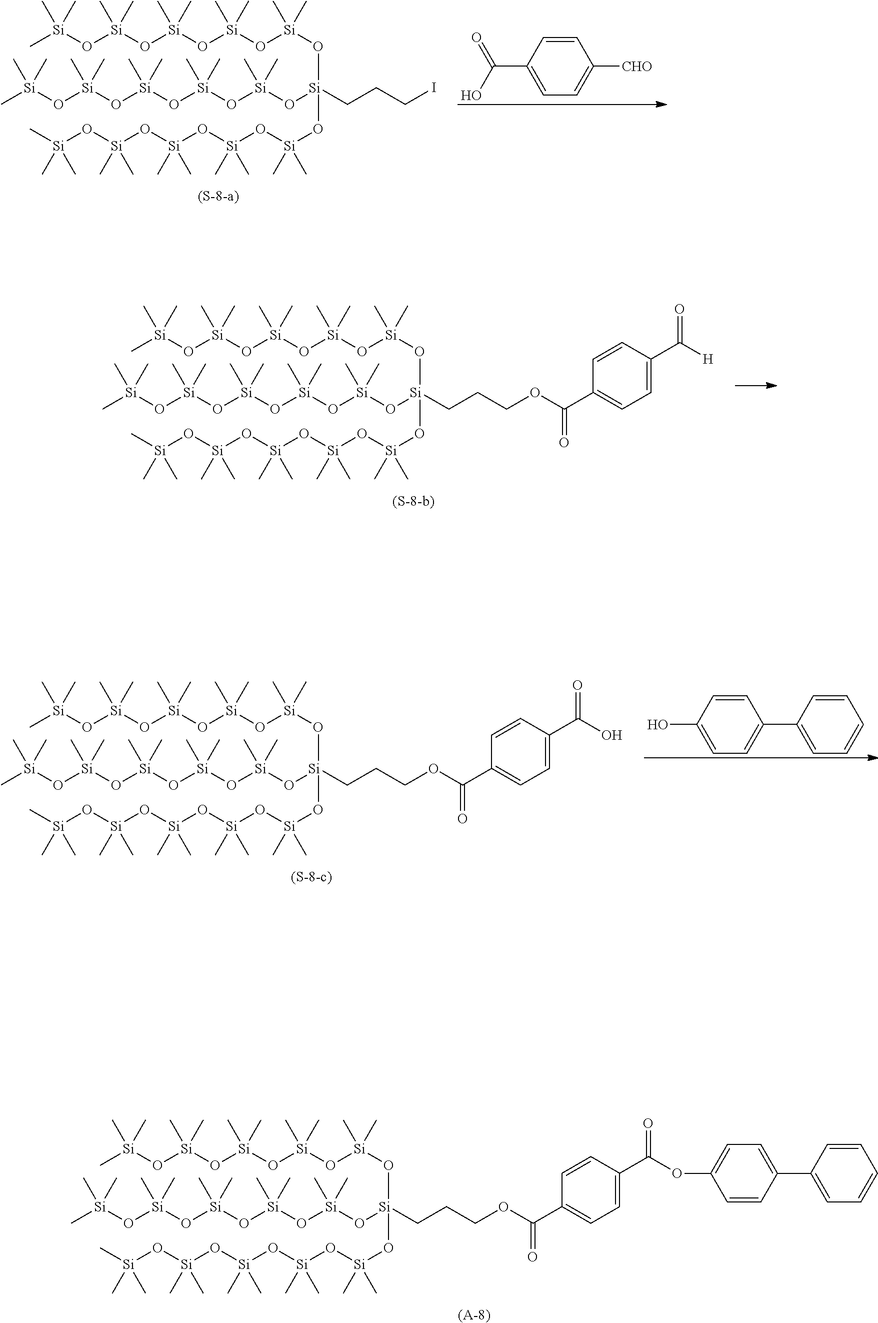

### Synthesis of Compound (S-8-b)

In accordance with “Synthesis of compound (S-4-b)” described above, a compound (S-8-b) was synthesized in yield of 83%.

### Synthesis of Compound (S-8-c)

In accordance with “Synthesis of compound (S-1-c)” described above, a compound (S-8-c) was synthesized in yield of 90%.

### Synthesis of Compound (A-8)

In accordance with “Synthesis of compound (A-3)” described above, a compound (A-8) was synthesized in yield of 78%.

MALDI-MS measurement results of the obtained compound (A-8) are shown below.

m/z: 1543.46 (100.0%), 1544.46 (72.1%), 1542.46 (69.5%), 1545.46 (54.5%), 1544.45 (37.2%), 1546.46 (36.6%), 1545.45 (28.3%), 1546.45 (19.4%), 1547.46 (17.6%), 1547.45 (14.5%), 1548.46 (8.1%), 1548.45 (8.0%), 1545.47 (4.9%), 1549.46 (3.7%), 1549.45 (3.7%), 1546.47 (3.4%), 1547.47 (2.0%), 1550.45 (1.6%), 1550.46 (1.3%), 1548.47 (1.2%)

### Synthesis of Compound (A-9)

A compound (A-9) was synthesized according to the following procedure.

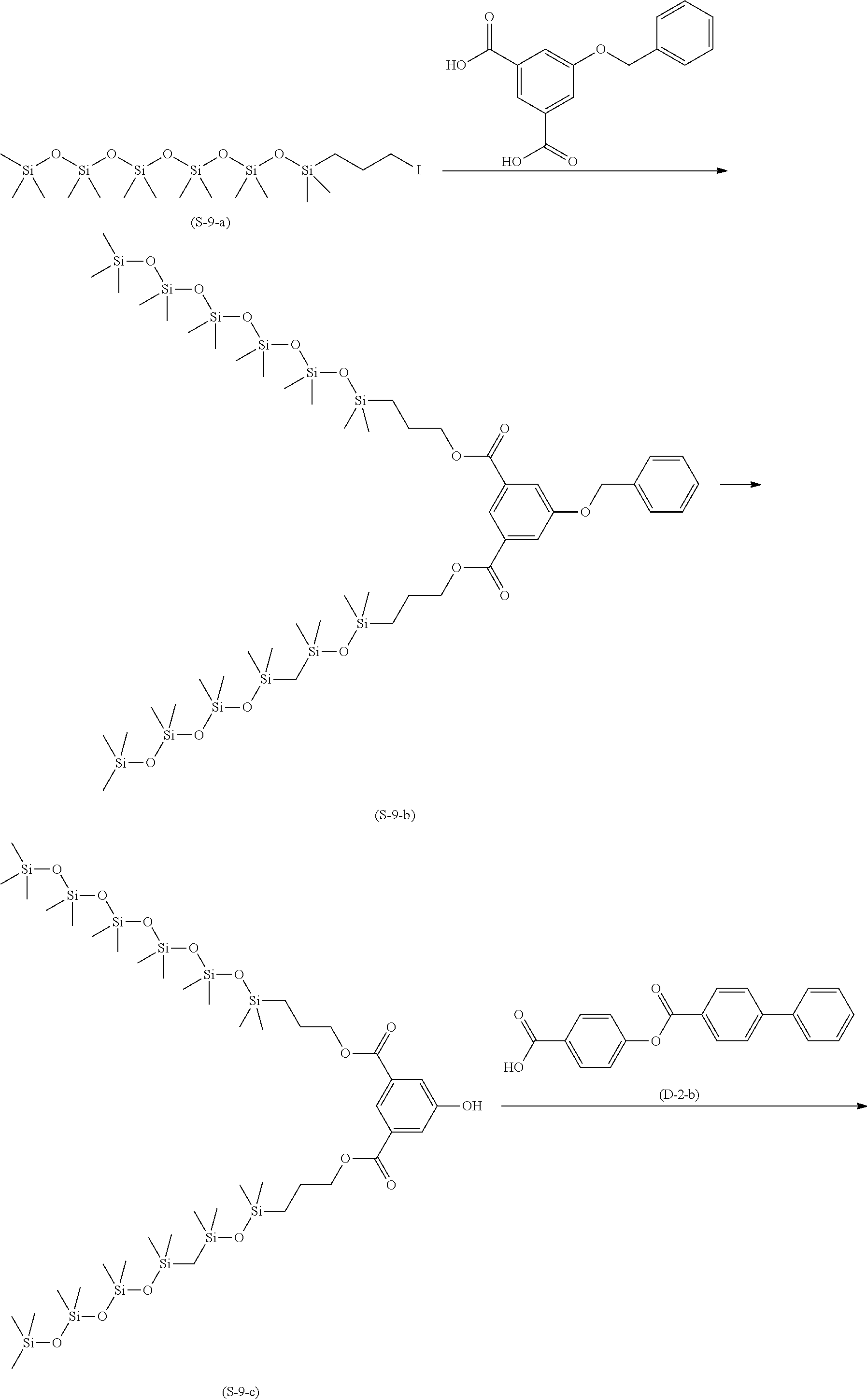

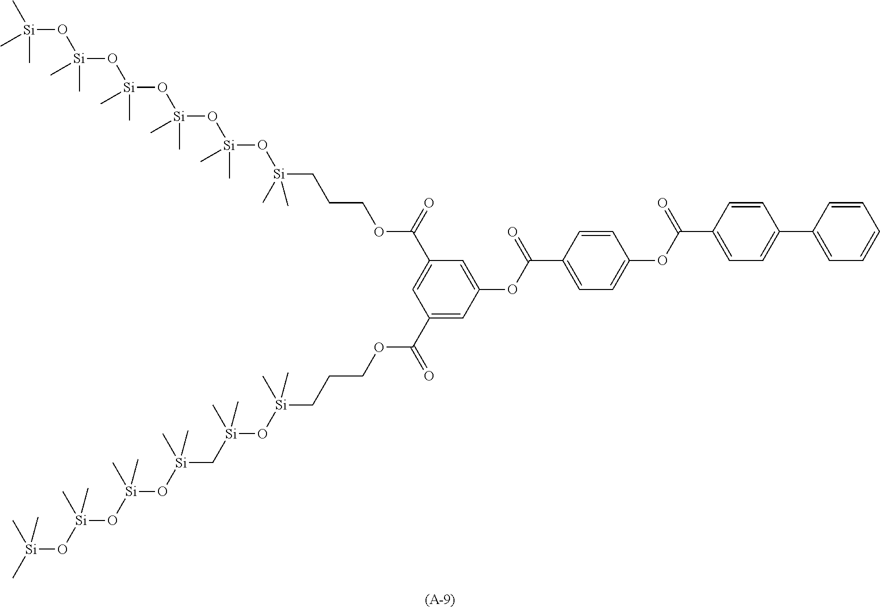 [SMILES: C[Si](C)(C)O[Si](C)(C)O[Si](C)(C)O[Si](C)(C)C[Si](C)(C)O[Si](C)(C)CCCOC(=O)c1cc(OC(=O)c2ccc(OC(=O)c3ccc(-c4ccccc4)cc3)cc2)cc(C(=O)OCCC[Si](C)(C)O[Si](C)(C)O[Si](C)(C)O[Si](C)(C)O[Si](C)(C)O[Si](C)(C)C)c1 ; "(A-9)"]

### Synthesis of Compound (S-9-b)

In accordance with “Synthesis of compound (S-4-b)” described above, a compound (S-9-b) was synthesized in yield of 80%.

### Synthesis of Compound (S-9-c)

In accordance with “Synthesis of compound (S-4-c)” described above, a compound (S-9-c) was synthesized in yield of 95%.

### Synthesis of Compound (A-9)

In accordance with “Synthesis of compound (A-3)” described above, a compound (A-9) was synthesized in yield of 71%.

MALDI-MS measurement results of the obtained compound (A-9) are shown below.

m/z: 1448.48 (100.0%), 1450.48 (97.4%), 1449.49 (67.9%), 1451.48 (63.8%), 1449.48 (60.9%), 1452.48 (32.0%), 1450.49 (27.3%), 1451.49 (23.6%), 1453.48 (19.4%), 1452.49 (18.9%), 1454.48 (6.5%), 1453.49 (6.1%), 1454.49 (3.0%), 1455.48 (2.6%), 1454.47 (1.7%), 1455.49 (1.3%)

### Synthesis of Compound (A-10)

A compound (A-10) was synthesized according to the following procedure.

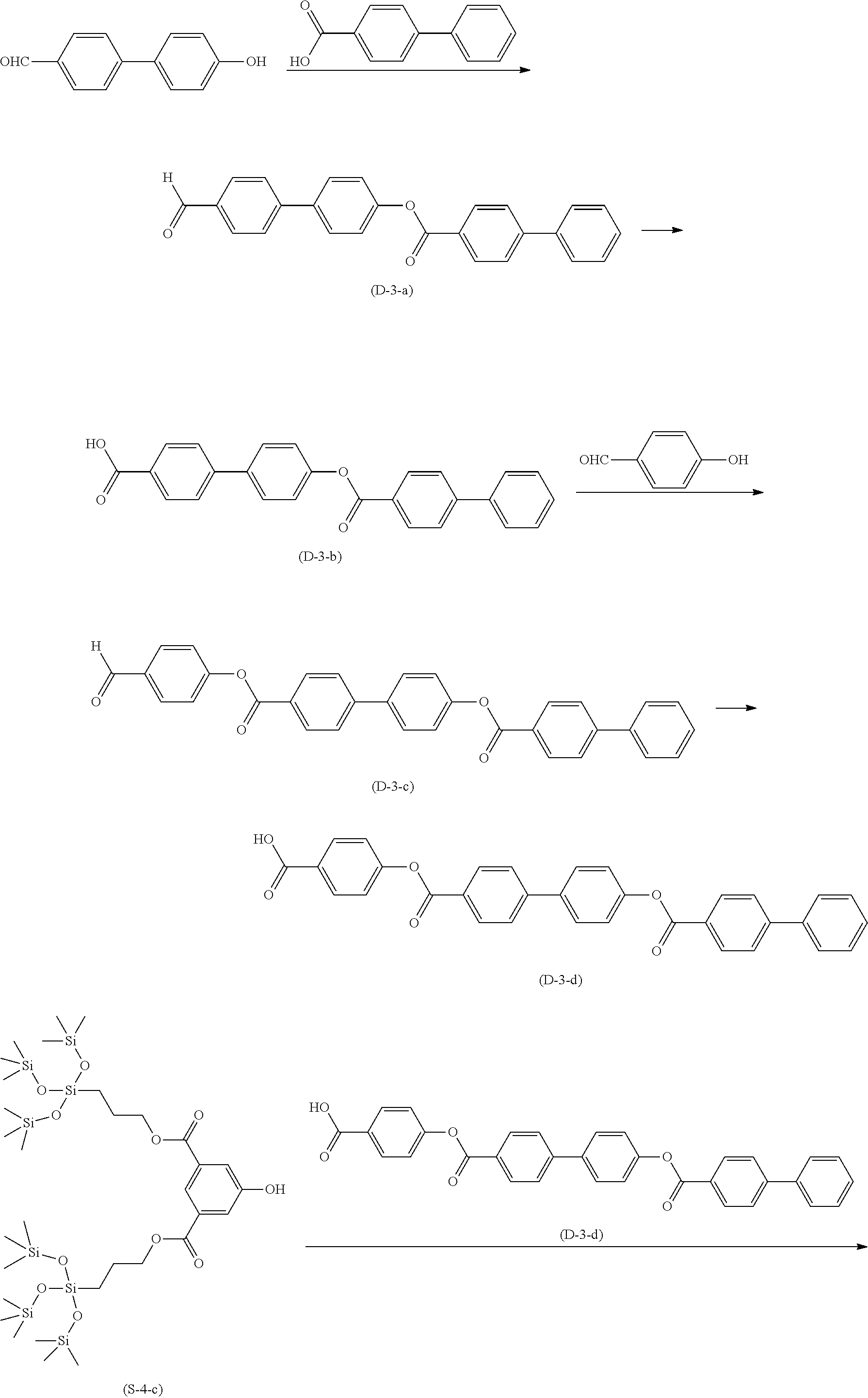

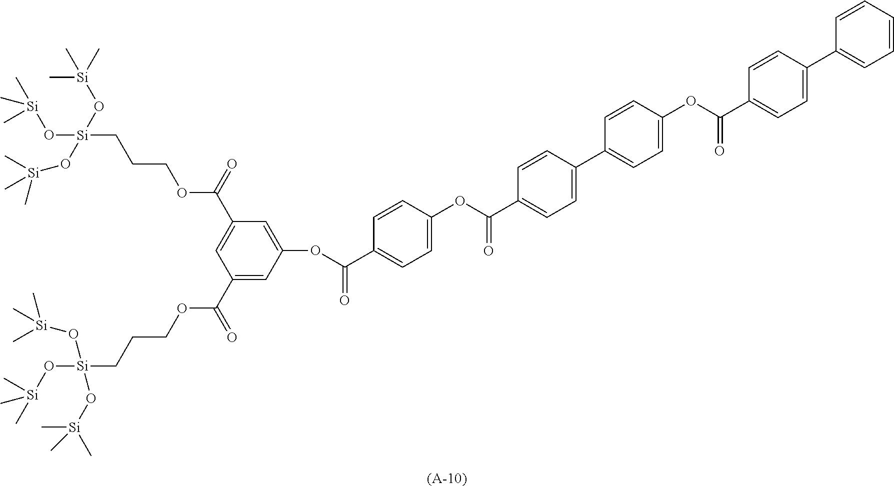 [SMILES: C[Si](C)(C)O[Si](CCCOC(=O)c1cc(OC(=O)c2ccc(OC(=O)c3ccc(-c4ccc(OC(=O)c5ccc(-c6ccccc6)cc5)cc4)cc3)cc2)cc(C(=O)OCCC[Si](O[Si](C)(C)C)(O[Si](C)(C)C)O[Si](C)(C)C)c1)(O[Si](C)(C)C)O[Si](C)(C)C ; "(A-10)"]

### Synthesis of Compound (D-3-a)

In accordance with “Synthesis of compound (D-2-a)” described above, a compound (D-3-a) was synthesized in yield of 85%.

### Synthesis of Compound (D-3-b)

In accordance with “Synthesis of compound (D-2-b)” described above, a compound (D-3-b) was synthesized in yield of 88%.

### Synthesis of Compound (D-3-c)

In accordance with “Synthesis of compound (D-2-a)” described above, a compound (D-3-c) was synthesized in yield of 68%.

### Synthesis of Compound (D-3-d)

In accordance with “Synthesis of compound (D-2-b)” described above, a compound (D-3-d) was synthesized in yield of 80%.

### Synthesis of Compound (A-10)

In accordance with “Synthesis of compound (A-3)” described above, a compound (A-10) was synthesized in yield of 75%.

MALDI-MS measurement results of the obtained compound (A-10) are shown below.

m/z: 1351.44 (100.0%), 1350.44 (88.8%), 1352.44 (59.1%), 1353.44 (32.3%), 1352.45 (22.6%), 1354.44 (15.2%), 1353.43 (8.5%), 1353.45 (7.8%), 1355.44 (6.1%), 1354.45 (4.7%), 1354.43 (4.1%), 1355.45 (2.8%), 1356.44 (2.0%), 1355.43 (1.0%)

### Example 1

### Preparation of Liquid Crystal Composition 1

A liquid crystal composition 1 having the following formulation was prepared using the compound A-1.

Liquid crystal composition 1

| | |
|---|---|
| Polymerizable disk-like liquid crystal compound M4 shown below | 80 parts by mass |
| Polymerizable disk-like liquid crystal compound M5 shown below | 20 parts by mass |
| Aligning agent 1 for alignment film interface shown below | 0.55 parts by mass |
| IRGACURE 819 (manufactured by BASF) | 3 parts by mass |
| Liquid crystal alignment accelerator (compound A-1) | 0.50 parts by mass |
| Methyl ethyl ketone (MEK) | amount at which concentration of solid contents was 33% by mass |

Polymerizable disk-like liquid crystal compound M4 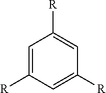
R = 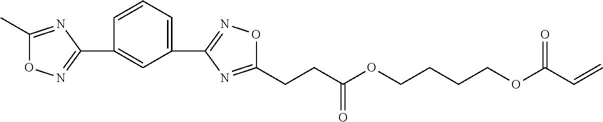 [SMILES: C=CC(=O)OCCCCOC(=O)CCc1nc(-c2cccc(-c3noc(C)n3)c2)no1]
Polymerizable disk-like liquid crystal compound M5 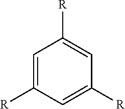
R = 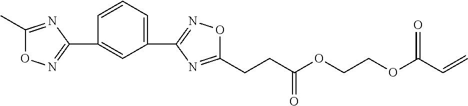 [SMILES: C=CC(=O)OCCOC(=O)CCc1nc(-c2cccc(-c3noc(C)n3)c2)no1]
Aligning agent 1 for alignment film interface

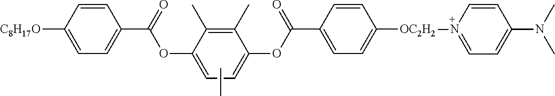

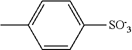

### [Production and Evaluation of Optical Film]

### <Production of Optical Film>

50 μL of the liquid crystal composition 1 was dispensed using a micropipette, and the liquid crystal composition 1 was dripped onto a glass with an alignment film (PVA-103) and then spin-coated to form a coating film. The obtained coating film was subjected to a heating treatment at 110° C. for 2 minutes, and further subjected to a cooling treatment for 1 minute. Next, the coating film after the cooling treatment was irradiated with ultraviolet rays (ultraviolet intensity: 500 mJ/cm²) in a nitrogen atmosphere to cure the coating film. A film thickness of the obtained cured film (optical film) was approximately 1.1 μm.

### <Evaluation of Optical Film>

### (Evaluation of Aligning Properties)

Aligning properties of the obtained cured film (optical film) were observed with an optical microscope and evaluated according to the following standard.
“A”: no alignment defect
“B”: slightly alignment defect
“C”: many alignment defects

### (Evaluation of Visible Non-Uniformity)

The obtained cured film (optical film) was visually observed and evaluated according to the following standard.
“A”: no visible non-uniformity
“B”: slight visible non-uniformity
“C”: large number of visible non-uniformities

### Examples 2 to 10 and Comparative Examples 1 and 2

Each of cured films (optical films) of Examples 2 to 10 and Comparative Examples 1 and 2 was produced by the same procedure as in Example 1, except that the compound A-1 was changed to the liquid crystal alignment accelerator (compounds A-2 to A-10 and C-1 and C-2) shown in Table 1. In addition, the evaluation was performed by the same procedure as in Example 1 using each of the obtained cured films.

### Example 11

A cured film (optical film) of Example 11 was produced by the same procedure as in Example 1, except that the liquid crystal composition 1 was changed to a liquid crystal composition 2. In addition, the evaluation was performed by the same procedure as in Example 1 using the obtained cured film.

### Preparation of Liquid Crystal Composition 2

A liquid crystal composition 2 having the following formulation was prepared using the compound A-4.

Liquid crystal composition 2

| | |
|---|---|
| Polymerizable rod-like liquid crystal compound M6 shown below | 100 parts by mass |
| Aligning agent 1 for alignment film interface shown above | 0.55 parts by mass |
| IRGACURE 819 (manufactured by BASF) | 3 parts by mass |
| Liquid crystal alignment accelerator (compound A-4) | 0.50 parts by mass |
| Methyl ethyl ketone (MEK) | amount at which concentration of solid contents was 33% by mass |

Polymerizable rod-like liquid crystal compound M6 (the following mixture)

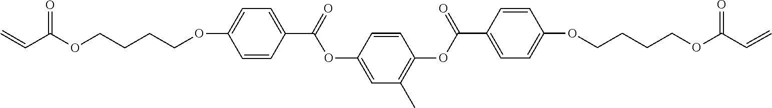 [SMILES: C=CC(=O)OCCCCOc1ccc(C(=O)Oc2ccc(OC(=O)c3ccc(OCCCCOC(=O)C=C)cc3)c(C)c2)cc1]

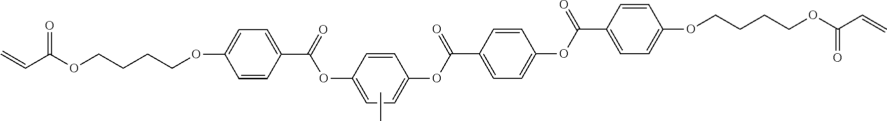

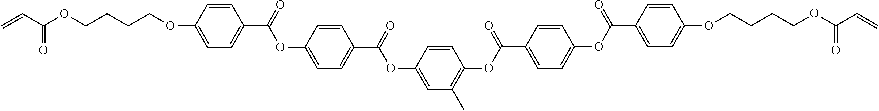 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]

### Example 12

A cured film (optical film) of Example 12 was produced by the same procedure as in Example 1, except that the liquid crystal composition 1 was changed to a liquid crystal composition 3. In addition, the evaluation was performed by the same procedure as in Example 1 using the obtained cured film.

### Preparation of Liquid Crystal Composition 3

A liquid crystal composition 3 having the following formulation was prepared using the compound A-4.

Liquid crystal composition 3

| | | |
|---|---|---|
| Disk-like liquid crystal compound (M4) | 80 | parts by mass |
| Disk-like liquid crystal compound (M5) | 20 | parts by mass |
| Polymerizable monomer E1 | 4 | parts by mass |
| Liquid crystal alignment accelerator (compound A-4) | 0.06 | parts by mass |
| Photopolymerization initiator (manufactured by BASF, IRGACURE 907) | 3 | parts by mass |
| Pyridinium salt A | 0.1 | parts by mass |
| Boronic acid monomer A | 3 | parts by mass |
| Chiral agent A | 4.00 | parts by mass |
| Methyl ethyl ketone | 151 | parts by mass |
| Cyclohexanone | 37 | parts by mass |

Disk-like liquid crystal compound (M4)\ 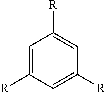
R = 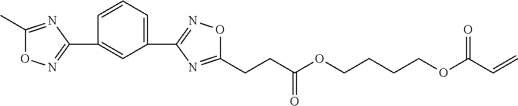 [SMILES: C=CC(=O)OCCCCOC(=O)CCc1nc(-c2cccc(-c3noc(C)n3)c2)no1]
Disk-like liquid crystal compound (M5) 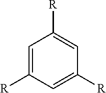
R = 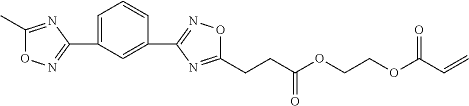 [SMILES: C=CC(=O)OCCOC(=O)CCc1nc(-c2cccc(-c3noc(C)n3)c2)no1]
Polymerizable monomer E1 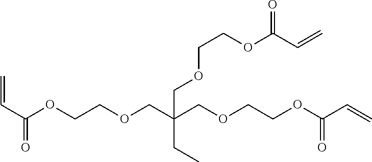 [SMILES: C=CC(=O)OCCOCC(CC)(COCCOC(=O)C=C)COCCOC(=O)C=C]
Pyridinium salt A 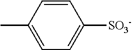 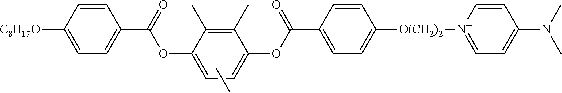
Boronic acid monomer A 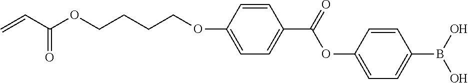 [SMILES: C=CC(=O)OCCCCOc1ccc(C(=O)Oc2ccc(B(O)O)cc2)cc1]
Chiral agent A

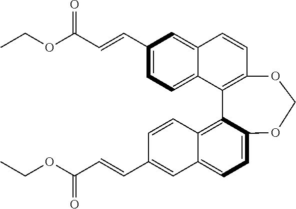

Table 1 is shown below.

The definition of “Si—R^{AL} content” in the table is as described above.

TABLE 1

| | Main formulation of liquid crystal composition | | | | | Evaluation | |
|---|---|---|---|---|---|---|---|
| | Liquid crystal aligning agent | | | | | | Visible |
| | | Molecular | Number of | Si-R^{AL} | Liquid crystal compound | Aligning | non- |
| | Type | weight | Si-R^{AL} | content | Formulation (mass ratio) | properties | uniformity |
| Example 1 | A-1 | 805.2 | 9 | 1.12 | M4/M5 = 80/20 | A | B |
| Example 2 | A-2 | 1206.0 | 14 | 1.16 | M4/M5 = 80/20 | A | A |
| Example 3 | A-3 | 1157.9 | 18 | 1.55 | M4/M5 = 80/20 | A | A |
| Example 4 | A-4 | 1155.9 | 18 | 1.56 | M4/M5 = 80/20 | A | A |
| Example 5 | A-5 | 1510.6 | 27 | 1.79 | M4/M5 = 80/20 | B | A |
| Example 6 | A-6 | 1009.6 | 14 | 1.39 | M4/M5 = 80/20 | A | A |
| Example 7 | A-7 | 1352.3 | 23 | 1.70 | M4/M5 = 80/20 | A | A |
| Example 8 | A-8 | 1544.9 | 33 | 2.14 | M4/M5 = 80/20 | B | A |
| Example 9 | A-9 | 1450.5 | 26 | 1.79 | M4/M5 = 80/20 | B | A |
| Example 10 | A-10 | 1352.1 | 18 | 1.33 | M4/M5 = 80/20 | A | A |
| Example 11 | A-4 | 1155.9 | 18 | 1.56 | M6 | A | B |
| Example 12 | A-4 | 1155.9 | 18 | 1.56 | M4/M5 = 80/20 | A | A |
| Comparative | C-1 | — | — | — | M4/M5 = 80/20 | C | C |
| Example 1 | | | | | | | |
| Comparative | C-2 | — | — | — | M4/M5 = 80/20 | C | C |
| Example 2 | | | | | | | |

From the results of Table 1, it was found that, with the liquid crystal composition of Examples, it was possible to form a film having excellent aligning properties of the liquid crystal compound with reduced visible non-uniformity.

From the results of Examples 1 to 10, it was found that, in a case where the Si-R^{AL} content of the specific compound was less than 1.79%, the aligning properties of the liquid crystal compound were more excellent.

In addition, from the results of Examples 1 to 10, it was found that, in a case where the Si—R^{AL} content of the specific compound was more than 1.12%, the visible non-uniformity was further suppressed.

In addition, from the comparison between Example 4 and Example 11, it was found that, in a case where the liquid crystal compound was a disk-like liquid crystal compound, the visible non-uniformity was further suppressed.

What is claimed is:

1. A liquid crystal composition comprising:
a compound represented by Formula (1); and
a liquid crystal compound, 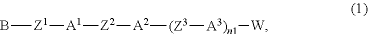
in Formula (1), A¹ to A³ each independently represent a divalent aromatic ring group or a divalent aliphatic ring group, Z¹ to Z³ each independently represent a single bond or a divalent linking group, n1 represents an integer of 0 or more, B represents a monovalent aromatic ring group in which one or more monovalent substituents T having a siloxane structure including three or more silicon atoms are substituted, and W represents a hydrogen atom or a monovalent substituent which does not include a silicon atom, provided that, in a case where n1 represents an integer of 2 or more, a plurality of Z³'s and a plurality of A³'s may be the same or different from each other.

2. The liquid crystal composition according to claim 1,
wherein the substituent T is a monovalent group represented by Formula (TA), 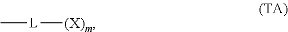
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group selected from the group consisting of the groups represented by Formula (C-1) to Formula (C-3), provided that, in a case where m is an integer of 2 or more, a plurality of X's may be the same or different from each other, 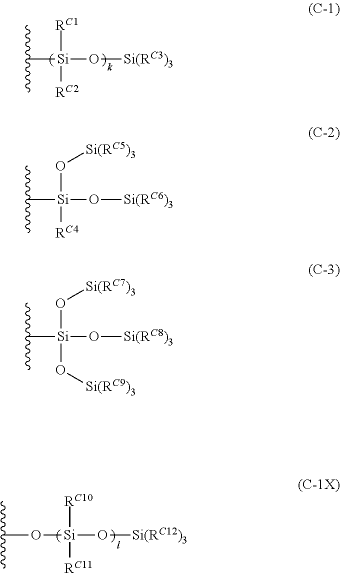
in Formula (C-1), R^{C1} to R^{C3} each independently represent an alkyl group having 1 to 10 carbon atoms, and k represents an integer of 2 to 20, in Formula (C-2), R^{C4} represents an alkyl group having 1 to 10 carbon atoms, and R^{C5} and R^{C6} each independently represent an alkyl group having 1 to 10 carbon atoms or a monovalent group represented by Formula (C-1X), in Formula (C-3), R^{C7} to R^{C9} each independently represent an alkyl group having 1 to 10 carbon atoms or a monovalent group represented by Formula (C-1X), in Formula (C-1), a plurality of R^{C1}'s, a plurality of R^{C2}'s, and a plurality of R^{C3}'s may be the same or different from each other, in Formula (C-2), a plurality of R^{C5}'s and a plurality of R^{C6}'s may be the same or different from each other, in Formula (C-3), a plurality of R^{C7}'s, a plurality of R^{C8}'s, and a plurality of R^{C9}'s may be the same or different from each other, in Formula (C-1X), R^{C10} to R^{C12} each independently represent an alkyl group having 1 to 10 carbon atoms, and 1 represents an integer of 0 to 20, provided that, in Formula (C-1X), a plurality of R^{C10}'s, a plurality of R^{C11}'s, and a plurality of R^{C12}'s may be the same or different from each other.

3. The liquid crystal composition according to claim 2,
wherein B represents a monovalent group selected from the group consisting of groups represented by Formula (B-1) to Formula (B-5), 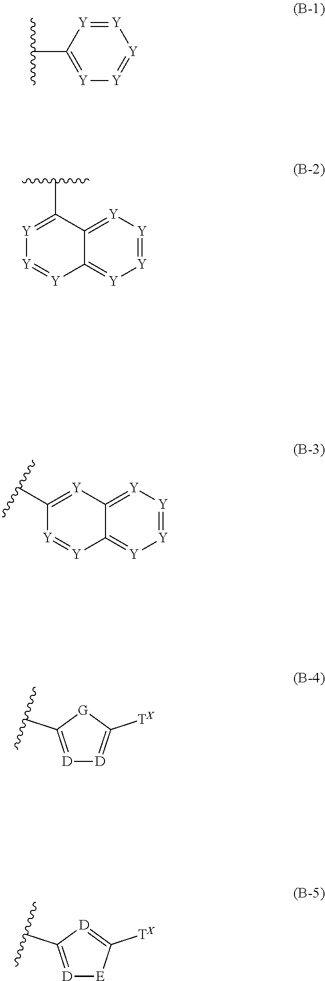
in Formula (B-1) to Formula (B-3), Y's each independently represent CR^{B1} or a nitrogen atom, and R^{B1}'s each independently represent a hydrogen atom or a substituent, provided that, in each of Formulae (B-1) to (B-3), at least one of Y's represents CR^{BT}, and R^{BT} represents the monovalent group represented by Formula (TA),
in Formula (B-4) and Formula (B-5), D's each independently represent CR^{A1} or a nitrogen atom, E represents CR^{A2}R^{A3}, NR^{A4}, an oxygen atom, or a sulfur atom, G represents CR^{A5}R^{A6}, NR^{A7}, a sulfur atom, or an oxygen atom, R^{A1} to R^{A7} each independently represent a hydrogen atom or a substituent, and T^{X} represents the monovalent group represented by Formula (TA).

4. The liquid crystal composition according to claim 3,
wherein, in the monovalent group represented by Formula (TA), which is represented by R^{BT} and T^{X} in Formula (B-1) to Formula (B-5), m represents 1, and L represents a chain-like alkylene group having 1 to 4 carbon atoms, in which at least one —CH₂— may be replaced with —NH—, —O—, —S—, —CO—, —CS—, —SO—, or —SO₂—.

5. The liquid crystal composition according to claim 3,
wherein B represents a monovalent group selected from the group consisting of groups represented by Formula (B-1-1) to Formula (B-1-5), 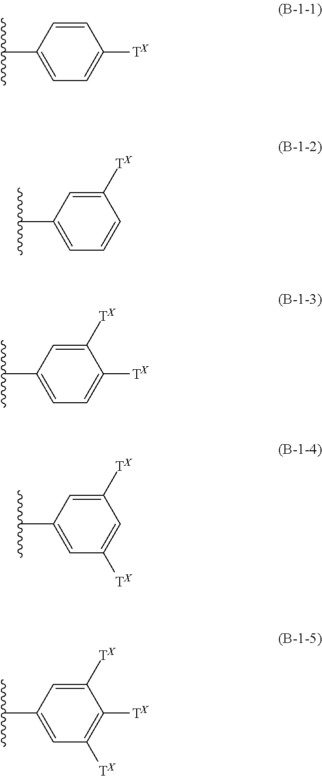
in Formula (B-1-1) to Formula (B-1-5), T^{X} represents the monovalent group represented by Formula (TA), and m in Formula (TA) represents 1.

6. The liquid crystal composition according to claim 2,
wherein X represents the monovalent group represented by Formula (C-1), where, in Formula (C-1), R^{C1} to R^{C3} each independently represent an alkyl group having 1 to 4 carbon atoms, and k represents an integer of 2 to 10.

7. The liquid crystal composition according to claim 2,
wherein X represents the monovalent group represented by Formula (C-2), where R^{C4} to R^{C6} in Formula (C-2) each independently represent an alkyl group having 1 to 4 carbon atoms.

8. The liquid crystal composition according to claim 2,
wherein X represents the monovalent group represented by Formula (C-2), where, in Formula (C-2), R^{C4} represents an alkyl group having 1 to 10 carbon atoms, and R^{C5} and R^{C6} each independently represent the monovalent group represented by Formula (C-1X).

9. The liquid crystal composition according to claim 2,
wherein X represents the monovalent group represented by Formula (C-3), where R^{C7} to R^{C9} in Formula (C-3) each independently represent an alkyl group having 1 to 4 carbon atoms.

10. The liquid crystal composition according to claim 2,
wherein X represents the monovalent group represented by Formula (C-3), where R^{C7} to R^{C9} in Formula (C-3) each independently represent the monovalent group represented by Formula (C-1X).

11. The liquid crystal composition according to claim 1,
wherein A¹ to A³ each independently represent a divalent group selected from the group consisting of groups represented by Formula (A-1) to Formula (A-14), 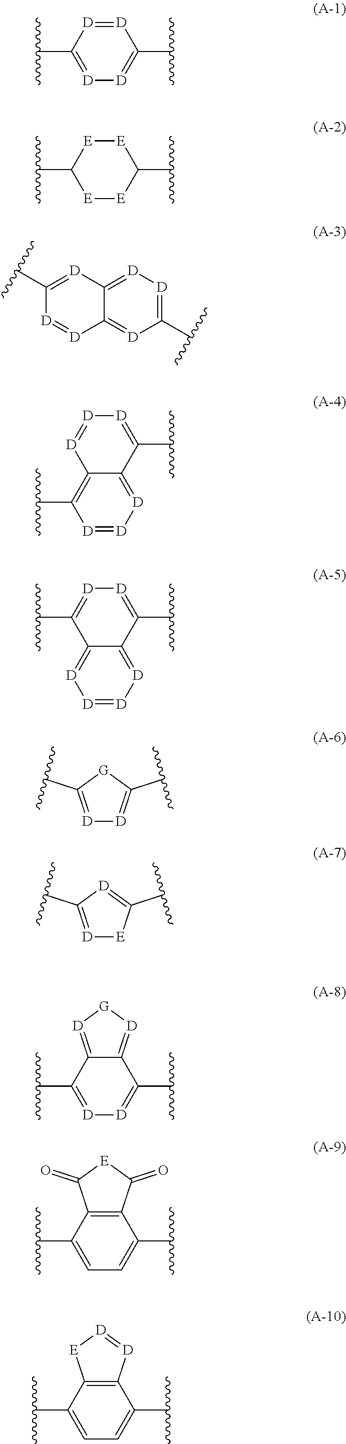 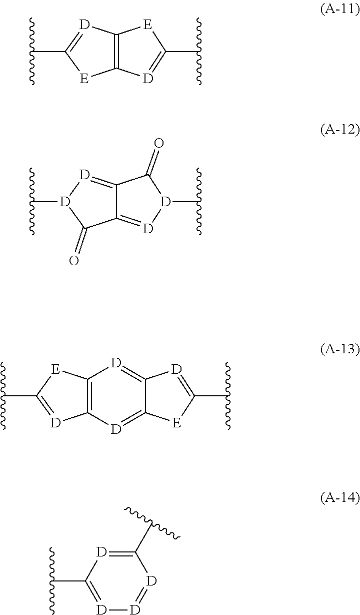
in Formula (A-1) to Formula (A-14), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent.

12. The liquid crystal composition according to claim 11,
wherein A¹ to A³ each independently represent a divalent group selected from the group consisting of the groups represented by Formula (A-1) to Formula (A-5) and Formula (A-14), where, in Formula (A-1), Formula (A-3) to Formula (A-5), and Formula (A-14), D's each independently represent CR^{A1}, and R^{A1}'s each independently represent a hydrogen atom or a substituent.

13. The liquid crystal composition according to claim 1,
wherein a content of a structural moiety represented by —Si—R^{AL} in the compound represented by Formula (1) is less than 1.79%, where R^{AL} represents an alkyl group.

14. The liquid crystal composition according to claim 1,
wherein a content of a structural moiety represented by —Si—R^{AL} in the compound represented by Formula (1) is more than 1.12%, where R^{AL} represents an alkyl group.

15. The liquid crystal composition according to claim 1,
wherein the liquid crystal compound is one or more selected from the group consisting of a polymerizable rod-like liquid crystal compound and a polymerizable disk-like liquid crystal compound.

16. The liquid crystal composition according to claim 1, further comprising:
a chiral agent.

17. A cured product formed of the liquid crystal composition according to claim 1.

18. A film comprising:
the cured product according to claim 17.

19. The film according to claim 18,
wherein the film exhibits optical anisotropy.

20. A film comprising:
a cured product formed of the liquid crystal composition according to claim 16, in which a cholesteric liquid crystalline phase is fixed.

21. A compound represented by Formula (1), 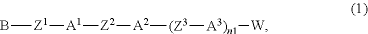
in Formula (1), A¹ to A³ each independently represent a divalent aromatic ring group or a divalent aliphatic ring group, Z¹ to Z³ each independently represent a single bond or a divalent linking group, n1 represents an integer of 0 or more, B represents a monovalent aromatic ring group in which one or more monovalent substituents T having a siloxane structure including three or more silicon atoms are substituted, and W represents a hydrogen atom or a monovalent substituent which does not include a silicon atom, provided that, in a case where n1 represents an integer of 2 or more, a plurality of Z³'s and a plurality of A³'s may be the same or different from each other.

22. The compound according to claim 21,
wherein the substituent T is a monovalent group represented by Formula (TA), 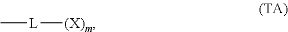
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group selected from the group consisting of the groups represented by Formula (C-1) to Formula (C-3), provided that, in a case where m is an integer of 2 or more, a plurality of X's may be the same or different from each other, 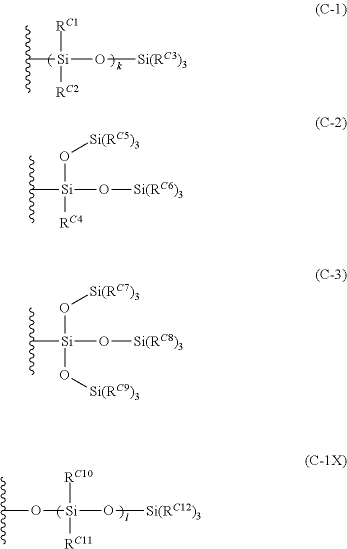
in Formula (C-1), R^{C1} to R^{C3} each independently represent an alkyl group having 1 to 10 carbon atoms, and k represents an integer of 2 to 20, in Formula (C-2), R^{C4} represents an alkyl group having 1 to 10 carbon atoms, and R^{C5} and R^{C6} each independently represent an alkyl group having 1 to 10 carbon atoms or a monovalent group represented by Formula (C-1X), in Formula (C-3), R^{C7} to R^{C9} each independently represent an alkyl group having 1 to 10 carbon atoms or a monovalent group represented by Formula (C-1X), in Formula (C-1), a plurality of R^{C1}'s, a plurality of R^{C2}'s, and a plurality of R^{C3}'s may be the same or different from each other, in Formula (C-2), a plurality of R^{C5}'s and a plurality of R^{C6}'s may be the same or different from each other, in Formula (C-3), a plurality of R^{C7}'s, a plurality of R^{C8}'s, and a plurality of R^{C9}'s may be the same or different from each other, in Formula (C-1X), R^{C10} to R^{C12} each independently represent an alkyl group having 1 to 10 carbon atoms, and 1 represents an integer of 0 to 20, provided that, in Formula (C-1X), a plurality of R^{C10}'s, a plurality of R^{C11}'s, and a plurality of R^{C12}'s may be the same or different from each other.

23. The compound according to claim 22,
wherein B represents a monovalent group selected from the group consisting of groups represented by Formula (B-1) to Formula (B-5), 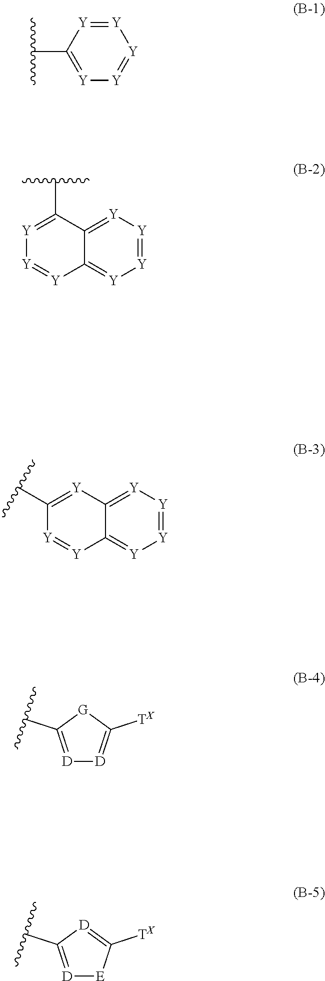
in Formula (B-1) to Formula (B-3), Y's each independently represent CR^{B1} or a nitrogen atom, R^{B1}'s each independently represent a hydrogen atom or a substituent, provided that, in each of Formulae (B-1) to (B-3), at least one of Y's represents CR^{BT}, and R^{BT} represents the monovalent group represented by Formula (TA),
in Formula (B-4) and Formula (B-5), D's each independently represent CR^{A1} or a nitrogen atom, E represents CR^{A2}R^{A3}, NR^{A4}, an oxygen atom, or a sulfur atom, G represents CR^{A5}R^{A6}, NR^{A7}, a sulfur atom, or an oxygen atom, R^{A1} to R^{A7} each independently represent a hydrogen atom or a substituent, and T^{X} represents the monovalent group represented by Formula (TA).

24. The compound according to claim 23,
wherein, in the monovalent group represented by Formula (TA), which is represented by R^{BT} and T^{X} in Formula (B-1) to Formula (B-5), m represents 1, and L represents a chain-like alkylene group having 1 to 4 carbon atoms, in which at least one —CH₂— may be replaced with —NH—, —O—, —S—, —CO—, —CS—, —SO—, or —SO₂—.

25. The compound according to claim 23,
wherein B represents a monovalent group selected from the group consisting of groups represented by Formula (B-1-1) to Formula (B-1-5), 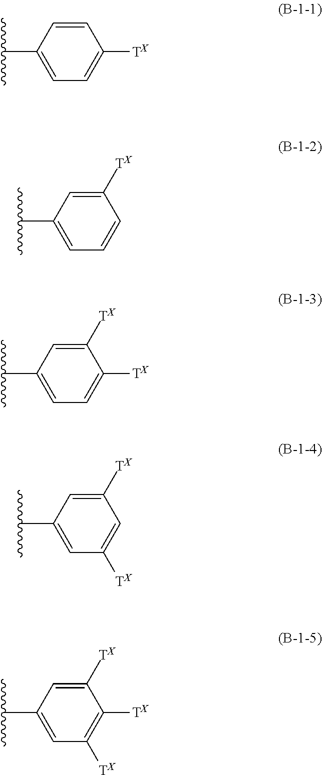
in Formula (B-1-1) to Formula (B-1-5), T^{X} represents the monovalent group represented by Formula (TA), and m in Formula (TA) represents 1.

26. The compound according to claim 22,
wherein X represents the monovalent group represented by Formula (C-1), where, in Formula (C-1), R^{C1} to R^{C3} each independently represent an alkyl group having 1 to 4 carbon atoms, and k represents an integer of 2 to 10.

27. The compound according to claim 22,
wherein X represents the monovalent group represented by Formula (C-2), where R^{C4} to R^{C6} in Formula (C-2) each independently represent an alkyl group having 1 to 4 carbon atoms.

28. The compound according to claim 22,
wherein X represents the monovalent group represented by Formula (C-2), where, in Formula (C-2), R^{C4} represents an alkyl group having 1 to 10 carbon atoms, and R^{C5} and R^{C6} each independently represent the monovalent group represented by Formula (C-1X).

29. The compound according to claim 22,
wherein X represents the monovalent group represented by Formula (C-3), where R^{C7} to R^{C9} in Formula (C-3) each independently represent an alkyl group having 1 to 4 carbon atoms.

30. The compound according to claim 22,
wherein X represents the monovalent group represented by Formula (C-3), where R^{C7} to R^{C9} in Formula (C-3) each independently represent the monovalent group represented by Formula (C-1X).

31. The compound according to claim 21,
wherein a content of a structural moiety represented by —Si—R^{AL} is less than 1.79%, where R^{AL} represents an alkyl group.

32. The compound according to claim 21,
wherein a content of a structural moiety represented by —Si—R^{AL} is more than 1.12%, where R^{AL} represents an alkyl group.

33. The liquid crystal composition according to claim 1,
wherein in Formula (1), A¹ to A³ each independently represent a divalent group selected from the group consisting of groups represented by Formula (A-1) to Formula (A-5) and Formula (A-8) to Formula (A-13),
n1 represents an integer of 1 or more,
B represents a monovalent aromatic ring group in which one or more monovalent substituents T represented by Formula (TA) are substituted, 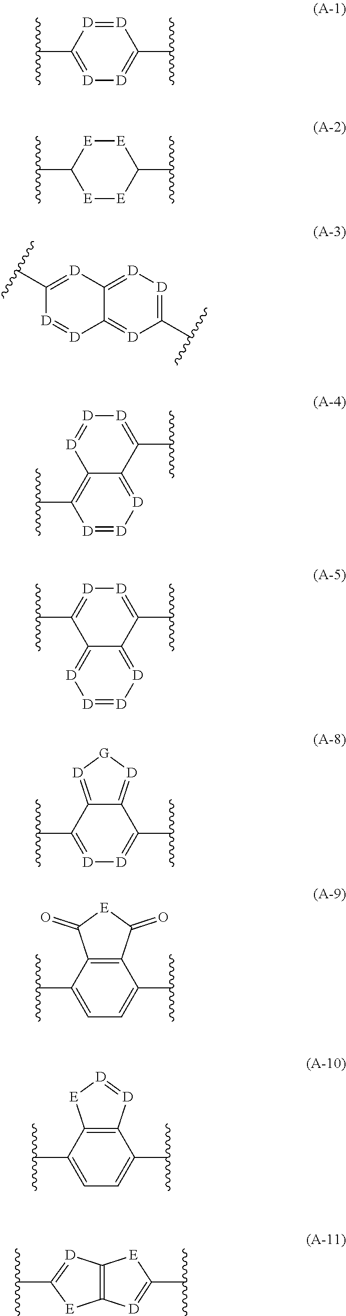 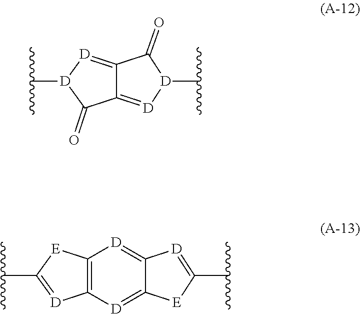
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent, 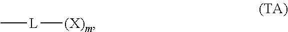
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-1), provided that, in a case where m is an integer of 2 or more, a plurality of X's may be the same or different from each other, and 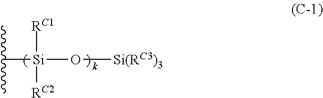
in Formula (C-1), R^{C1} to R^{C3} each independently represent an alkyl group having 1 to 10 carbon atoms, and k represents an integer of 2 to 20, provided that a plurality of R^{C1}'s, a plurality of R^{C2}'s, and a plurality of R^{C3}'s may be the same or different from each other.

34. The liquid crystal composition according to claim 1,
wherein in Formula (1), A¹ to A³ each independently represent a divalent group selected from the group consisting of groups represented by Formula (A-1) to Formula (A-5) and Formula (A-8) to Formula (A-13),
B represents a monovalent aromatic ring group in which one or more monovalent substituents T represented by Formula (TA) are substituted, 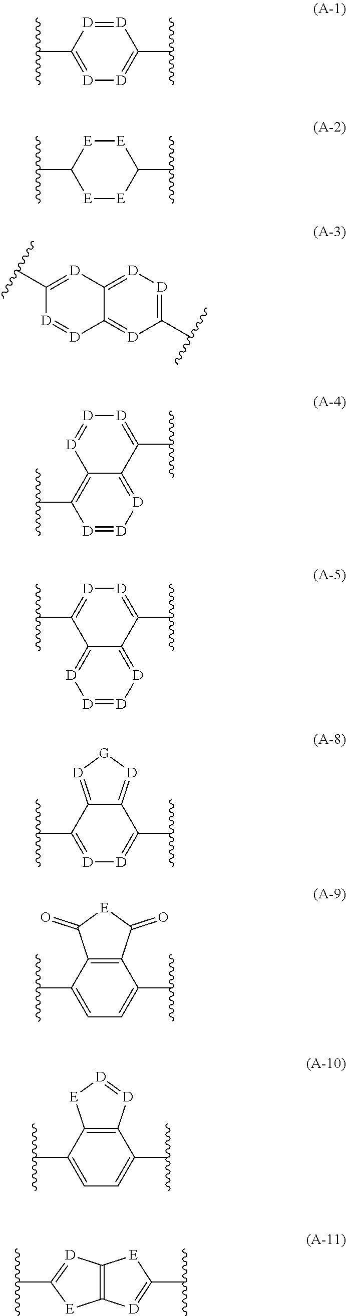 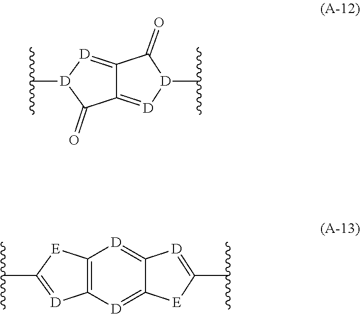
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent, 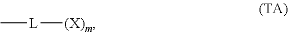
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH—CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-2), provided that, in a case where m is an integer of 2 or more, a plurality of X's may be the same or different from each other, 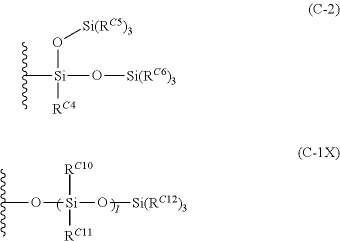
in Formula (C-2), R^{C4} represents an alkyl group having 1 to 10 carbon atoms, and R^{C5} and R^{C6} each independently represent an alkyl group having 1 to 10 carbon atoms or a monovalent group represented by Formula (C-1X), provided that a plurality of R^{C5}'s and a plurality of R^{C6}'s may be the same or different from each other,
in Formula (C-1X), R^{C10} to R^{C12} each independently represent an alkyl group having 1 to 10 carbon atoms, and 1 represents an integer of 0 to 20, provided that a plurality of R^{C10}'s, a plurality of R^{C11}'s, and a plurality of R^{C12}'s may be the same or different from each other.

35. The liquid crystal composition according to claim 1,
wherein in Formula (1), A¹ to A³ each independently represent a divalent group selected from the group consisting of groups represented by Formula (A-1) to Formula (A-5) and Formula (A-8) to Formula (A-13),
B represents a monovalent aromatic ring group in which one or more monovalent substituents T represented by Formula (TA) are substituted, 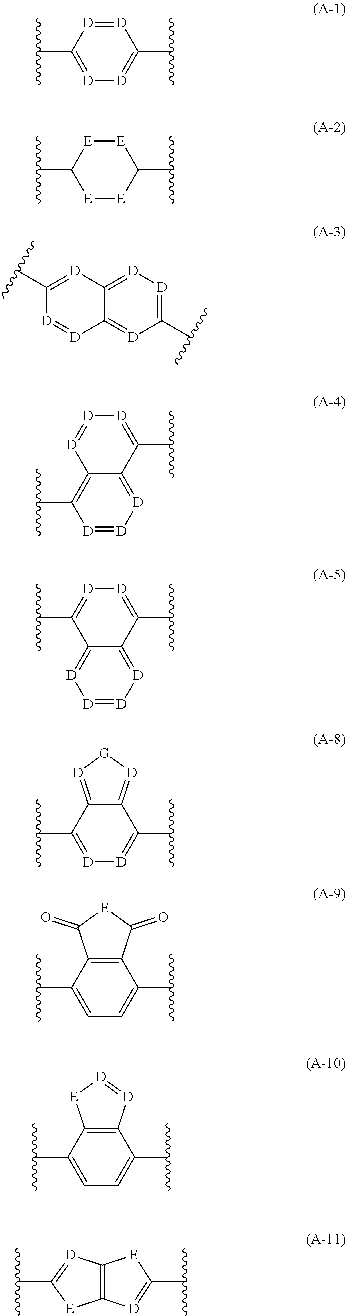 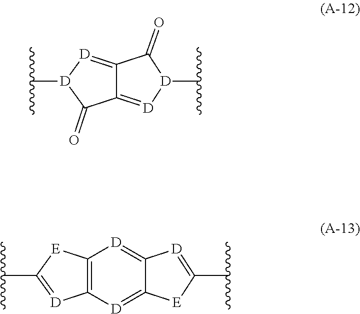
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{A1} to R^{A7} each independently represent a hydrogen atom or a substituent, 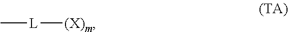
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH—CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-3), provided that, in a case where m is an integer of 2 or more, a plurality of X's may be the same or different from each other, 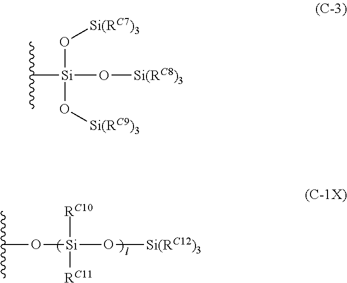
in Formula (C-3), R^{C7} to R^{C9} each independently represent an alkyl group having 1 to 10 carbon atoms or a monovalent group represented by Formula (C-1X), provided that a plurality of R^{C7}'s, a plurality of R^{C8}'s, and a plurality of R^{C9}'s may be the same or different from each other,
in Formula (C-1X), R^{C10} to R^{C12} each independently represent an alkyl group having 1 to 10 carbon atoms, and 1 represents an integer of 0 to 20, provided that a plurality of R^{C10}'s, a plurality of R^{C11}'s, and a plurality of R^{C12}'s may be the same or different from each other.

36. The compound according to claim 21,
wherein in Formula (1), A¹ to A³ each independently represent a divalent group selected from the group consisting of groups represented by Formula (A-1) to Formula (A-5) and Formula (A-8) to Formula (A-13),
n1 represents an integer of 1 or more,
B represents a monovalent aromatic ring group in which one or more monovalent substituents T represented by Formula (TA) are substituted, 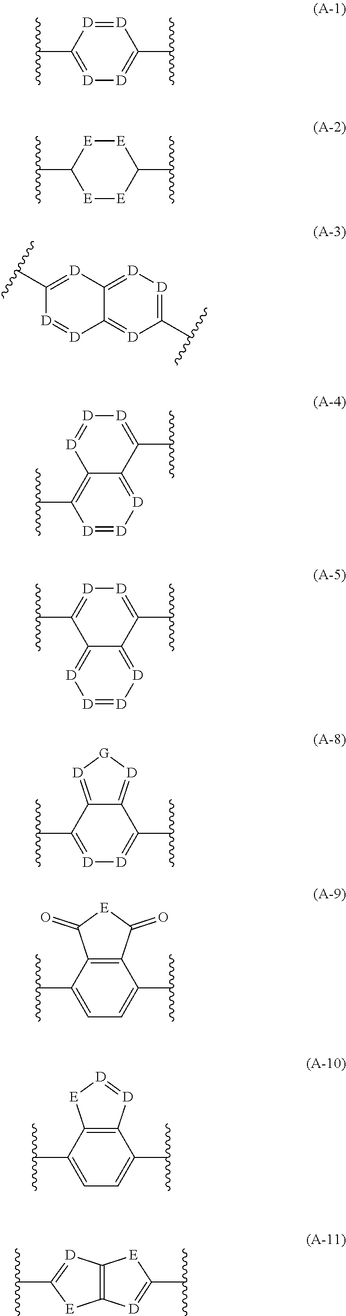 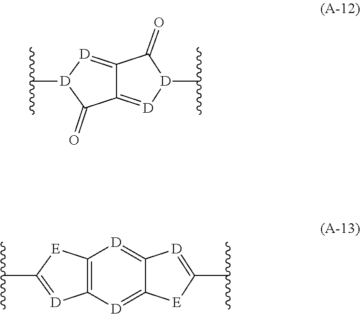
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent, 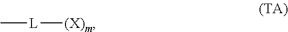
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-1), provided that, in a case where m is an integer of 2 or more, a plurality of X's may be the same or different from each other, and 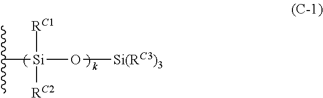
in Formula (C-1), R^{C1} to R^{C3} each independently represent an alkyl group having 1 to 10 carbon atoms, and k represents an integer of 2 to 20, provided that a plurality of R^{C1}'s, a plurality of R^{C2}'s, and a plurality of R^{C3}'s may be the same or different from each other.

37. The compound according to claim 21,
wherein in Formula (1), A¹ to A³ each independently represent a divalent group selected from the group consisting of groups represented by Formula (A-1) to Formula (A-5) and Formula (A-8) to Formula (A-13),
B represents a monovalent aromatic ring group in which one or more monovalent substituents T represented by Formula (TA) are substituted, 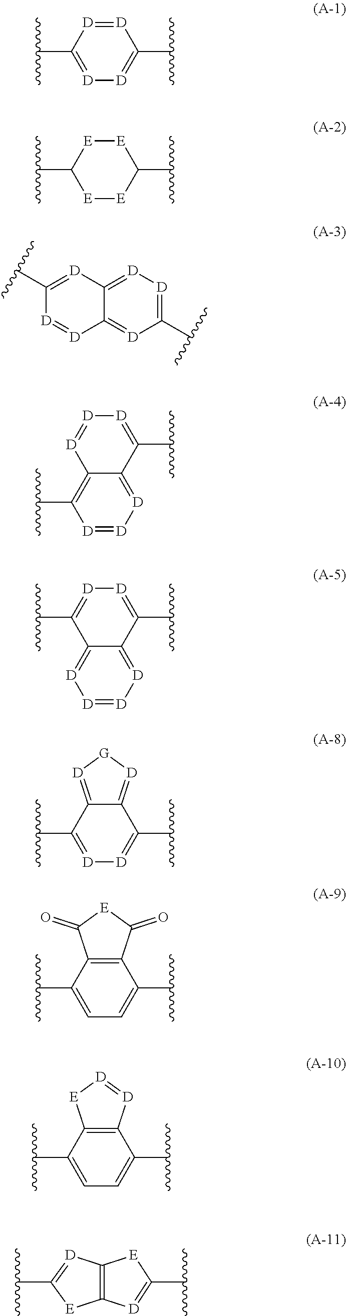 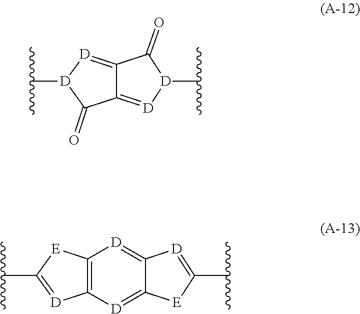
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent, 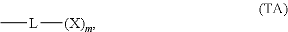
in Formula (TA), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-2), provided that, in a case where m is an integer of 2 or more, a plurality of X's may be the same or different from each other, 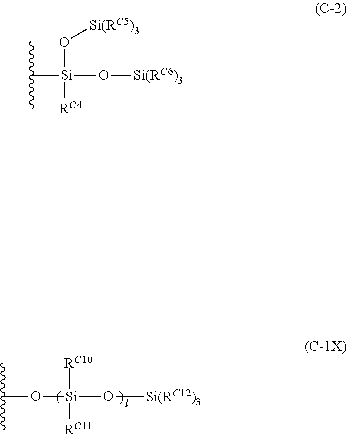
in Formula (C-2), R^{C4} represents an alkyl group having 1 to 10 carbon atoms, and R^{C5} and R^{C6} each independently represent an alkyl group having 1 to 10 carbon atoms or a monovalent group represented by Formula (C-1X), provided that, a plurality of R^{C5}'s and a plurality of R^{C6}'s may be the same or different from each other,
in Formula (C-1X), R^{C10} to R^{C12} each independently represent an alkyl group having 1 to 10 carbon atoms, and 1 represents an integer of 0 to 20, provided that a plurality of R^{C10}'s, a plurality of R^{C11}'s, and a plurality of R^{C12}'s may be the same or different from each other.

38. The compound according to claim 21,
wherein in Formula (1), A¹ to A³ each independently represent a divalent group selected from the group consisting of groups represented by Formula (A-1) to Formula (A-5) and Formula (A-8) to Formula (A-13),
B represents a monovalent aromatic ring group in which one or more monovalent substituents T represented by Formula (TA) are substituted, 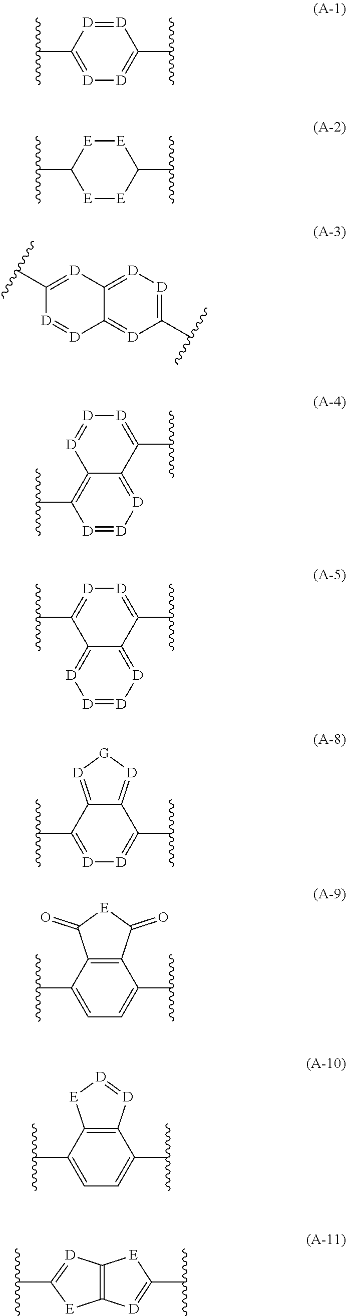 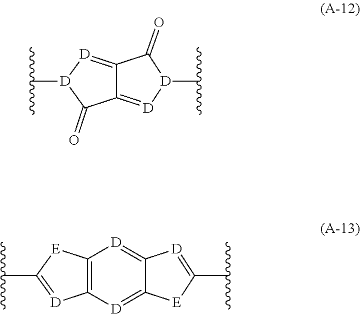
in Formula (A-1) to Formula (A-5) and Formula (A-8) to Formula (A-13), D's each independently represent CR^{A1} or a nitrogen atom, E's each independently represent CR^{A2}R^{A3}, NR^{A4}, an oxygen atom, or a sulfur atom, G represents CR^{A5}R^{A6}, NR^{A7}, a sulfur atom, or an oxygen atom, and R^{AL} to R^{A7} each independently represent a hydrogen atom or a substituent, 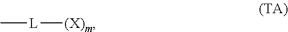
in Formula (A-1), L represents a single bond or a chain-like (m+1)-valent hydrocarbon group, where, in the hydrocarbon group, at least one —CH₂— may be replaced with —NH—, —O—, —S—, —CO—, —CS—, —SO—, or —SO₂—, at least one —CH₂CH₂— may be replaced with —CH═CH—, —N═N—, —CH═N—, —CF═CF—, or —C≡C—, at least one-CH< may be replaced with —N< or —SiH<, and at least one >C< may be replaced with >Si<, m represents an integer of 1 or more, and X represents a monovalent group represented by Formula (C-3), provided that, in a case where m is an integer of 2 or more, a plurality of X's may be the same or different from each other, 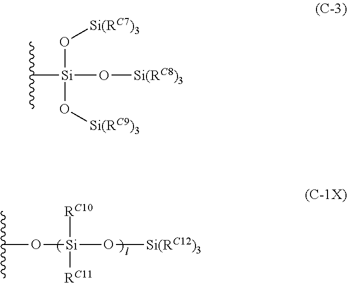
in Formula (C-3), R^{C7} to R^{C9} each independently represent an alkyl group having 1 to 10 carbon atoms or a monovalent group represented by Formula (C-1X), provided that a plurality of R^{C7}'s, a plurality of R^{C8}'s, and a plurality of R^{C9}'s may be the same or different from each other,
in Formula (C-1X), R^{C10} to R^{C12} each independently represent an alkyl group having 1 to 10 carbon atoms, and 1 represents an integer of 0 to 20, provided that a plurality of R^{C10}'s, a plurality of R^{C11}'s, and a plurality of R^{C12}'s may be the same or different from each other.
